(19) United States
(12) Patent Application Publication
(10) Pub. No.: US 2024/0320119 A1
(43) Pub. Date: Sep. 26, 2024

(54) Devices, Methods, and Graphical User Interfaces for Updating a Session Region

(71) Applicant: Apple Inc., Cupertino, CA (US)

(72) Inventors: Chanaka G. Karunamuni, San Jose, CA (US); William M. Tyler, San Francisco, CA (US); Nathan de Vries, Alameda, CA (US); Marcos Alonso Ruiz, Oakland, CA (US)

(21) Appl. No.: 18/607,241

(22) Filed: Mar. 15, 2024

Related U.S. Application Data
(60) Provisional application No. 63/454,611, filed on Mar. 24, 2023.

(51) Int. Cl. G06F 11/32; G06F 3/0488

(52) U.S. Cl. CPC G06F 11/328; G06F 3/0488

(57) ABSTRACT

A computer system, while displaying a user interface corresponding to a first function, automatically determines that the computer system is in a respective context associated with a different, second function, without detecting an input to perform an operation associated with the second function. In response, the computer system displays, in a status region, status information about the second function, while displaying the user interface corresponding to the first function outside of the status region. While displaying the status information about the second function in the status region, the computer system detects an input corresponding to a request to change the user interface displayed outside of the status region and, in response, displays a user interface corresponding to a third function, different from the user interface corresponding to the first function, outside of the status region while continuing to display the status information about the second function in the status region.

### RELATED APPLICATIONS

This application claims priority to U.S. Provisional Patent Application No. 63/454,611, filed Mar. 24, 2023, which is hereby incorporated by reference in its entirety.

### TECHNICAL FIELD

This relates generally to computer systems with display generation components, including but not limited to electronic devices that include a display area having a session region.

### BACKGROUND

Graphical user interfaces are useful for providing status information and status updates for functions and processes of computers and other electronic computing devices, such as when status information is provided and updated in a dedicated session region. But conventional methods for providing status information are cumbersome and inefficient. In some cases, the status information displayed is not sufficiently relevant to a user or device's current context. In some cases, displaying the status information takes too much focus away from and/or interrupts interaction with other displayed user interfaces. In some cases, the session region is not sufficiently user-configurable or is not configured to display certain types of status information. In addition, these methods take longer than necessary, thereby wasting energy. This latter consideration is particularly important in battery-operated devices.

### SUMMARY

Accordingly, there is a need for electronic devices with faster, more efficient methods and interfaces for providing and updating status information. Such methods and interfaces optionally complement or replace conventional methods for providing and updating status information. Such methods and interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display generation component having a display area. The method includes, while displaying a user interface corresponding to a first function, automatically determining that the computer system is in a respective context associated with a second function that is different from the first function, wherein determining that the computer system is in the respective context is performed without detecting an input to perform an operation associated with the second function. The method includes, in response to automatically determining that the computer system is in the respective context, displaying, in a status region of the display area, a user interface object that includes status information about the second function, while displaying the user interface corresponding to the first function outside of the status region. The method includes, while displaying the user interface object that includes status information about the second function in the status region, detecting an input corresponding to a request to display a user interface corresponding to a third function outside of the status region, wherein the user interface corresponding to the third function is different from the user interface corresponding to the first function. The method includes, in response to detecting the input corresponding to a request to display the user interface corresponding to the third function outside of the status region, displaying the user interface corresponding to the third function outside of the status region while continuing to display the user interface object that includes status information about the second function.

In accordance with some embodiments, a method is performed at a computer system that is in communication with a display generation component having a display area. The method includes, while displaying a first user interface in display area outside of a status region of the display area, wherein the status region is surrounded on at least two sides by the first user interface, receiving a first alert associated with an application that is not associated with the first user interface. The method includes, in response to receiving the first alert, while continuing to display the first user interface outside of the status region, expanding the status region into a portion of the display area that was previously occupied by the first user interface and displaying, in the status region, a first user interface object indicative of the first alert, including: in accordance with a determination that the first alert is associated with a first application, displaying, in the first user interface object, a representation of the first application associated with the first alert; and in accordance with a determination that the first alert is associated with a second application that is different from the first application, displaying, in the first user interface object, a representation of the second application associated with the first alert.

In accordance with some embodiments, a method is performed at a computer system that is in communication with a display generation component having a display area. The method includes displaying, in display area outside of a status region of the display area, a first user interface, wherein the status region has a first size, and the status region is a dynamic status region that has content that changes to reflect a current status of the computer system. The method includes receiving one or more inputs corresponding to a request to associate the status region with first content, including receiving an input selecting the first content and receiving an input directed to the status region. The method includes, in response to receiving the one or more inputs corresponding to a request to associate the status region with the first content, displaying the status region with a second size that is different from the first size, including displaying in the status region a representation of the first content.

In accordance with some embodiments, a method is performed at a computer system that is in communication with one or more cameras and with a display generation component having a display area. The method includes displaying, in display area outside of a status region of the display area, a user interface associated with a first function of the computer system. The method includes displaying, in the status region, status information about a second function of the computer system, wherein the status region is associated with an active session of the second function, and the second function is different from the first function. The method includes detecting one or more inputs corresponding to a request to perform an operation associated with a camera function of the computer system. The method includes, in response to detecting the one or more inputs corresponding to the request to perform the operation associated with the camera function, displaying in the status region status information about the camera function, including displaying a representation of a field of view of the one or more cameras that is updated over time in accordance with changes in the field of view of the one or more cameras.

In accordance with some embodiments, a method is performed at a computer system that is in communication with a plurality of hardware elements and with a display generation component having a display area. The method includes, while displaying, in display area outside of a status region of the display area, a first user interface, receiving an input via a first hardware element of the plurality of hardware elements. The method includes, in response to receiving the input via the first hardware element, displaying, in the status region, a first user interface object associated with the first hardware element. The method includes, while continuing to display, in the display area outside of the status region, the first user interface, receiving an input via a second hardware element of the plurality of hardware elements, wherein the second hardware element is different from the first hardware element. The method includes, in response to receiving the input via the second hardware element, displaying, in the status region, a second user interface object associated with the second hardware element, wherein the second user interface object is different from the first user interface object.

In accordance with some embodiments, an electronic device includes a display (or more generally, a display generation component), a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing and updating status information, thereby increasing the effectiveness, efficiency, and user satisfaction with such devices. Such methods and interfaces may complement or replace conventional methods for providing and updating status information.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5DD illustrate example user interfaces for updating content in a session region in accordance with some embodiments.

FIGS. 6A-6B are flow diagrams of a process for automatically displaying content in a session region based on a current context of a device in accordance with some embodiments.

FIGS. 7A-7D are flow diagrams of a process for displaying notification content generally and for using a session region to display notification content in accordance with some embodiments.

FIGS. 8A-8C are flow diagrams of a process for enabling a user to manually select content for display in a session region in accordance with some embodiments.

FIGS. 9A-9C are flow diagrams of a process for displaying camera information in a session region in accordance with some embodiments.

FIGS. 10A-10D are flow diagrams of a process for displaying user interfaces in a session region in response to inputs via corresponding hardware elements in accordance with some embodiments.

### DESCRIPTION OF EMBODIMENTS

Many electronic devices have graphical user interfaces that provide status information and status updates for functions and processes of a computer system. Conventional methods of providing and updating status information are often limited in functionality. In some cases, the status information displayed is not sufficiently relevant to a user or device's current context. In some cases, displaying the status information takes too much focus away from and/or interrupts interaction with other displayed user interfaces. In some cases, the session region is not sufficiently user-configurable or is not configured to display certain types of status information. The embodiments described herein provide intuitive ways for a user to view relevant, desired status information in a session region while being able to continue to interact with one or more other user interfaces displayed concurrently with and outside of the session region, and while enabling the session region to support displaying more types of status information.

The methods, devices, and GUIs described herein improve user interface interactions related to displayed status information in multiple ways. For example, they make it easier to view context-relevant status information and to view more types of status information in the session region, to view status information less intrusively to reduce interruption to interaction with other displayed user interfaces, and to enable a user to configure which status information is displayed in the session region, thereby eliminating the need for extra, separate steps to view a particular status update.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, improving privacy and/or security, reducing the amount of display area needed to display notifications and/or status information and thus increasing the amount of display area available for other applications to display information, and/or additional techniques. These techniques also reduce power usage and improve battery life of the device by enabling the user to use the device more quickly and efficiently. Saving on battery power, and thus weight, improves the ergonomics of the device.

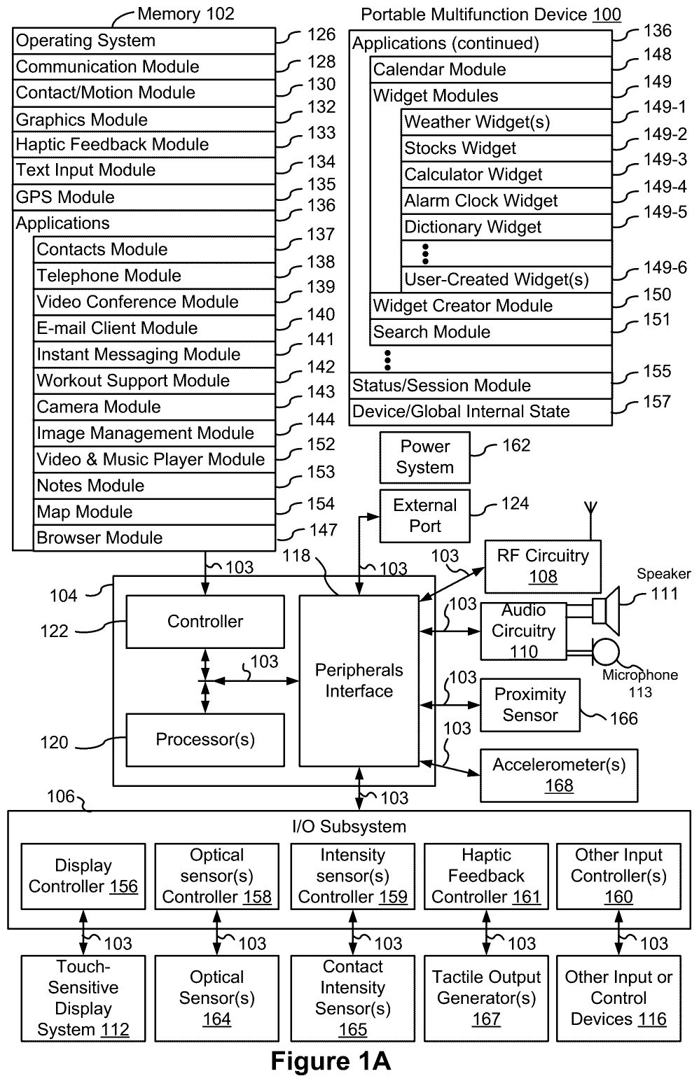

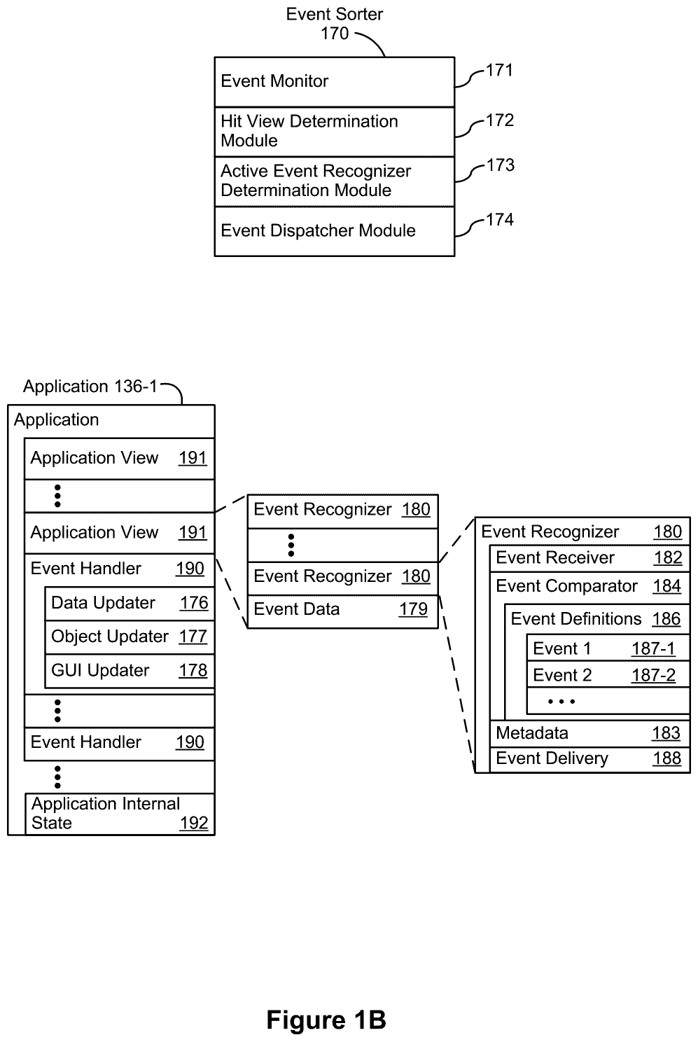

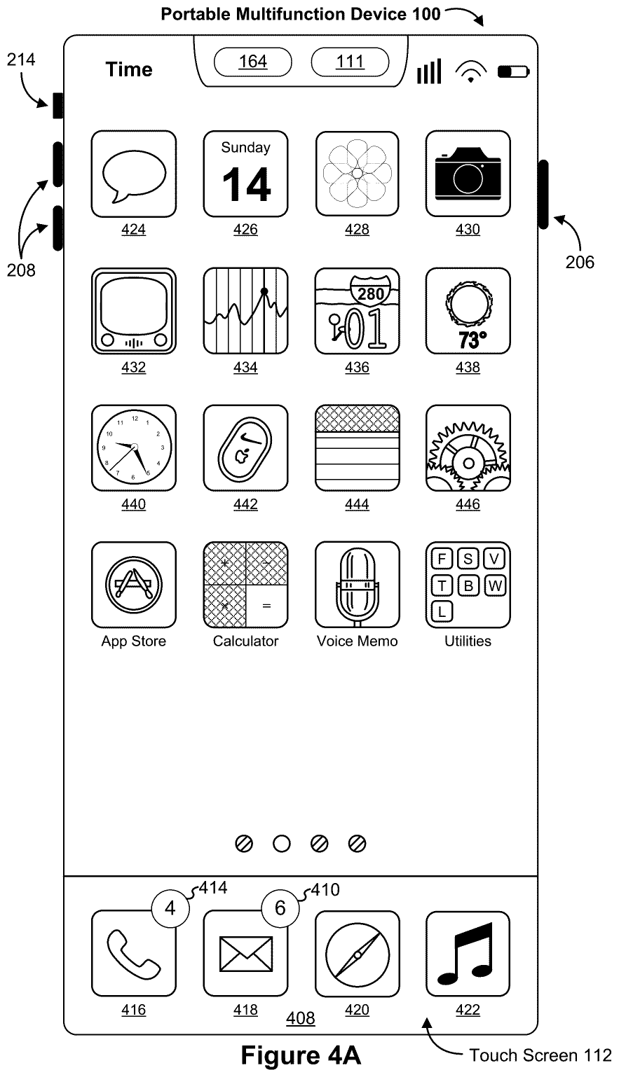

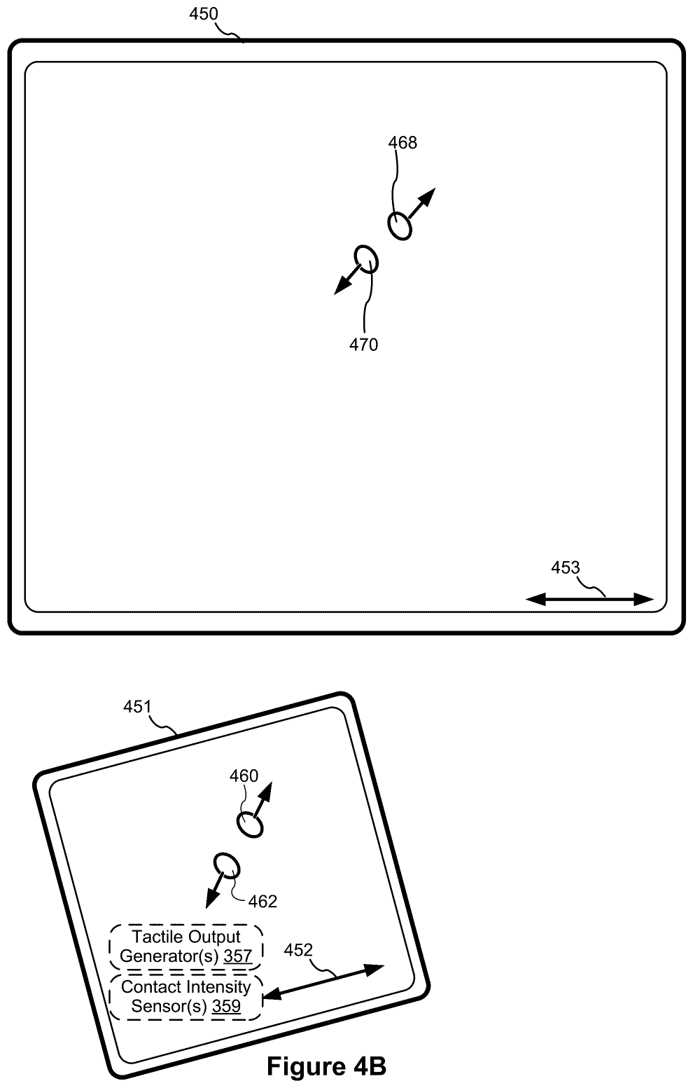

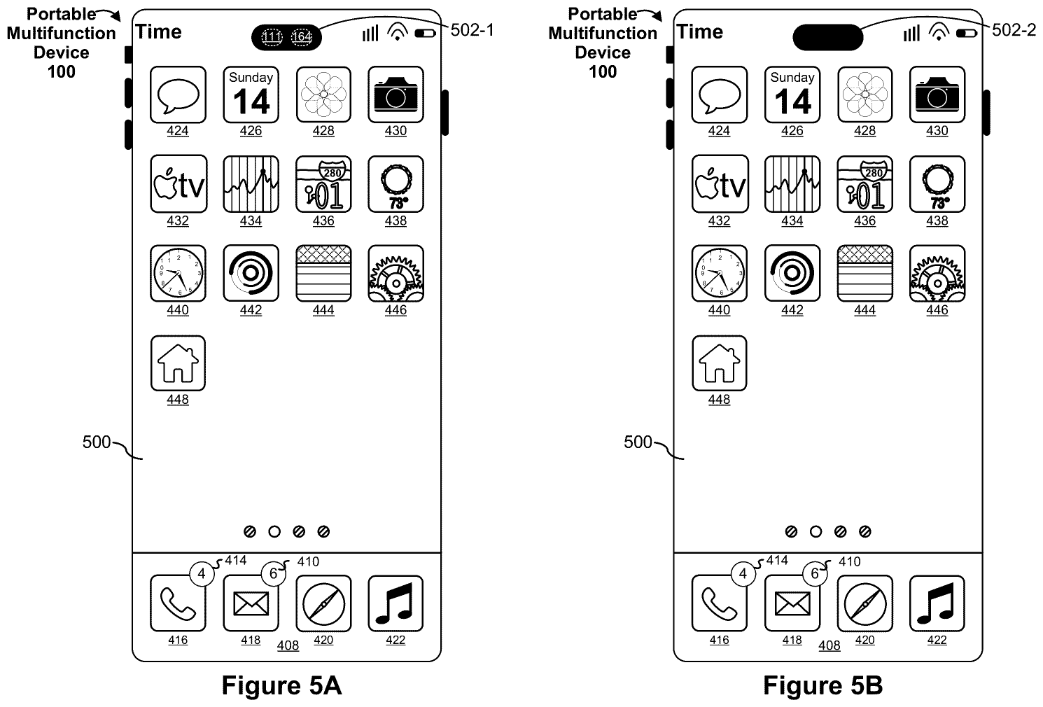

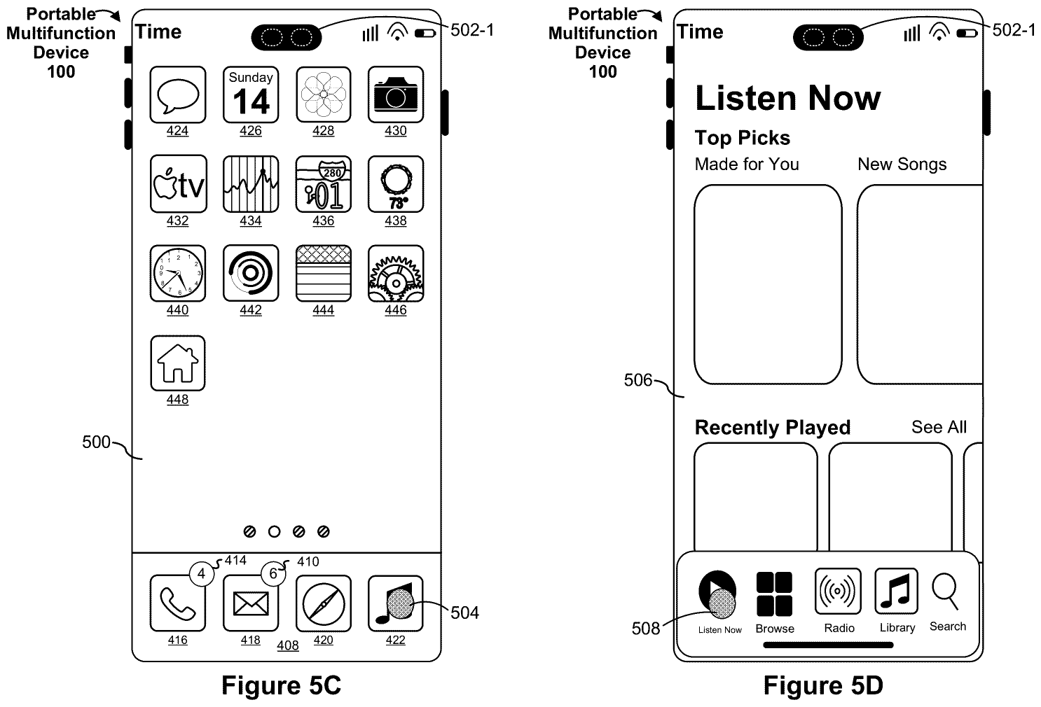

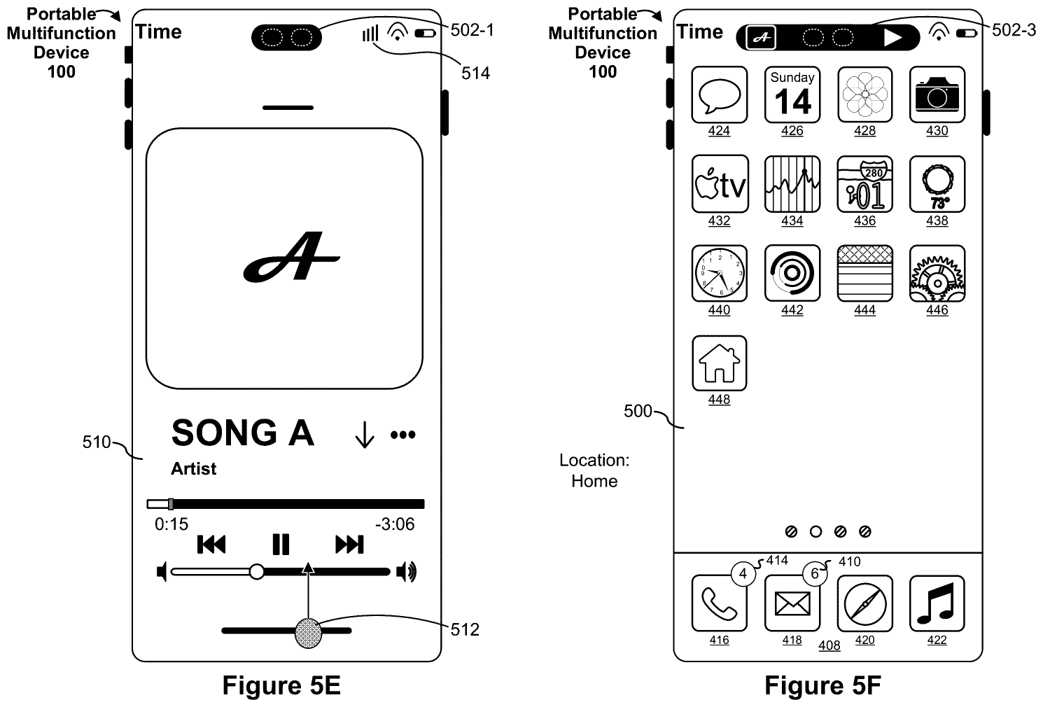

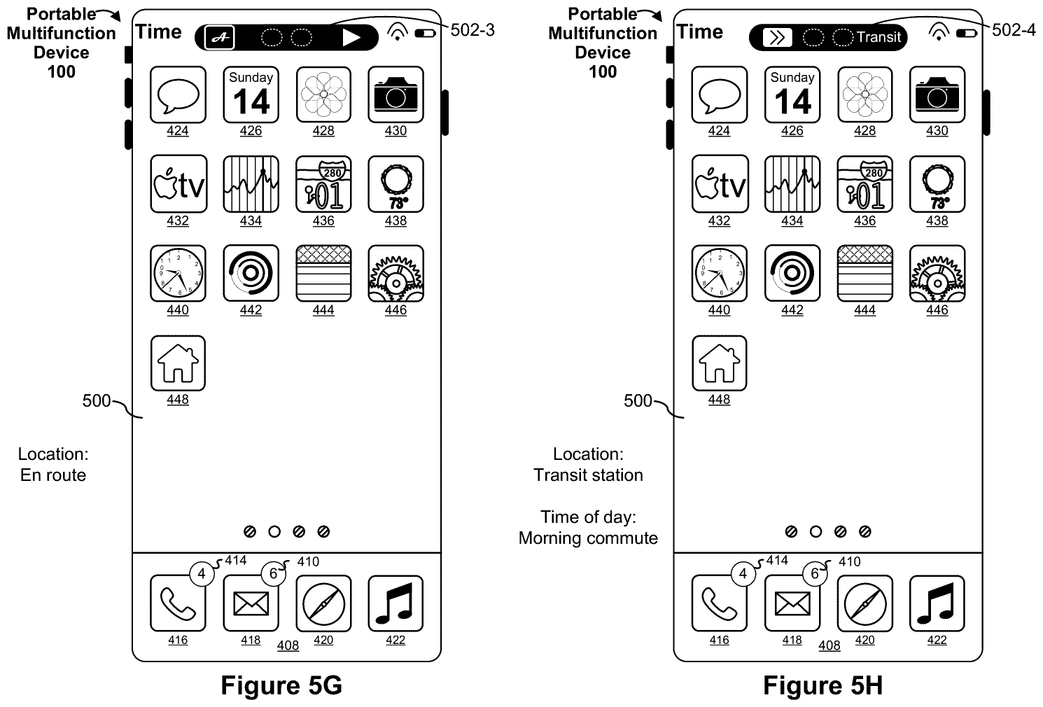

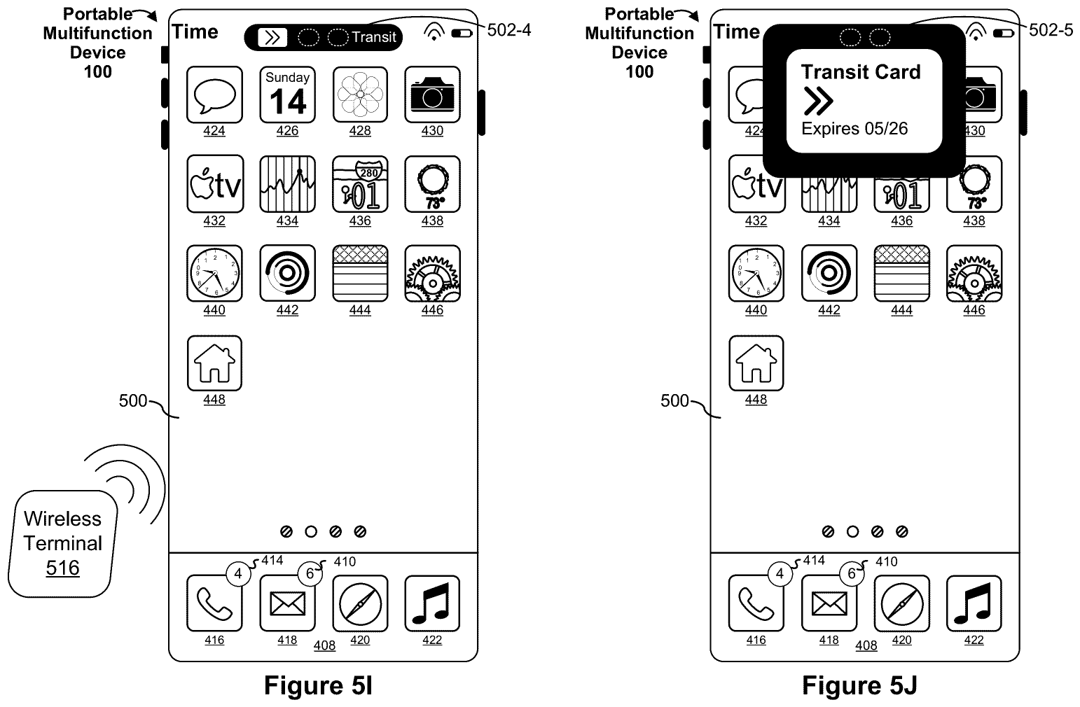

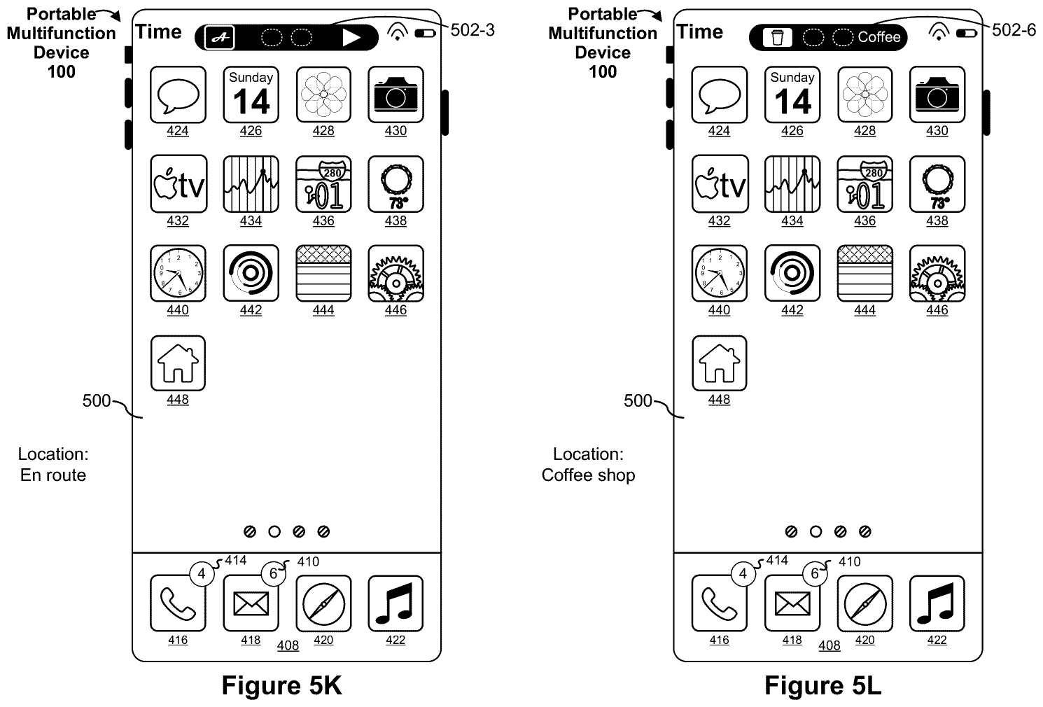

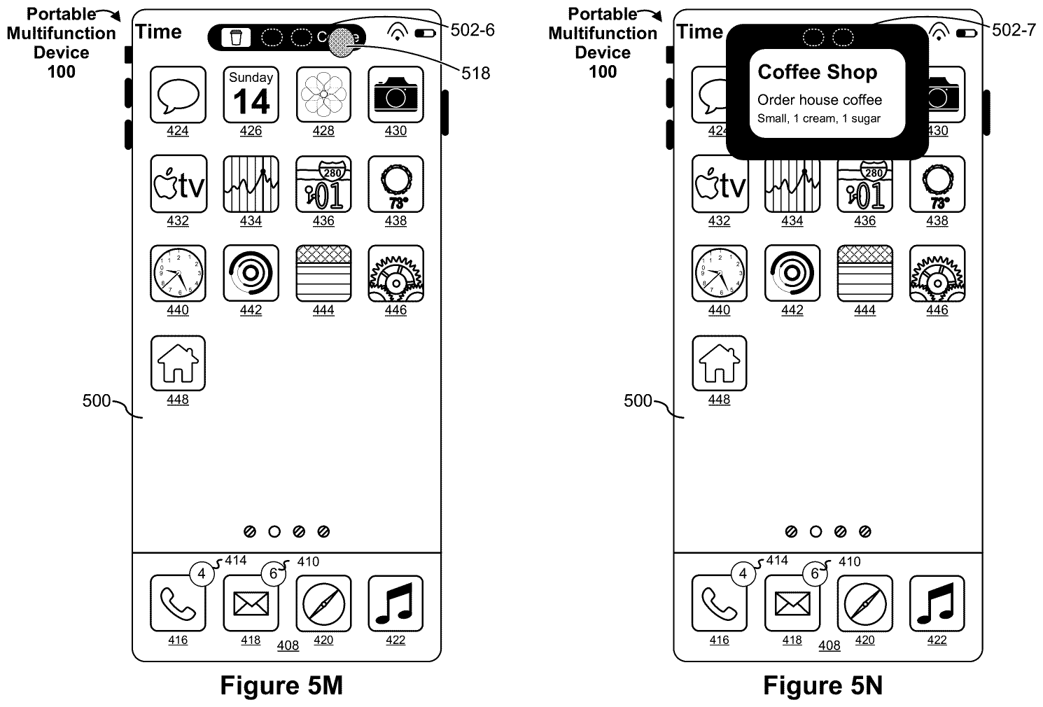

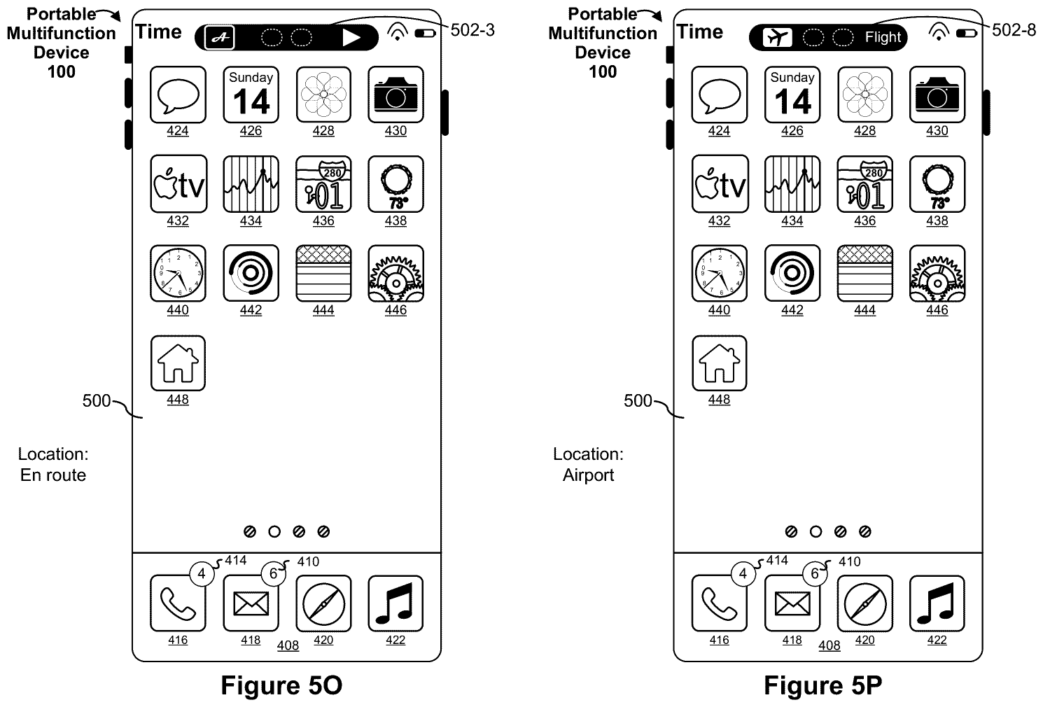

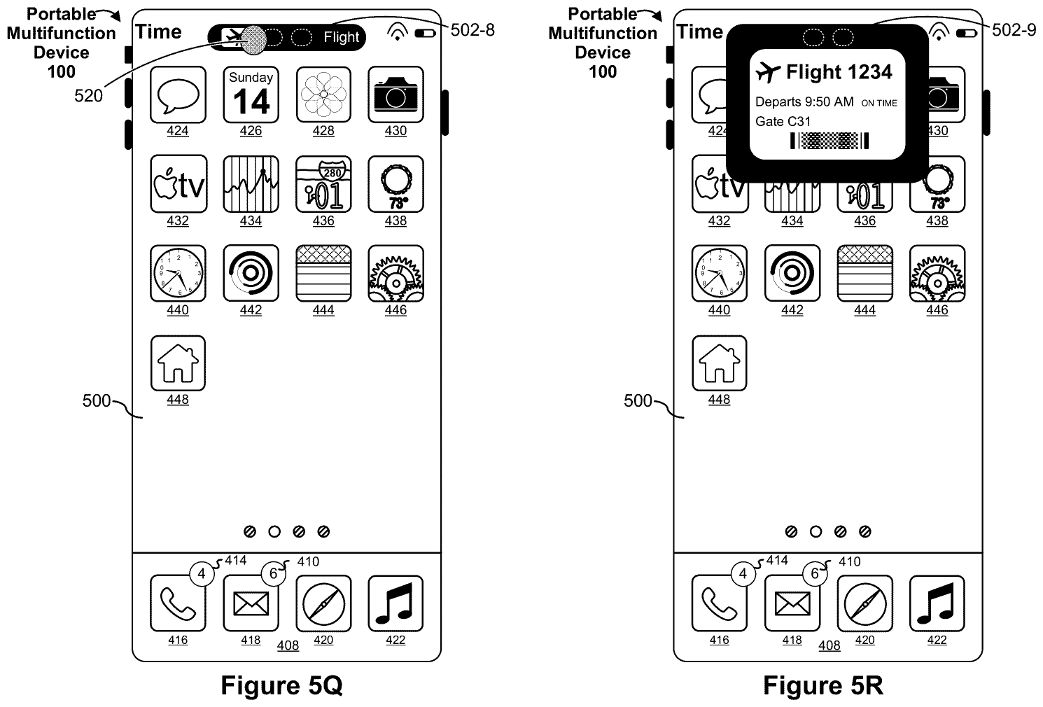

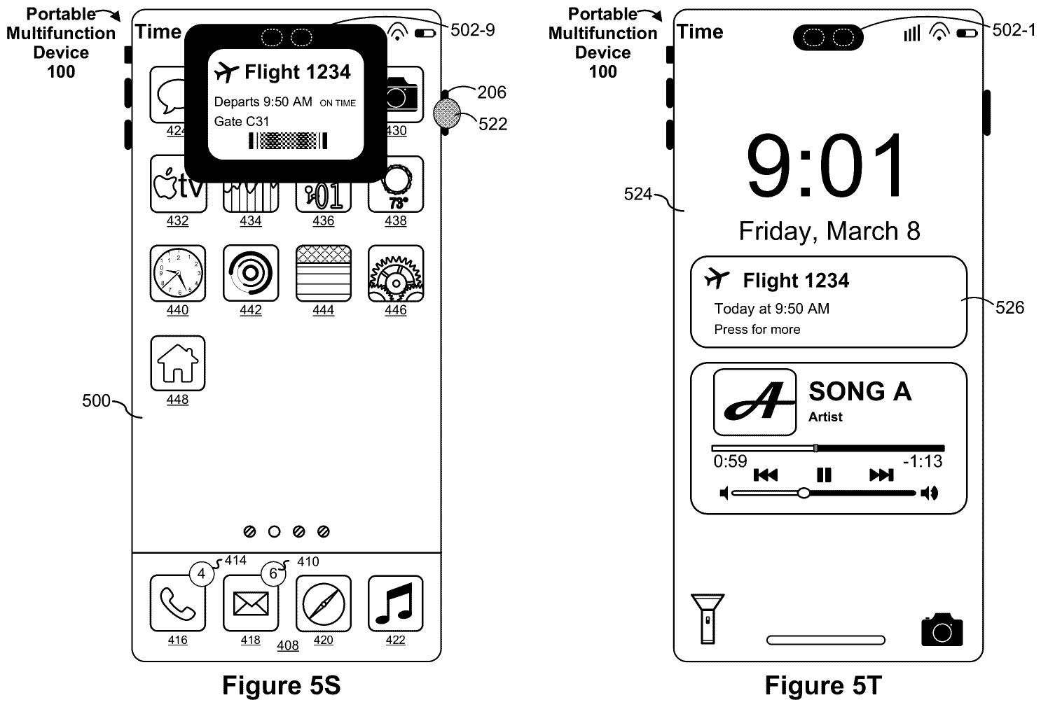

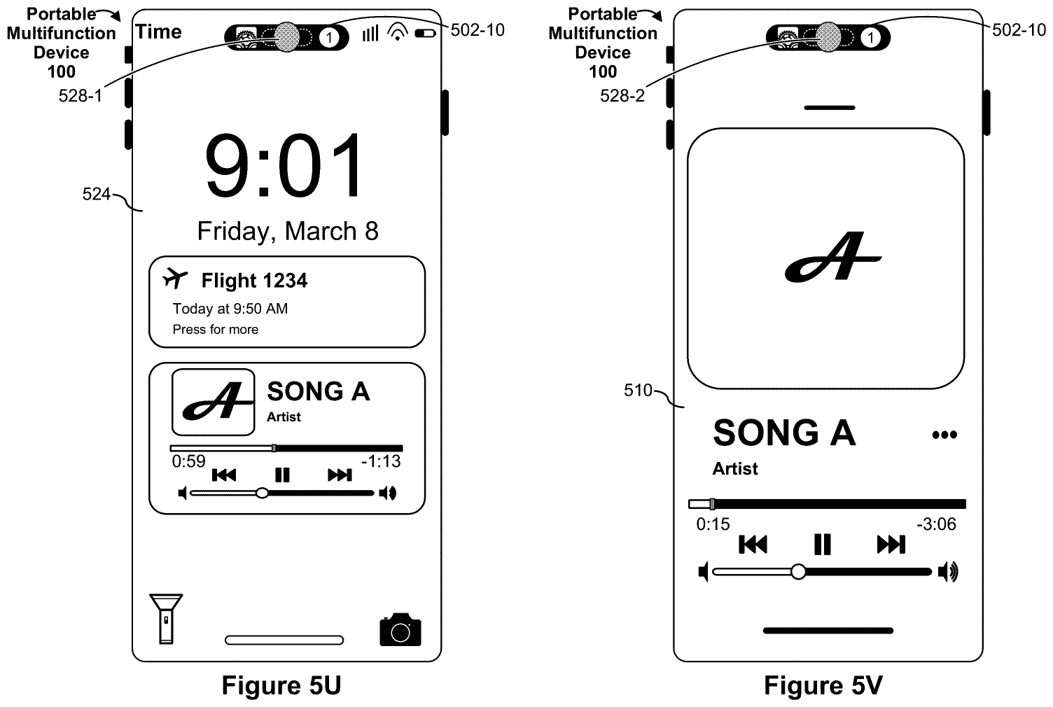

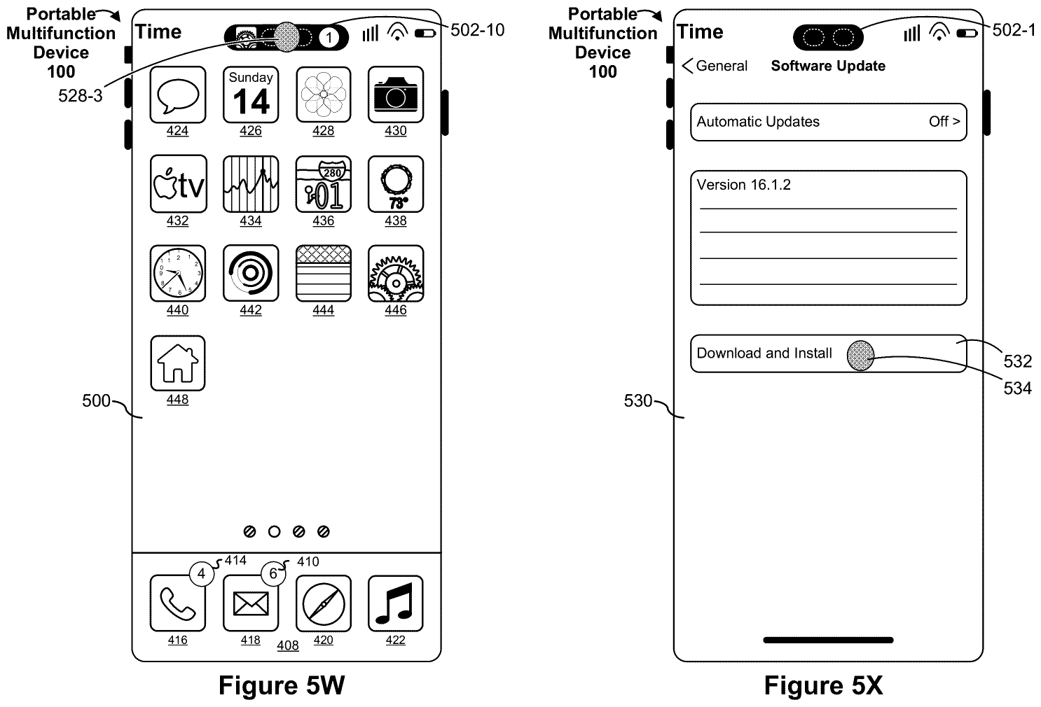

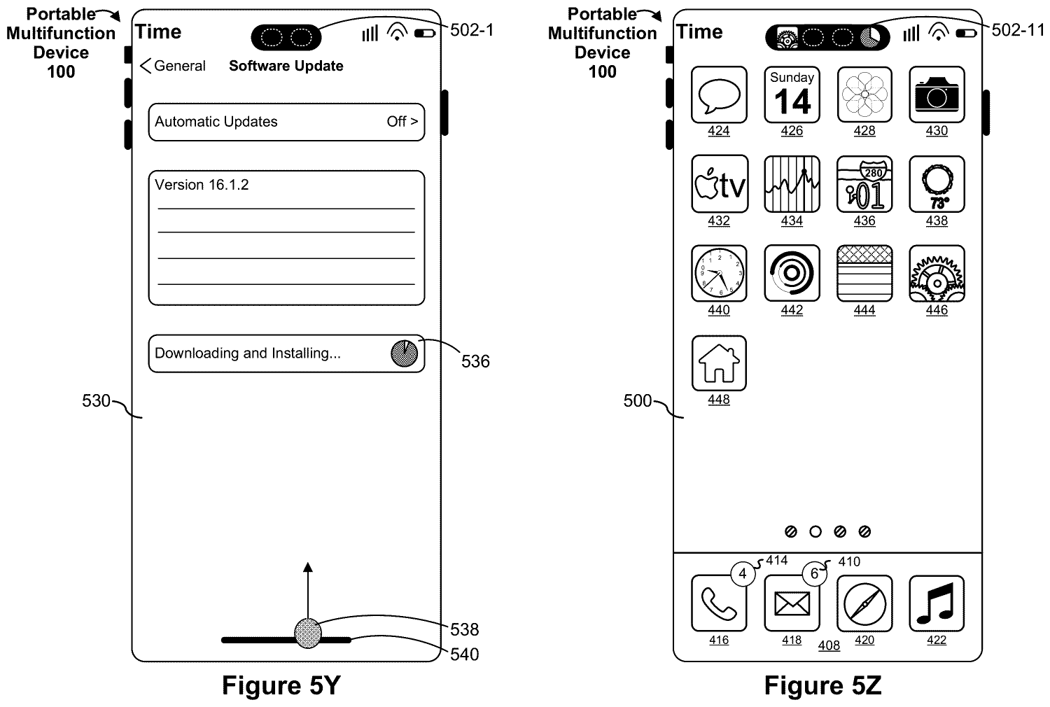

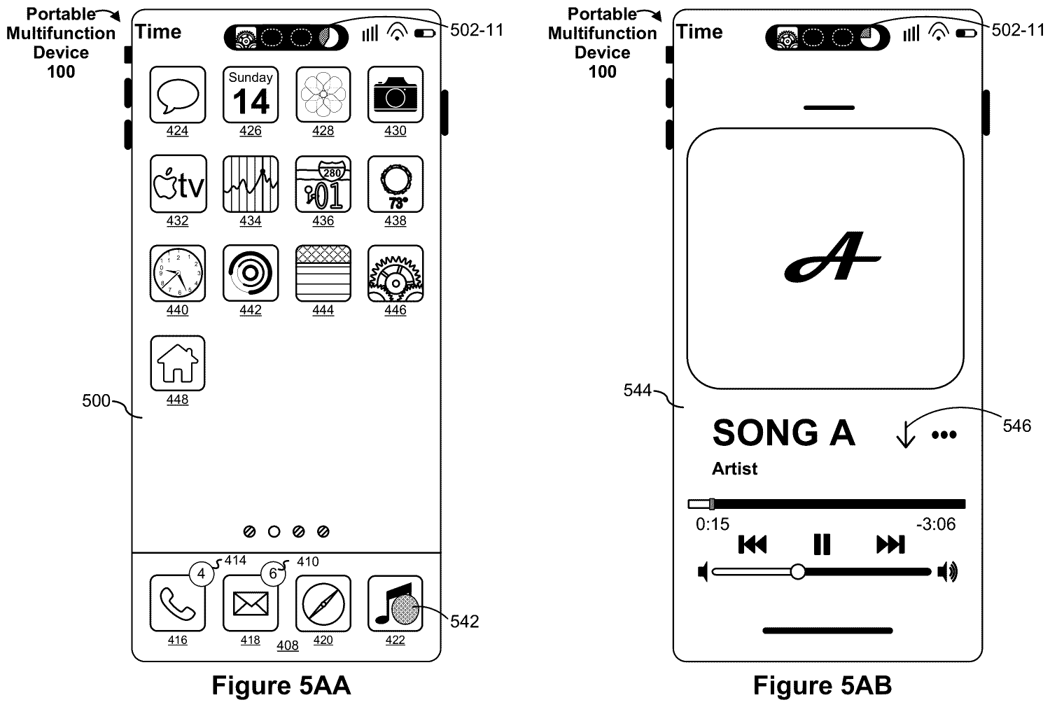

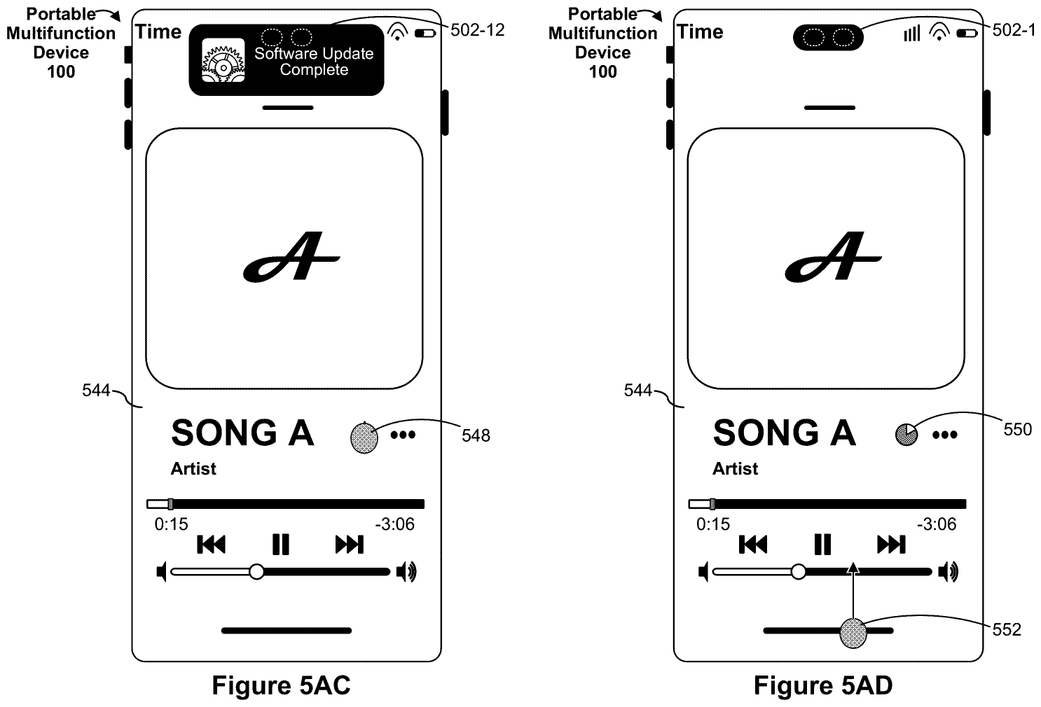

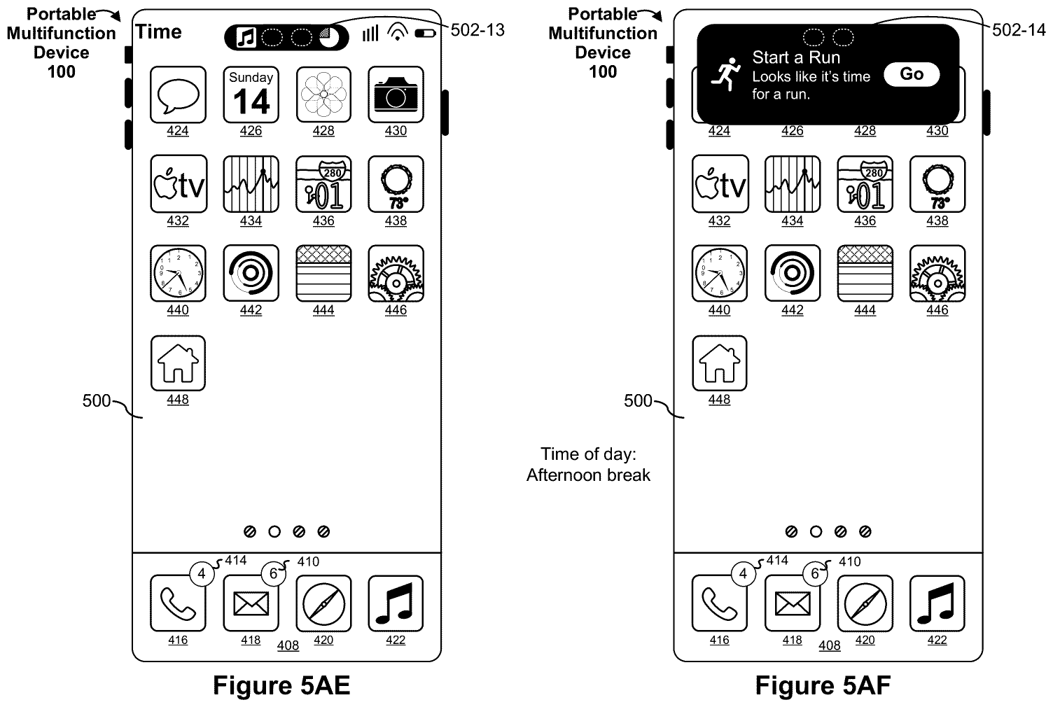

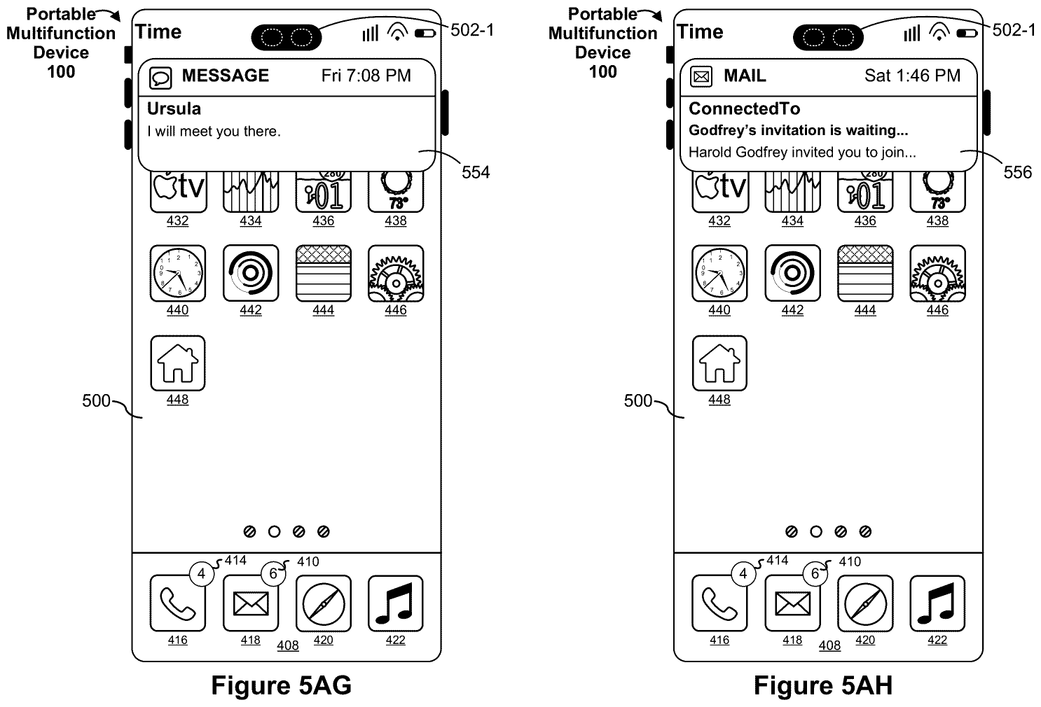

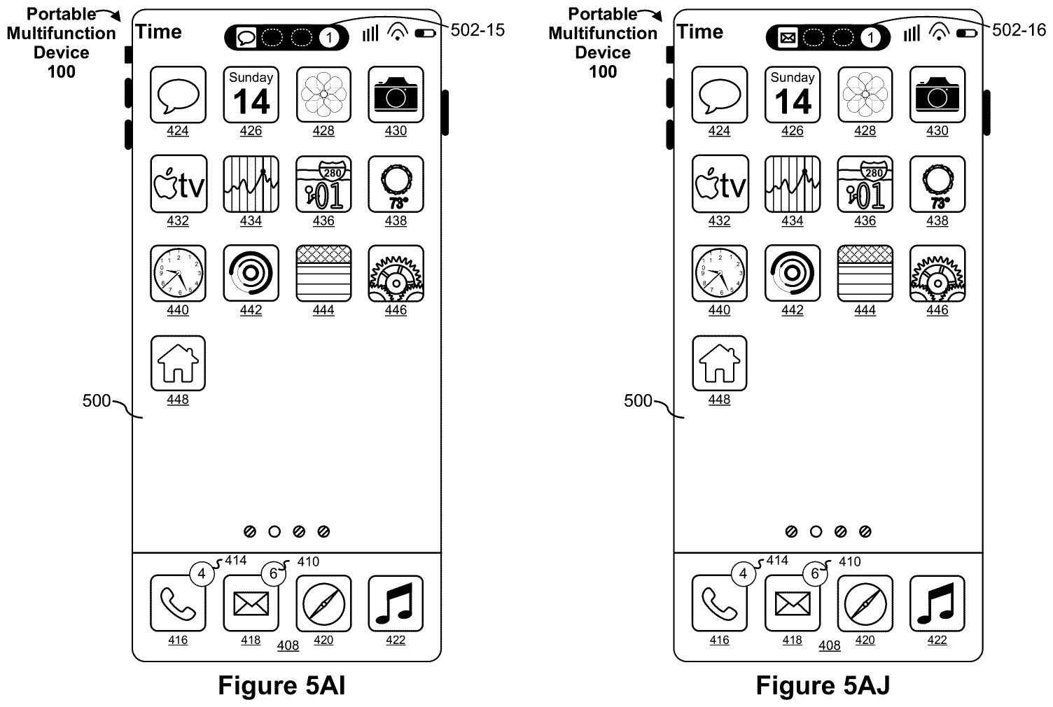

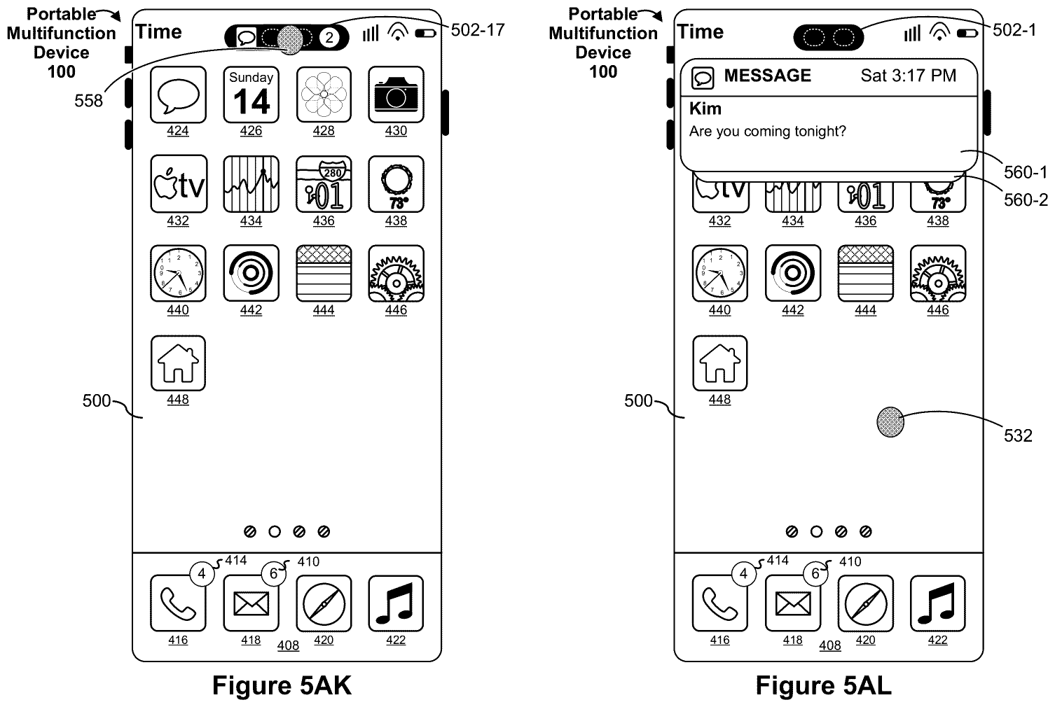

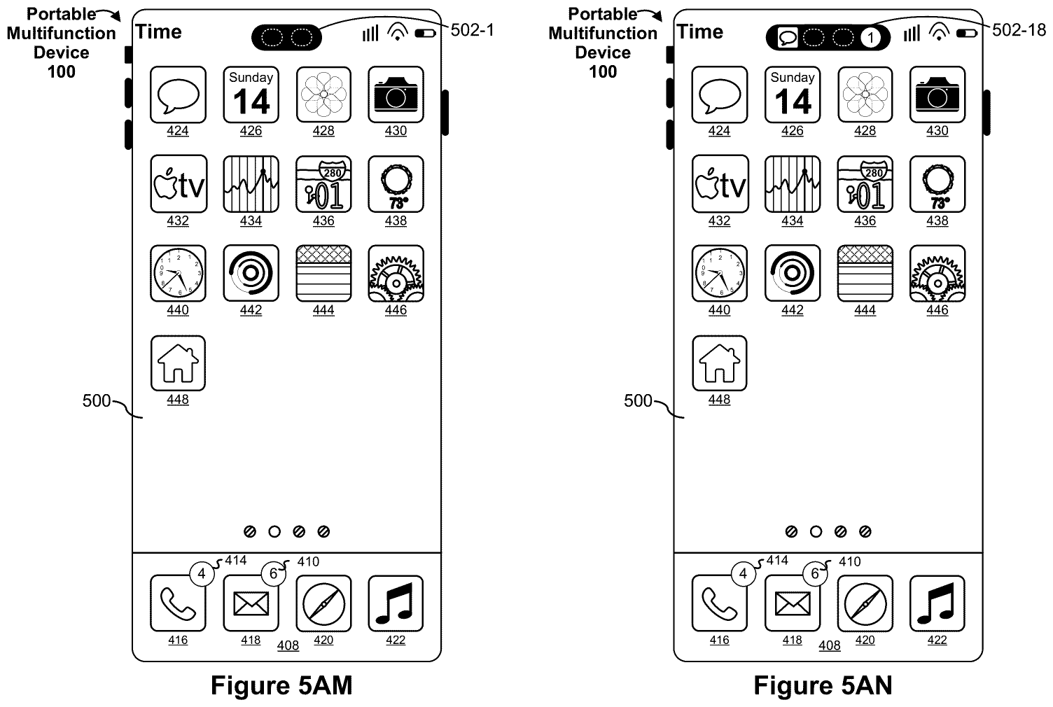

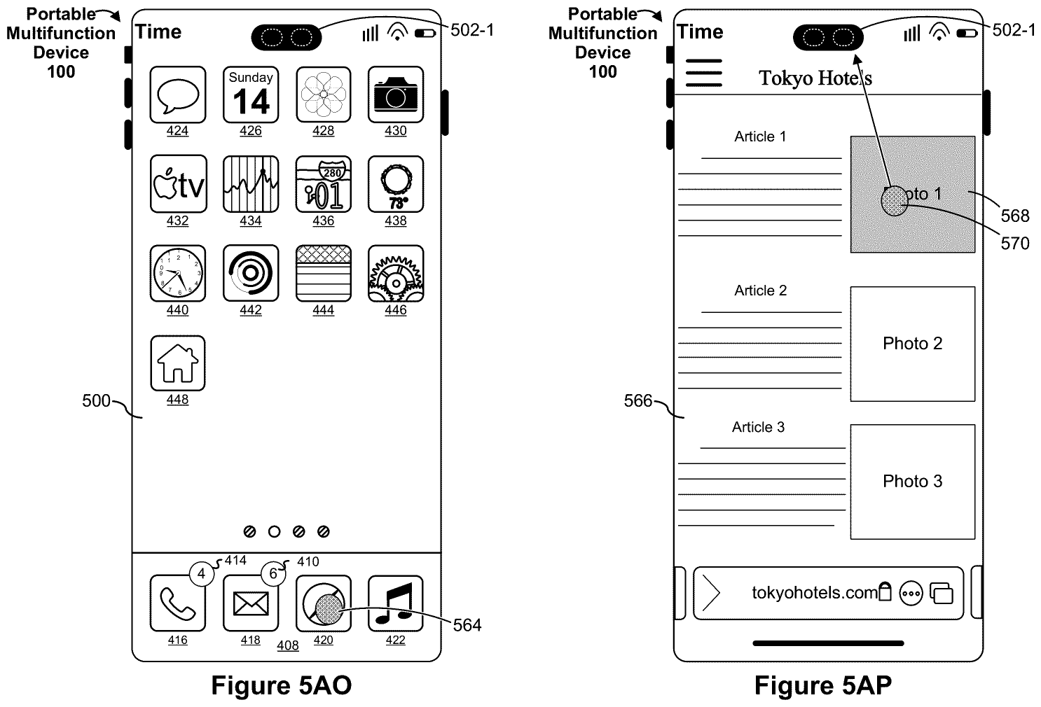

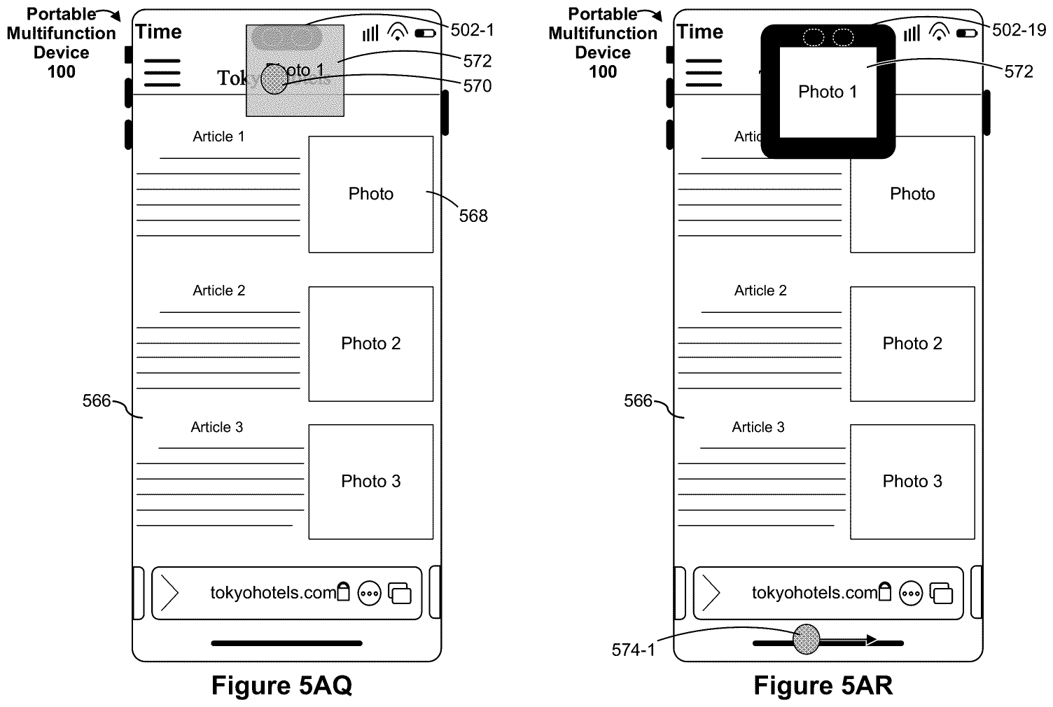

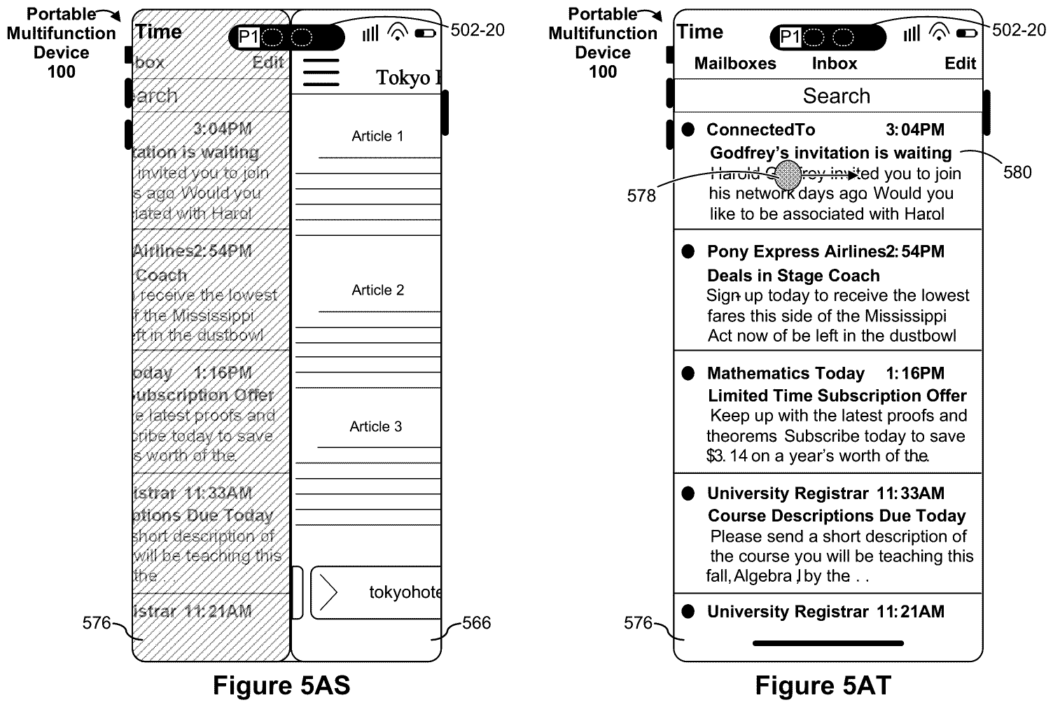

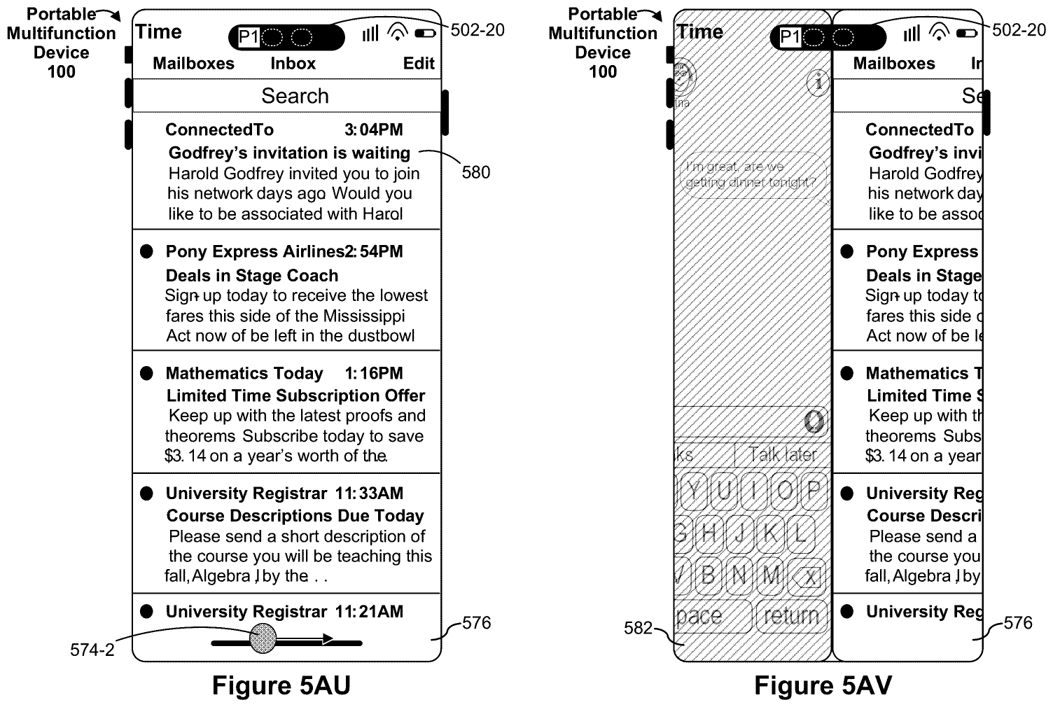

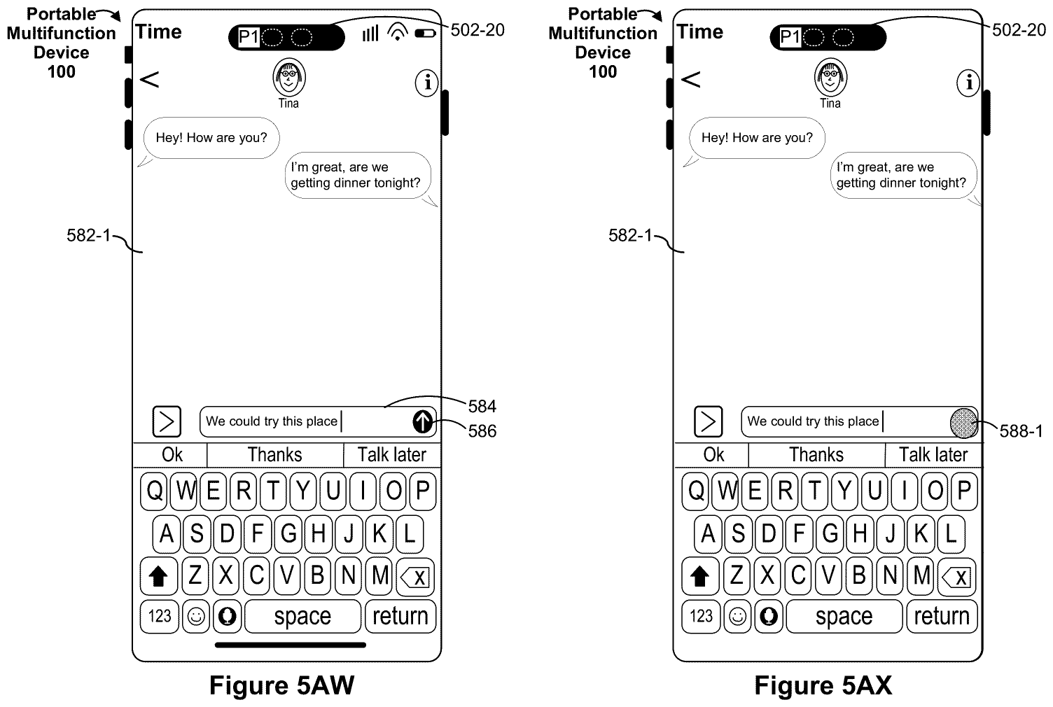

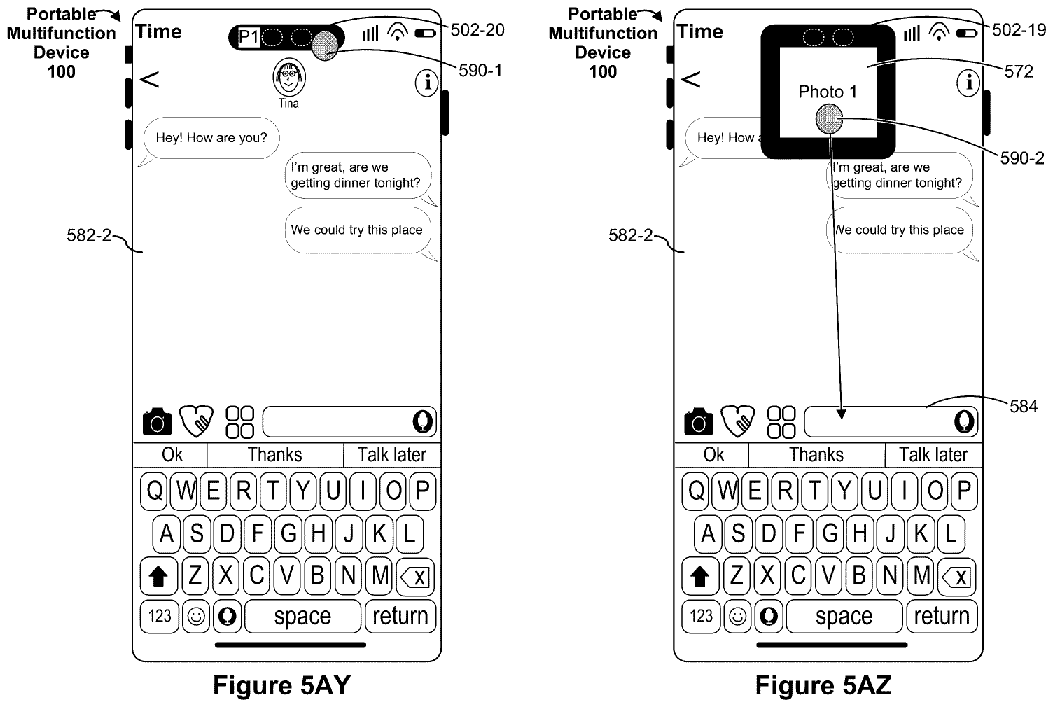

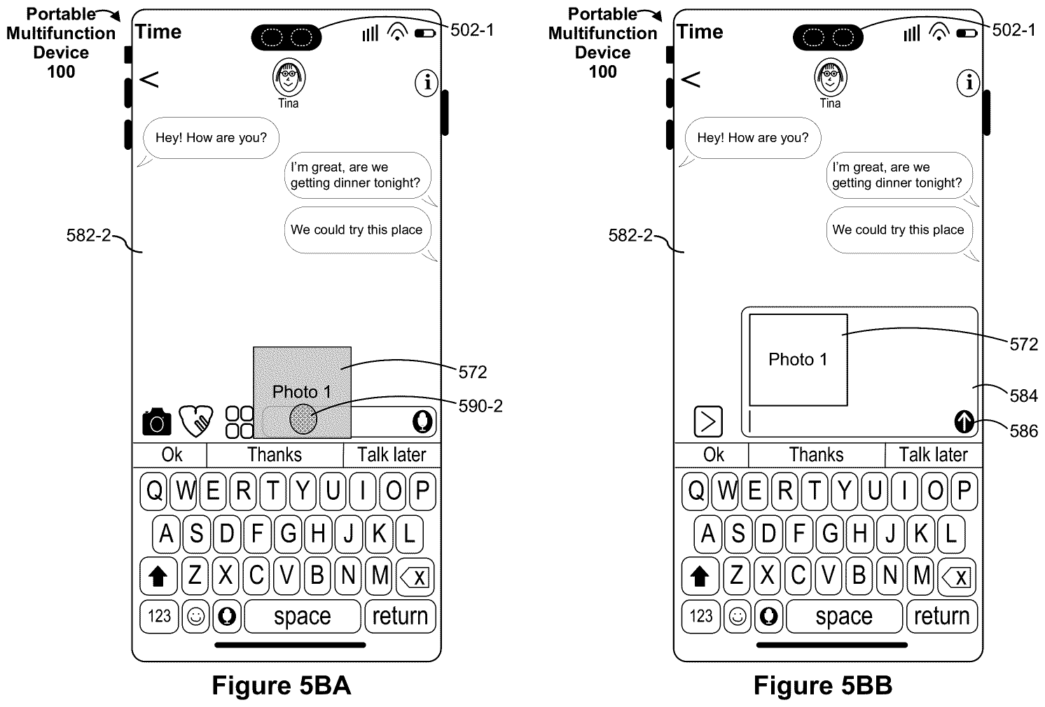

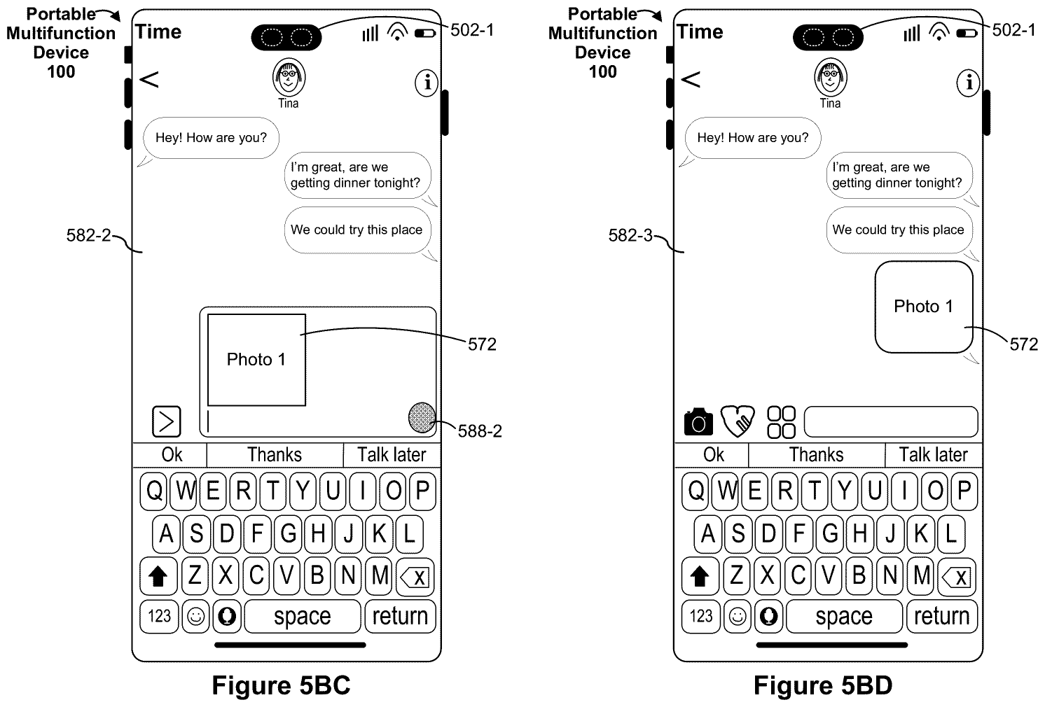

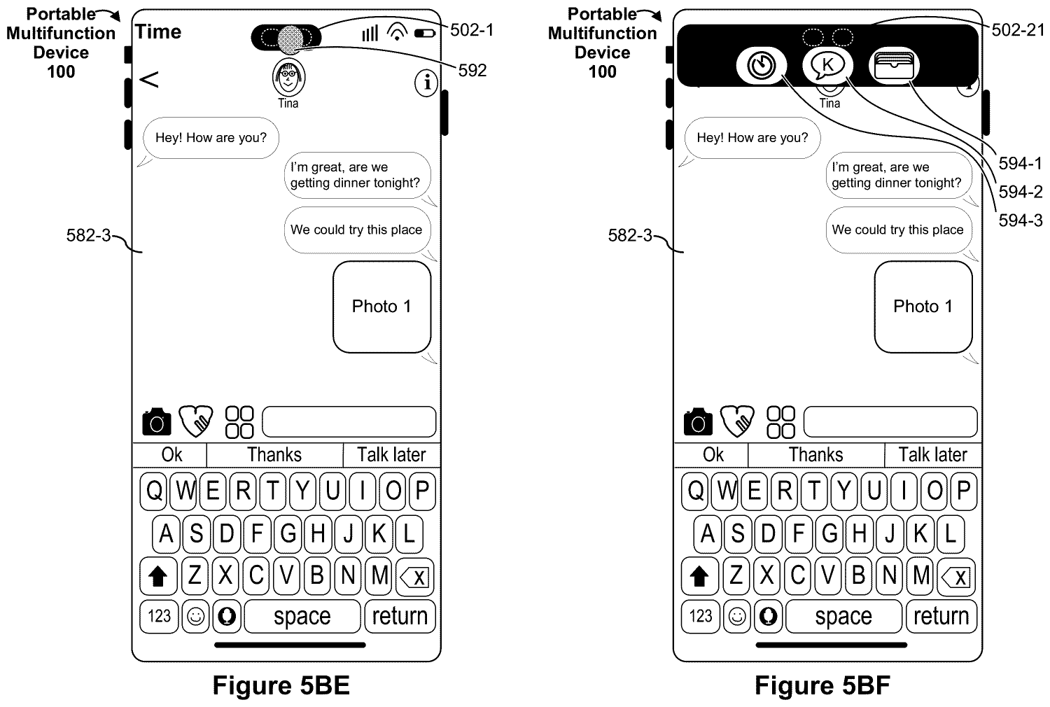

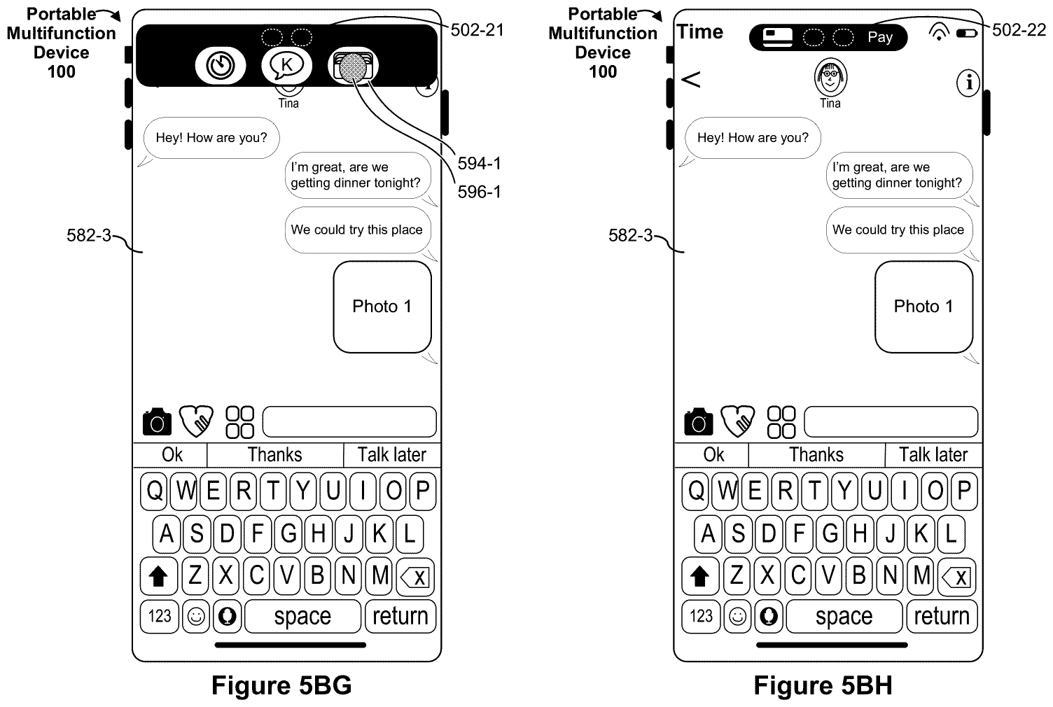

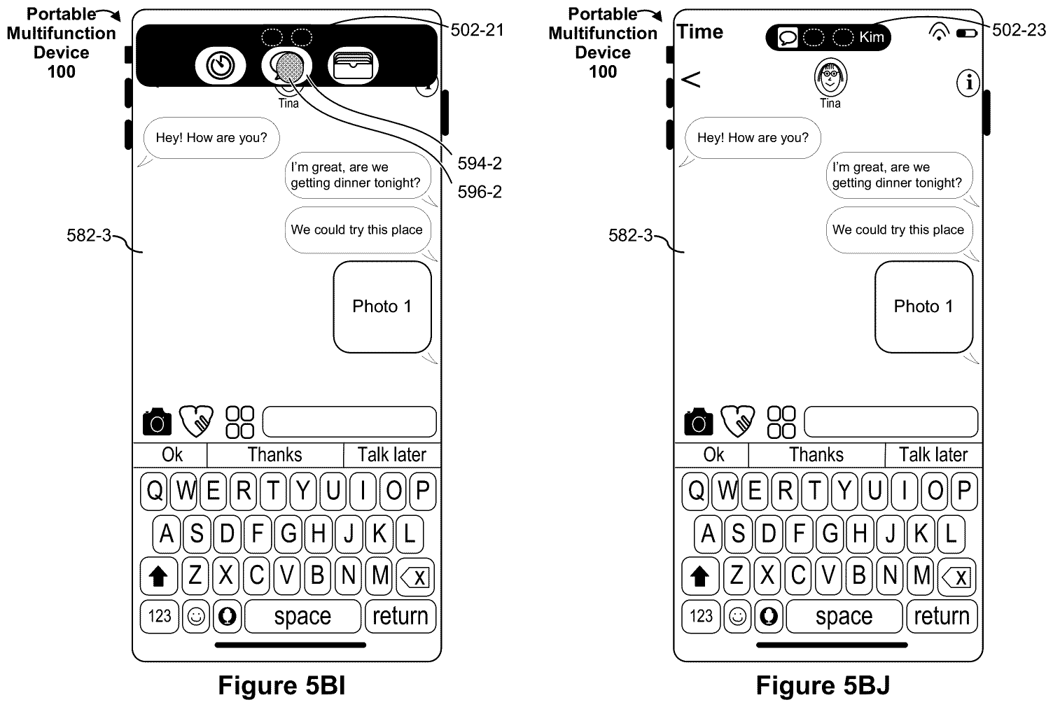

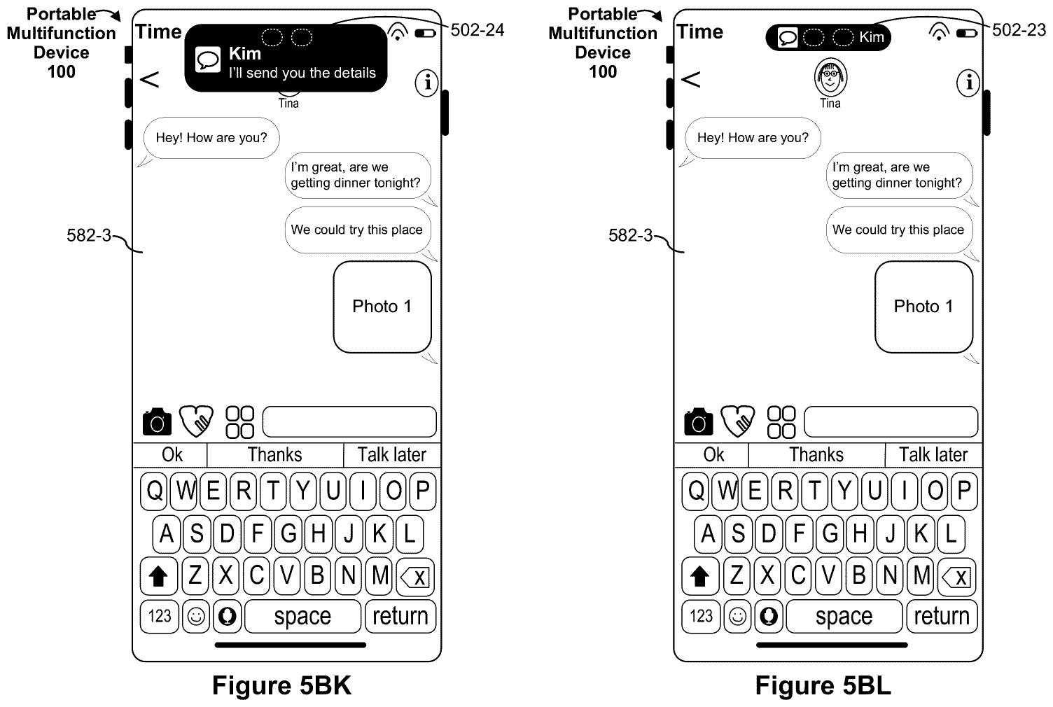

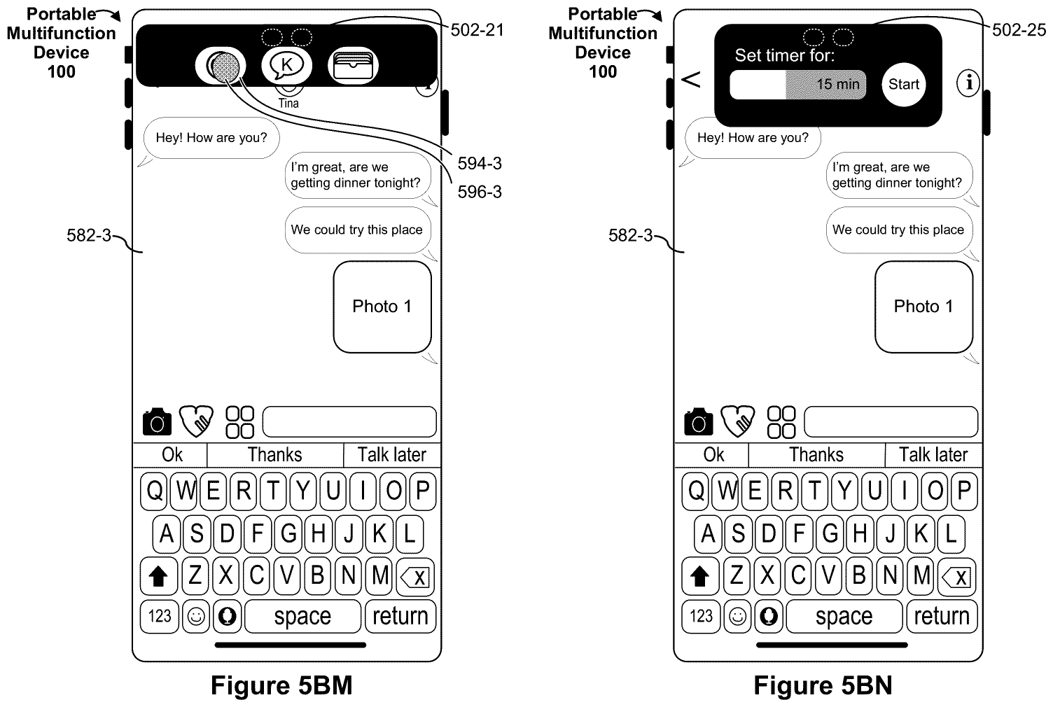

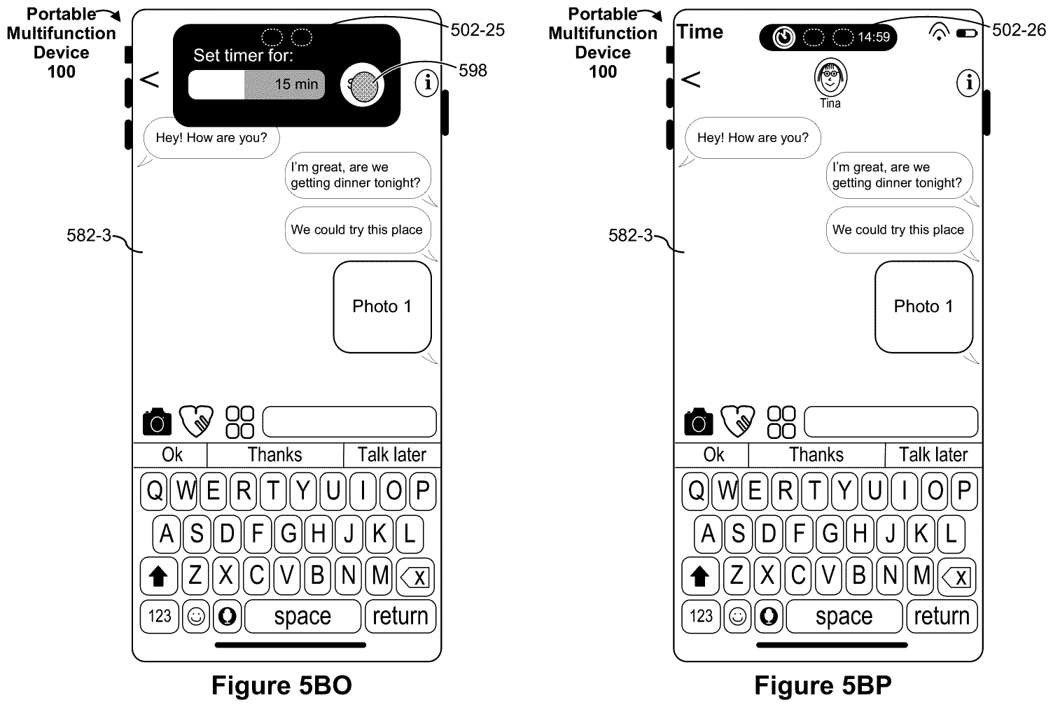

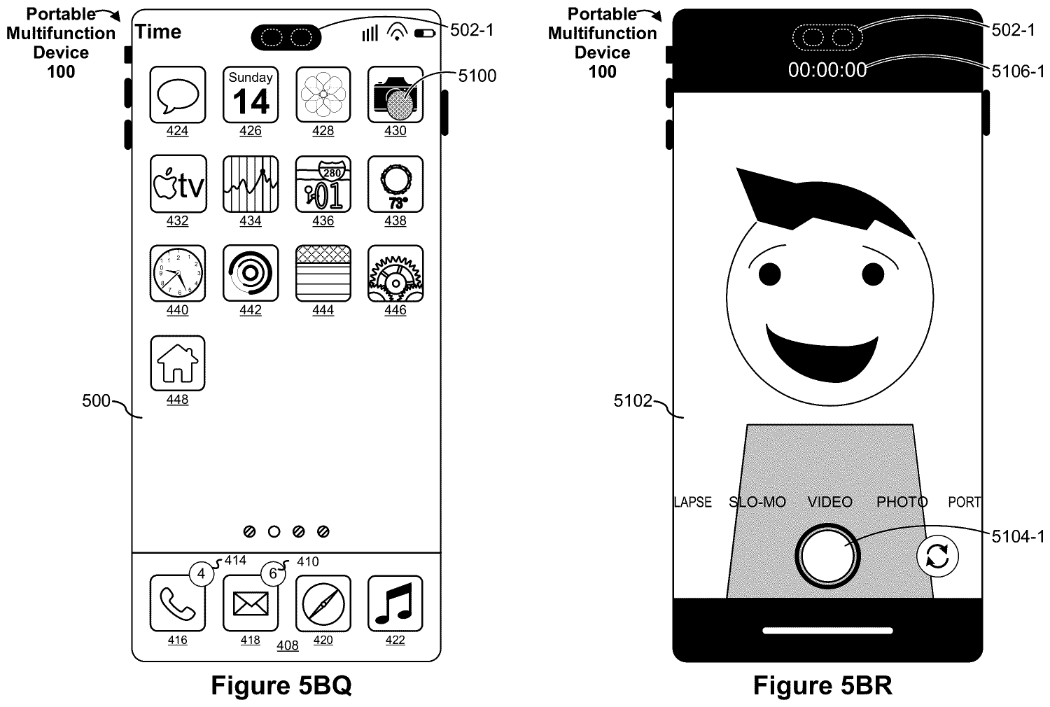

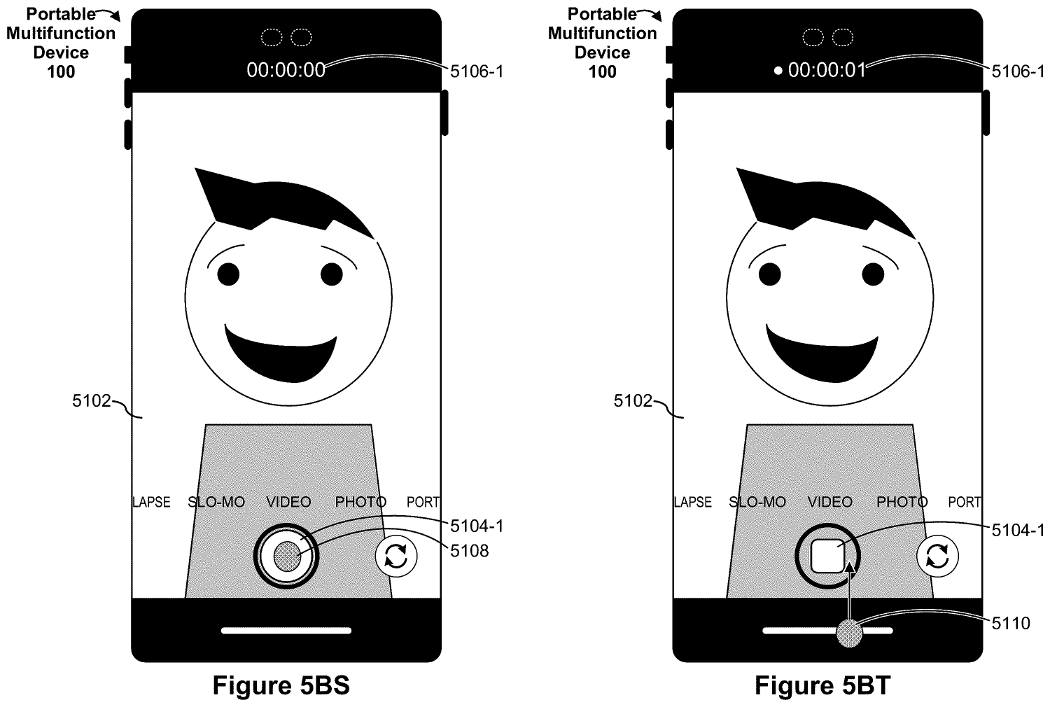

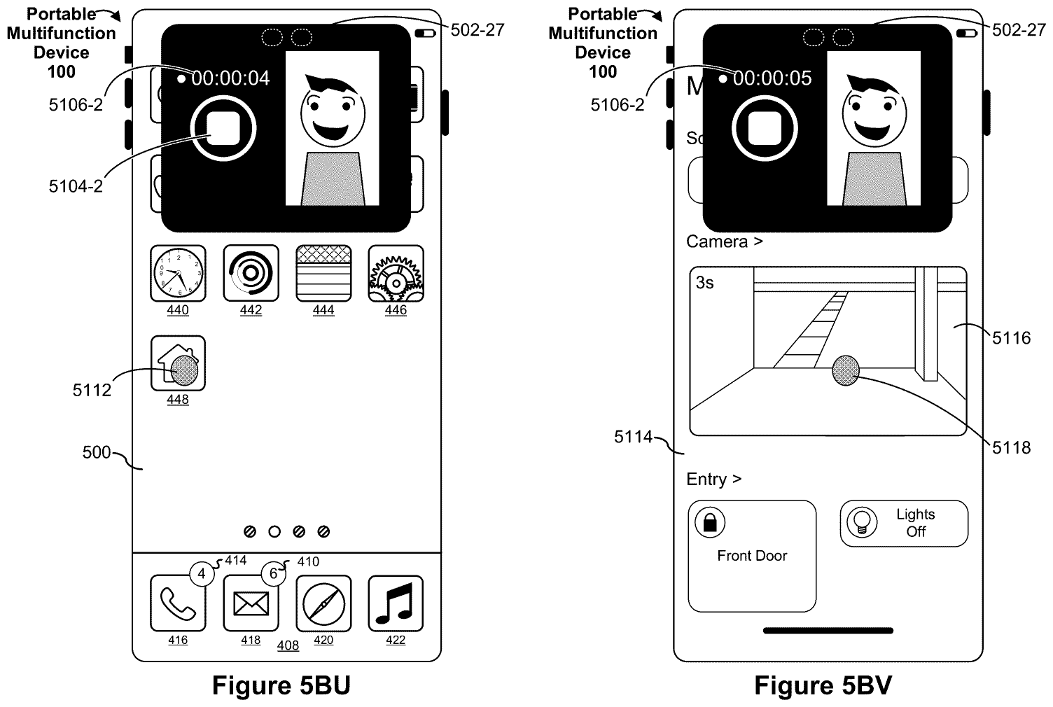

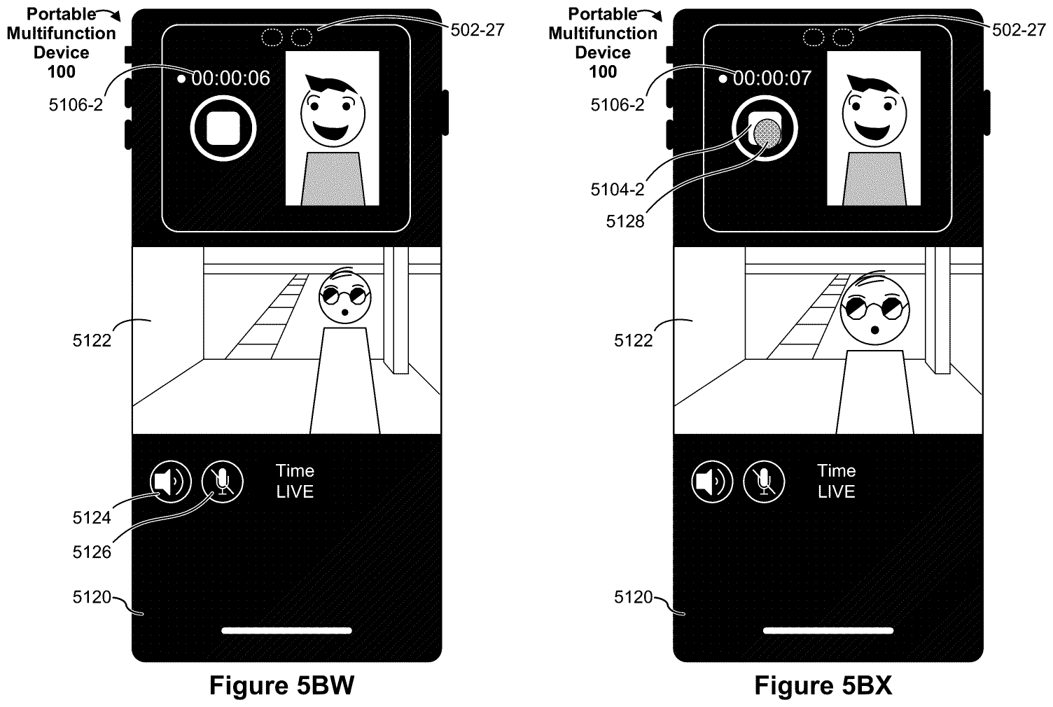

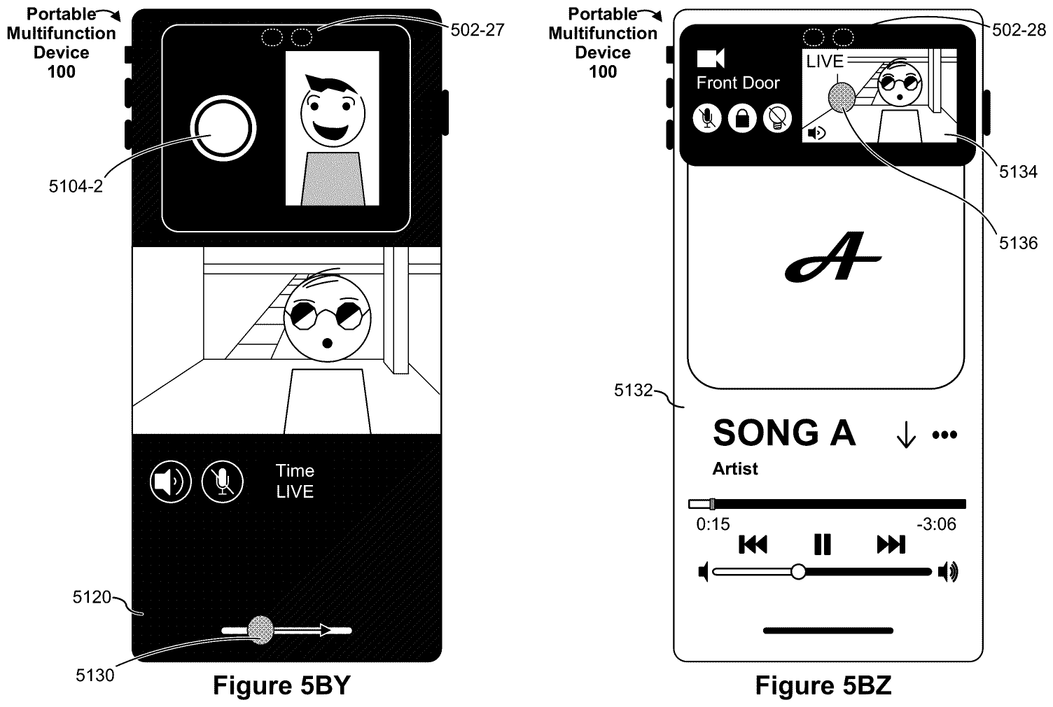

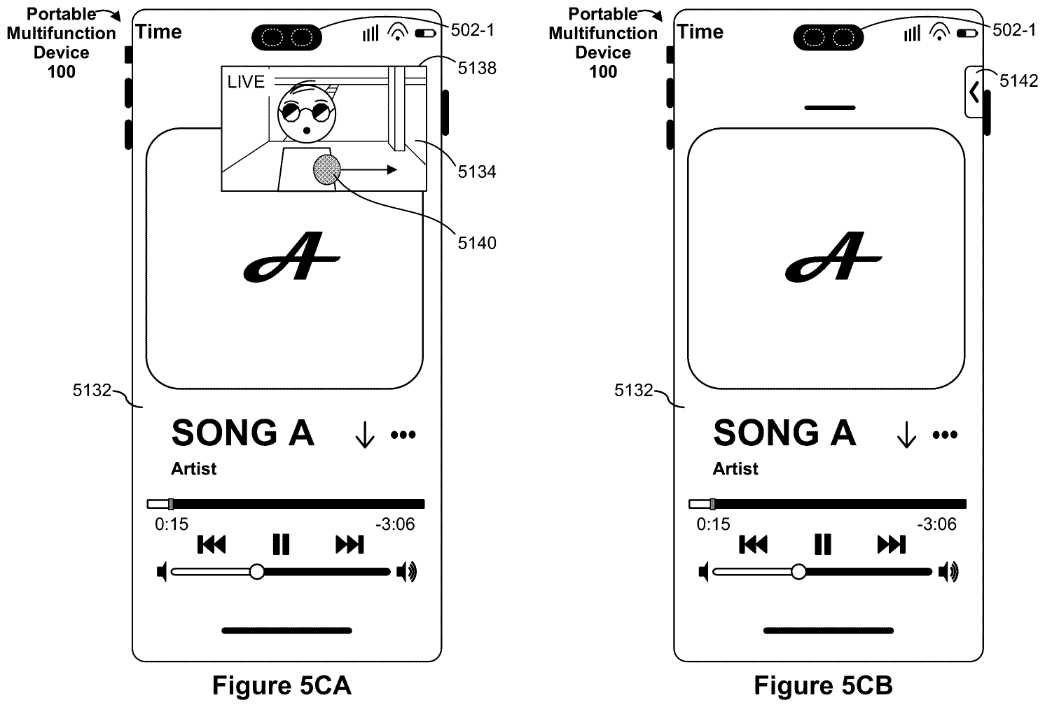

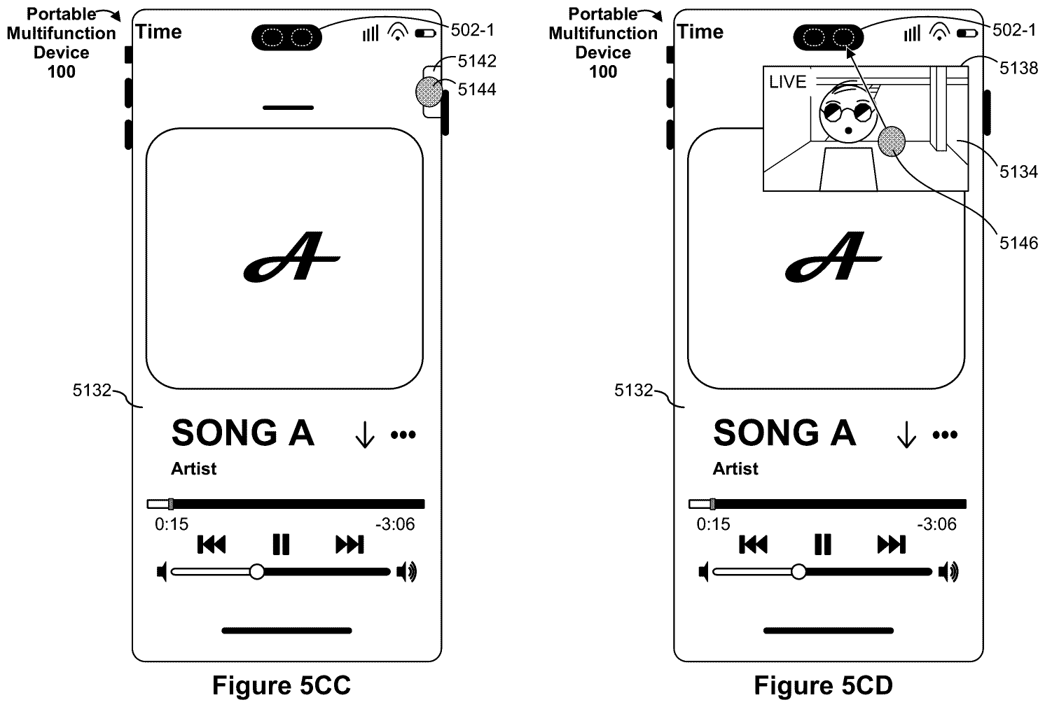

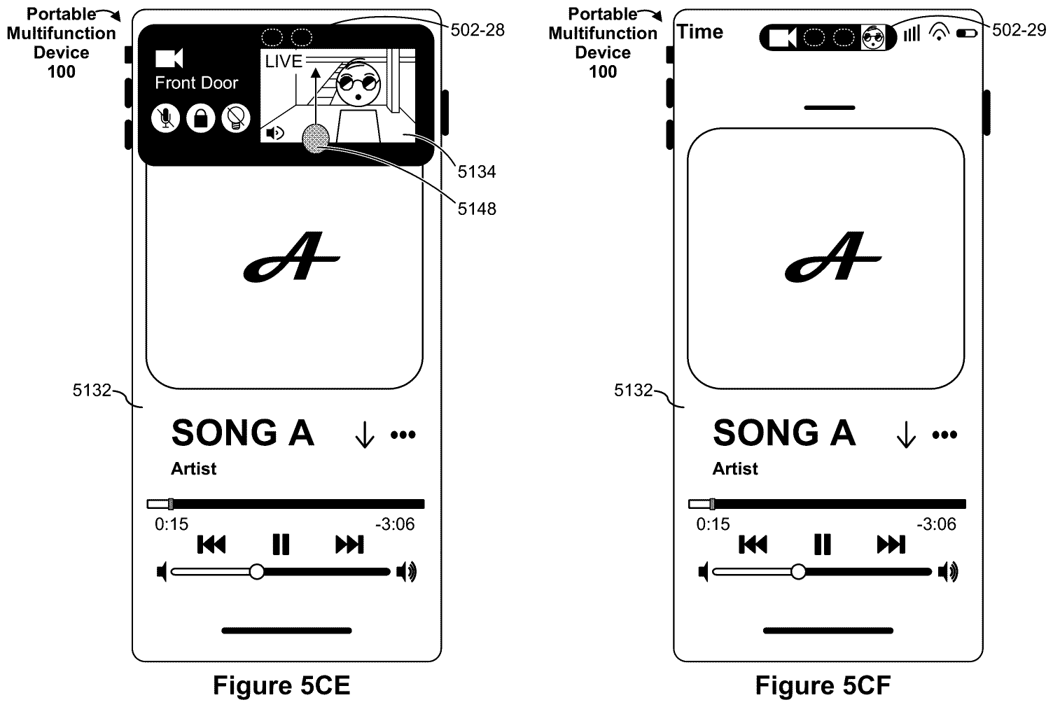

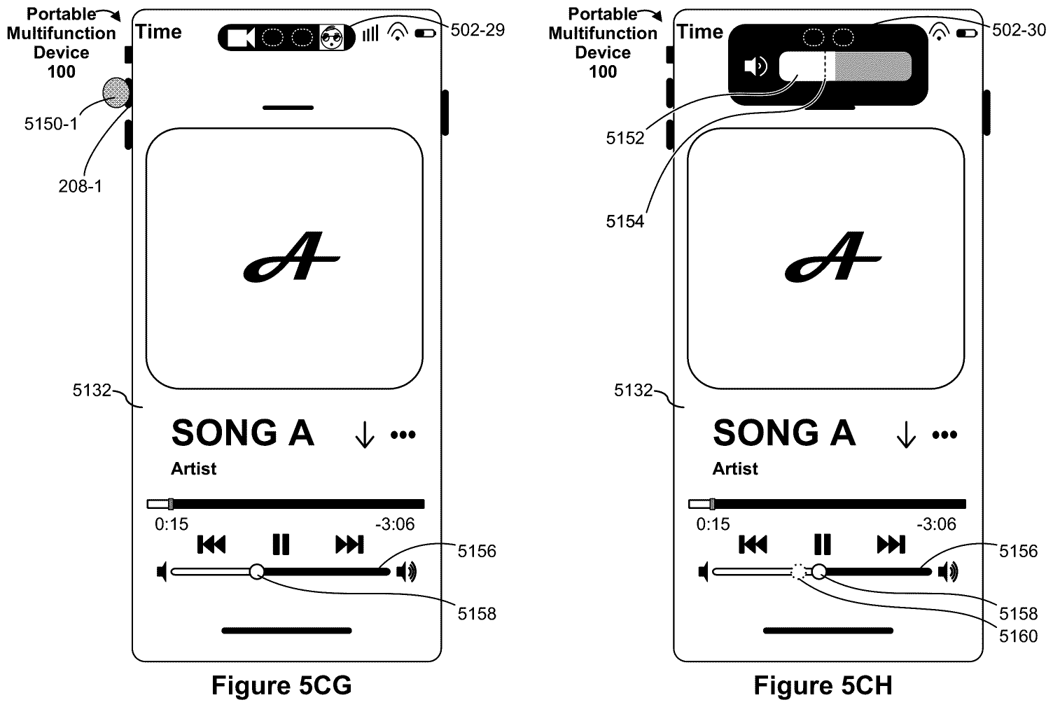

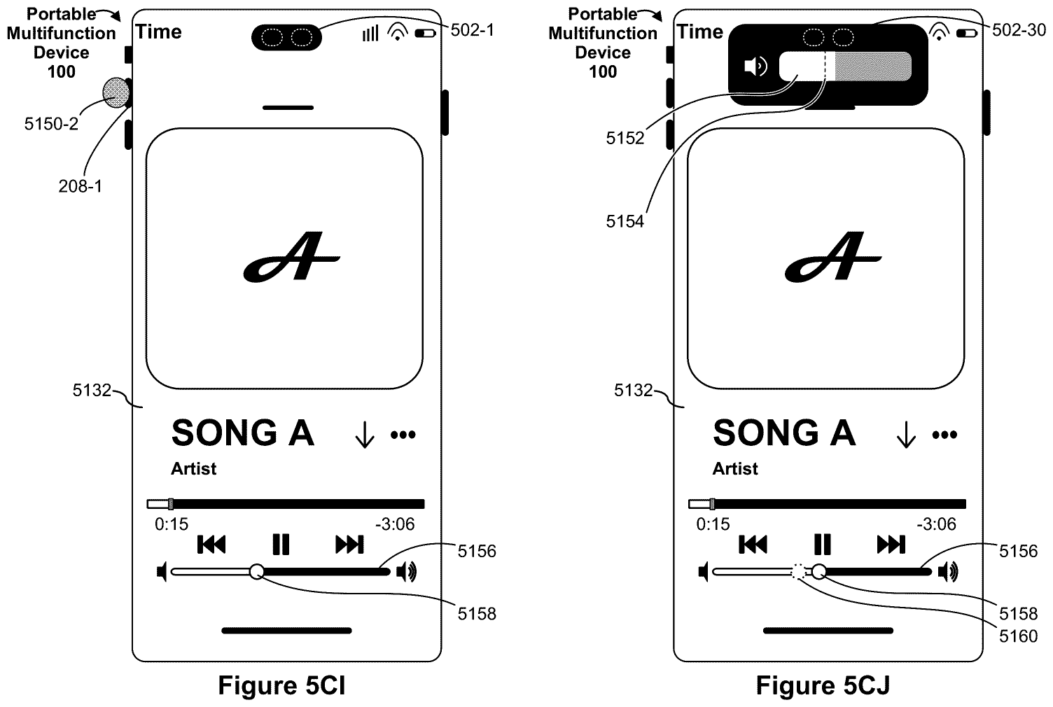

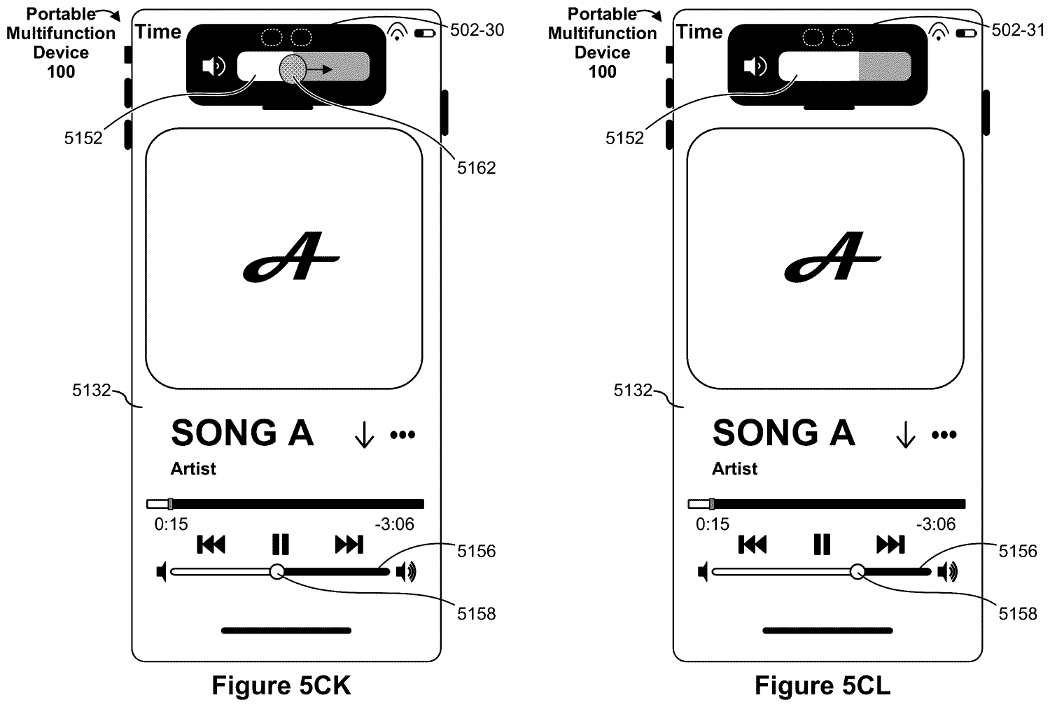

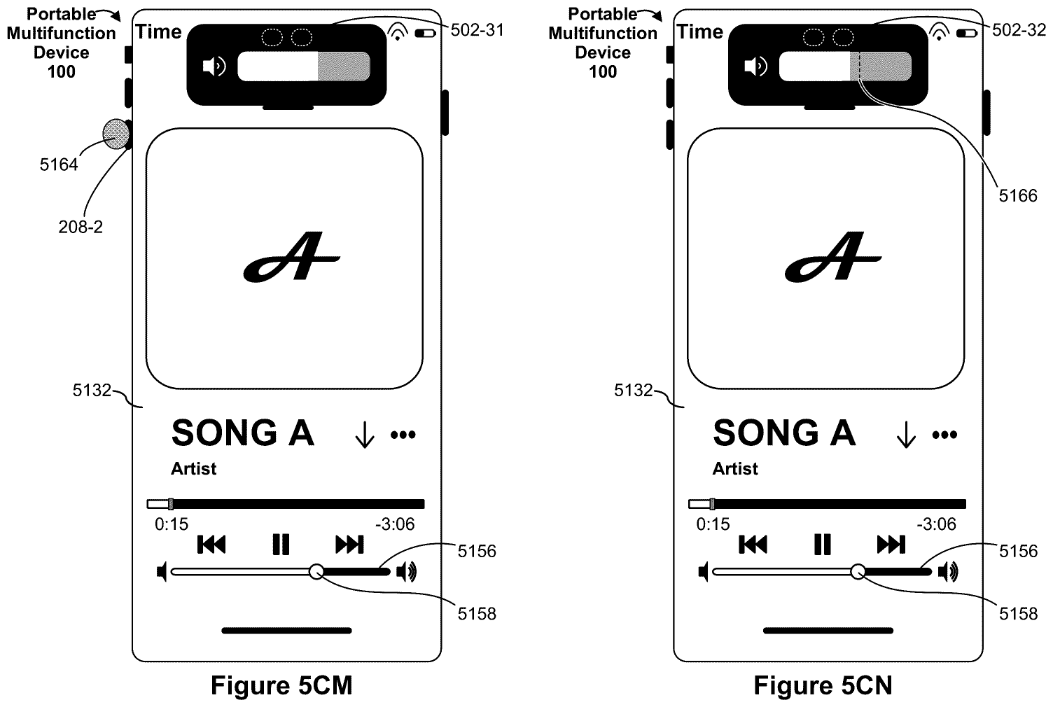

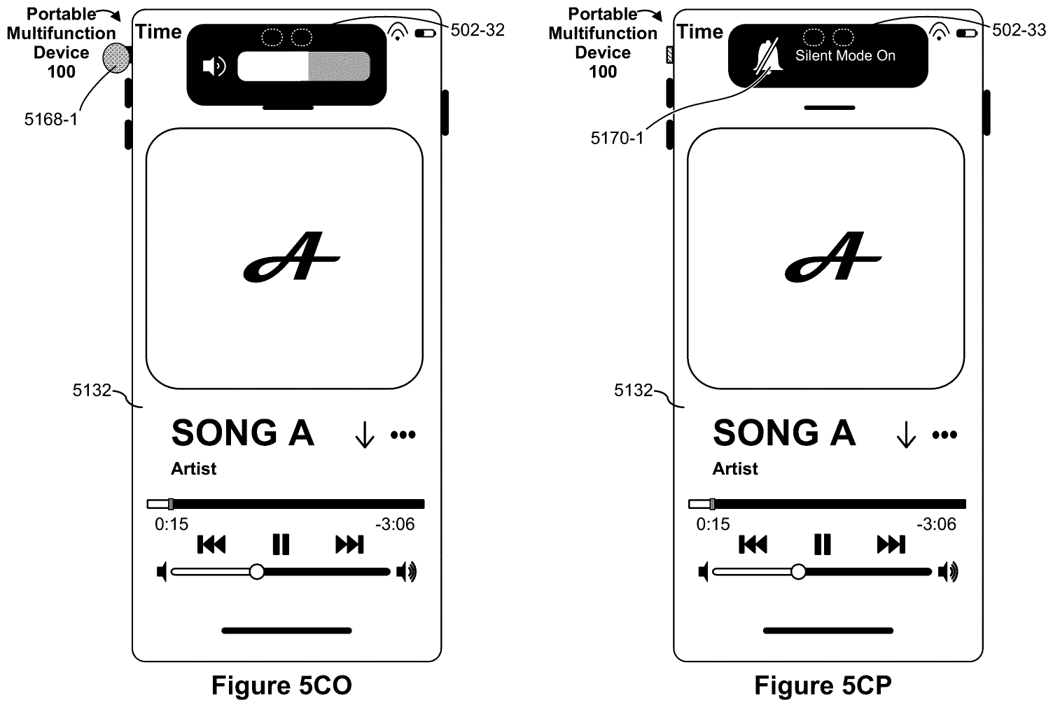

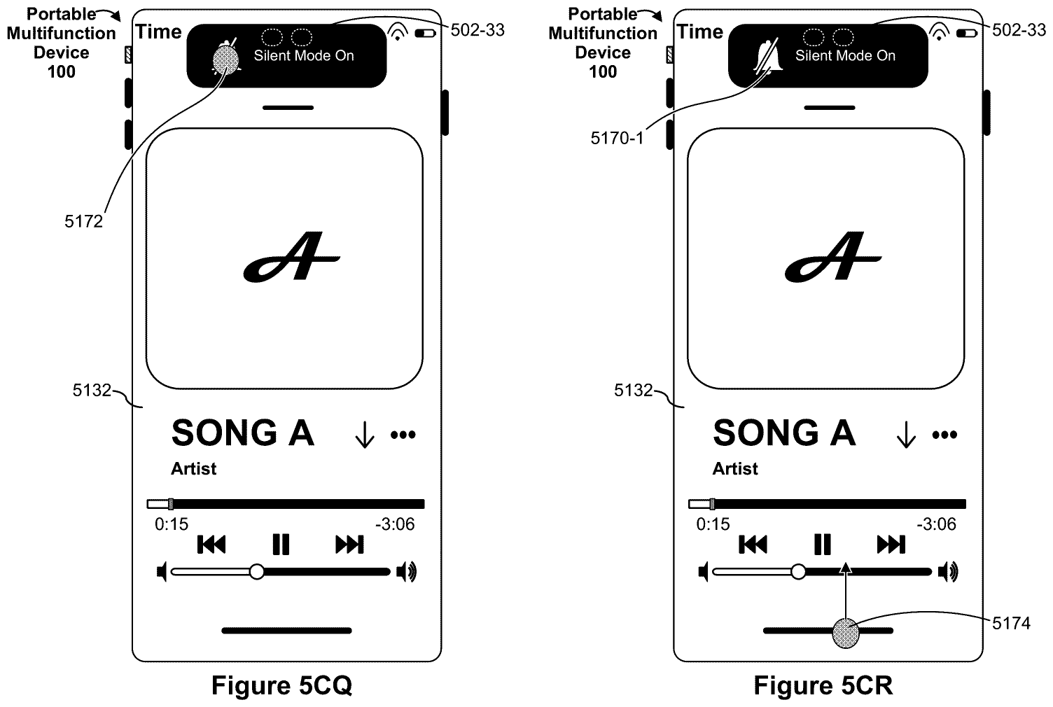

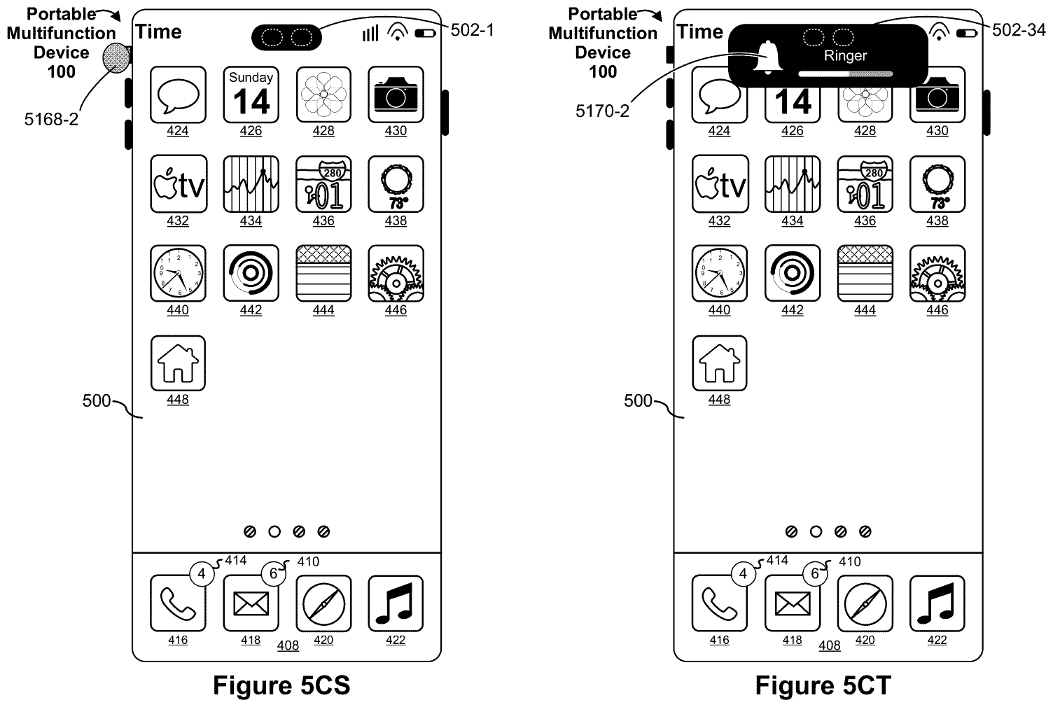

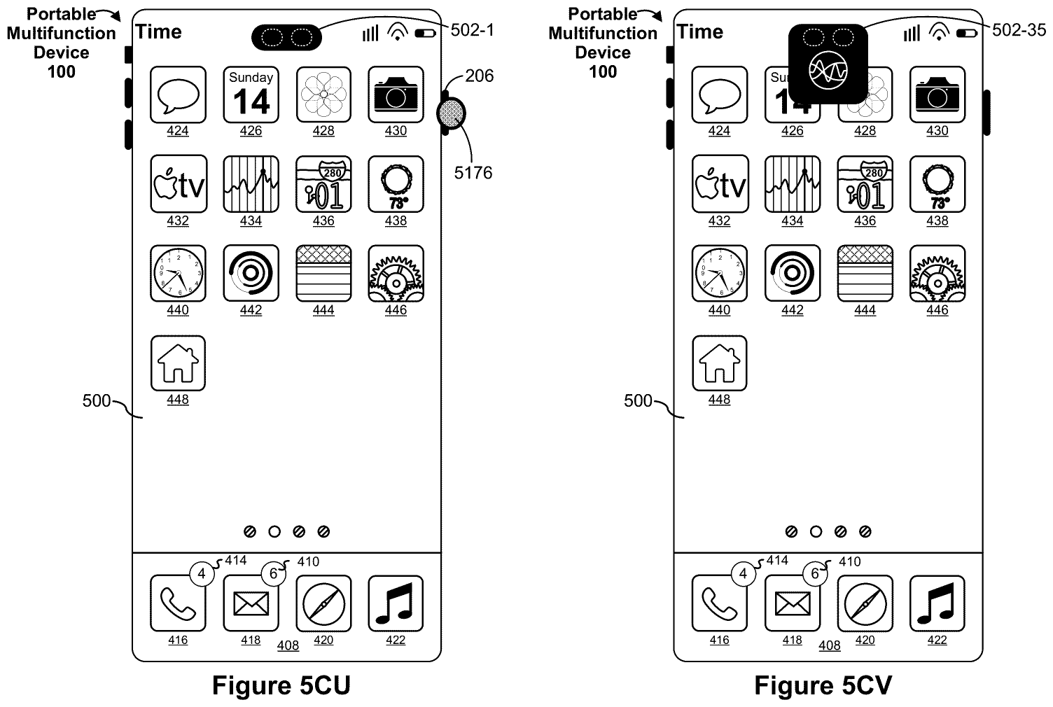

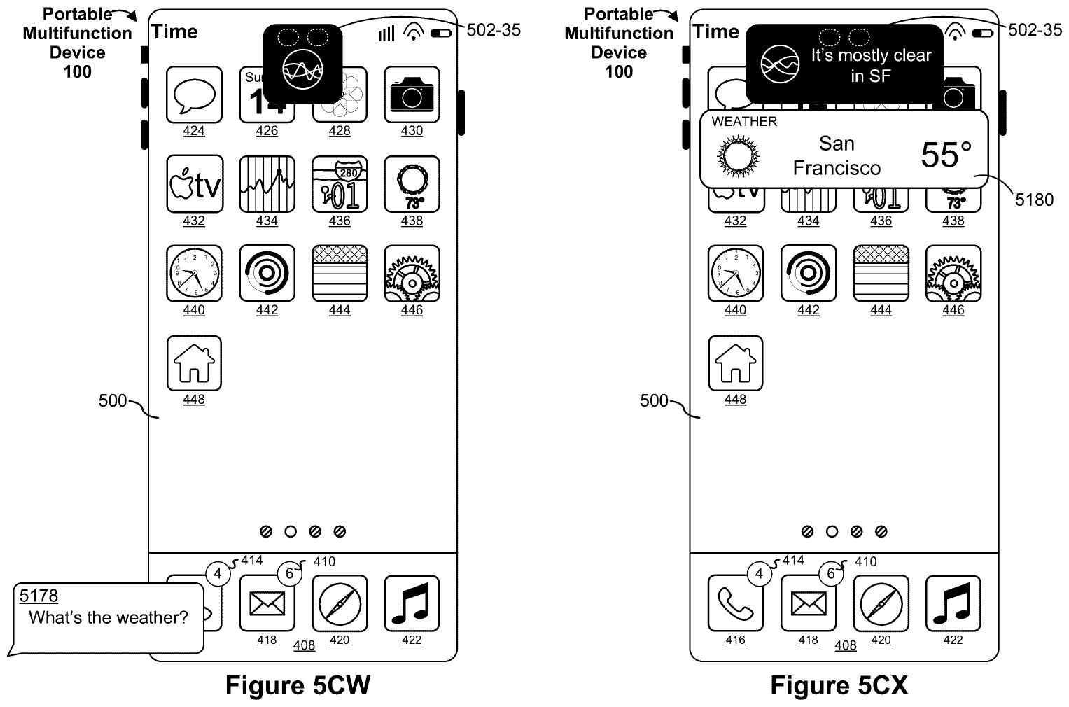

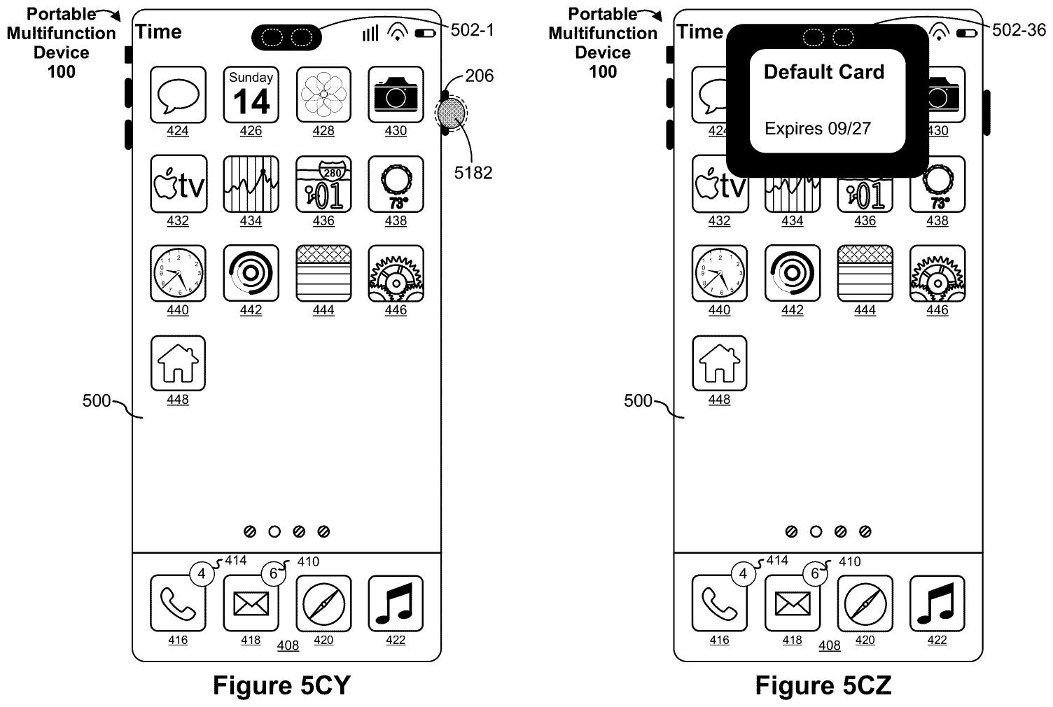

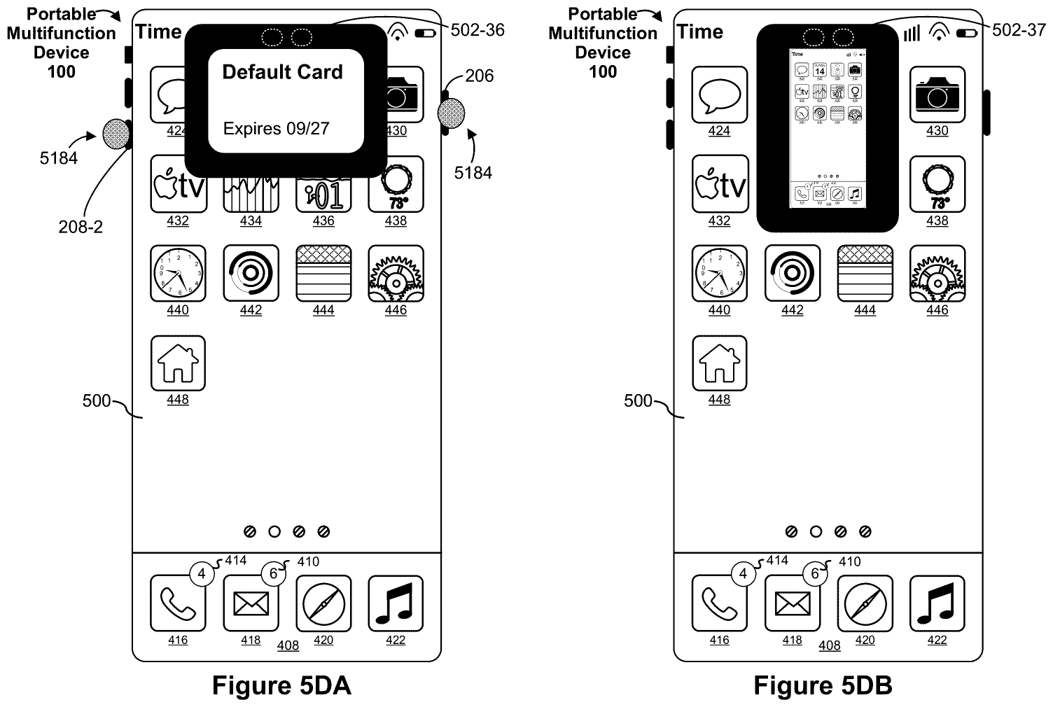

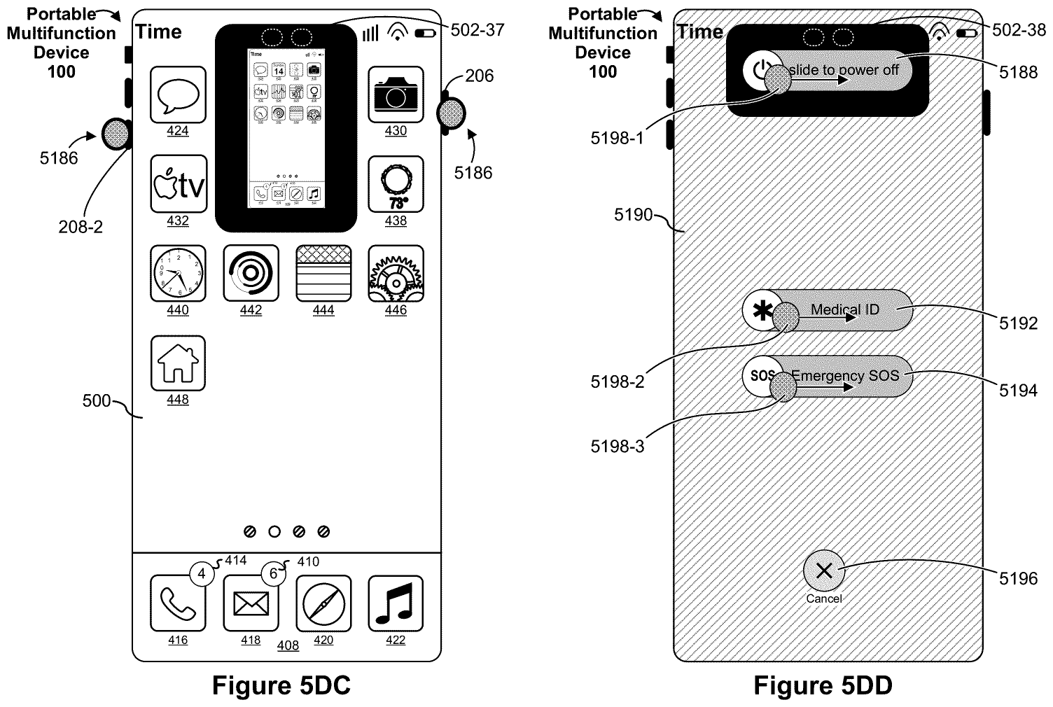

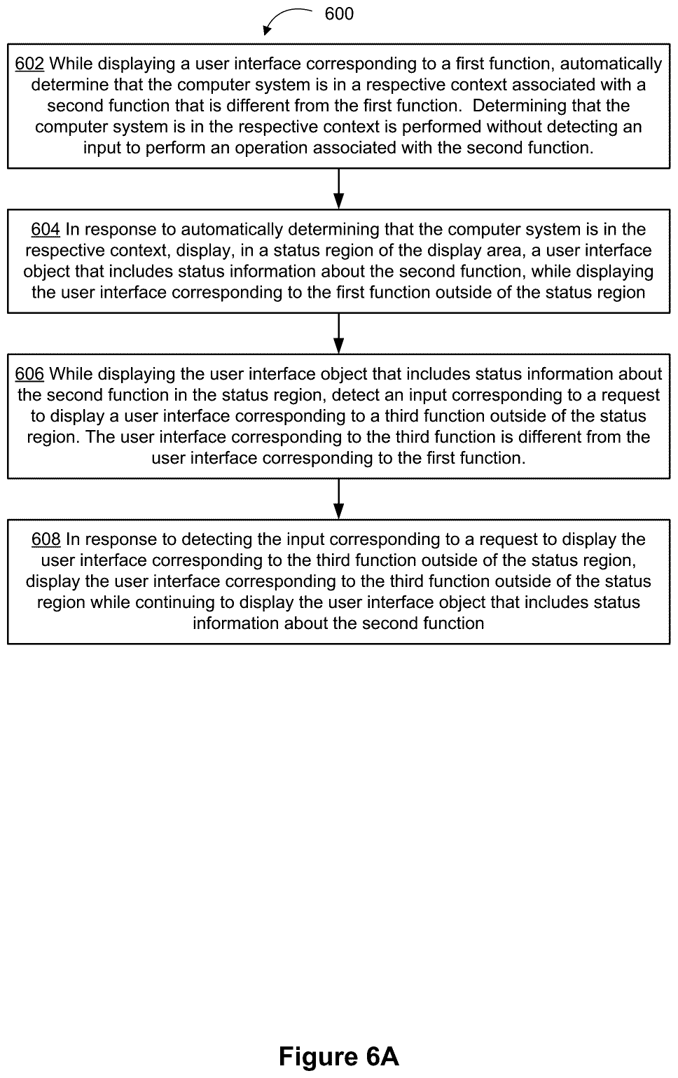

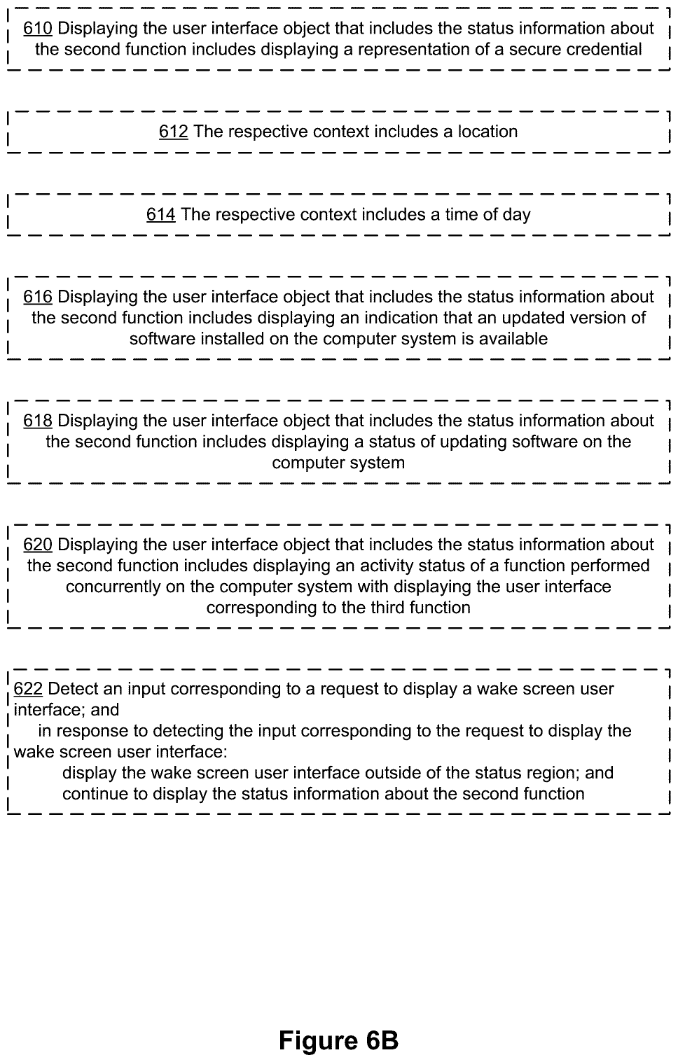

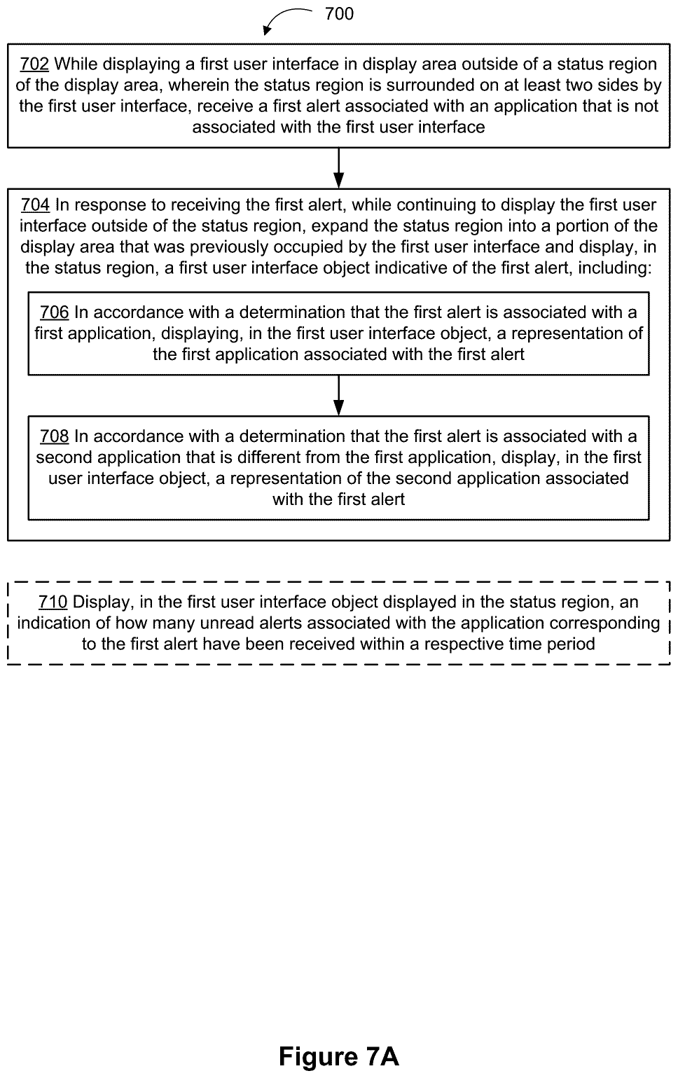

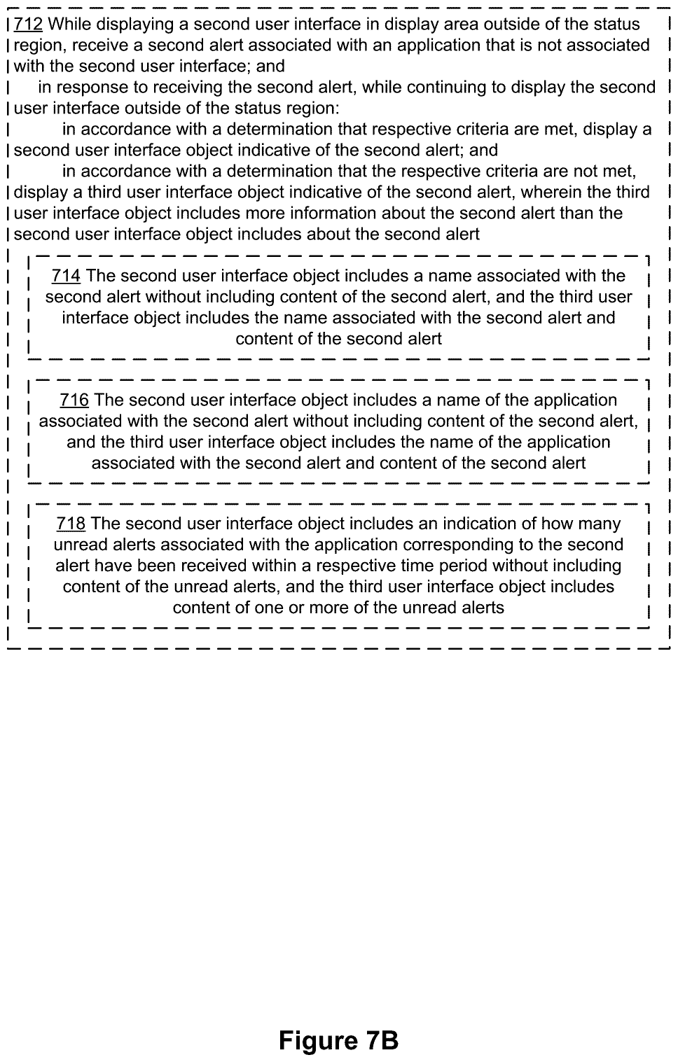

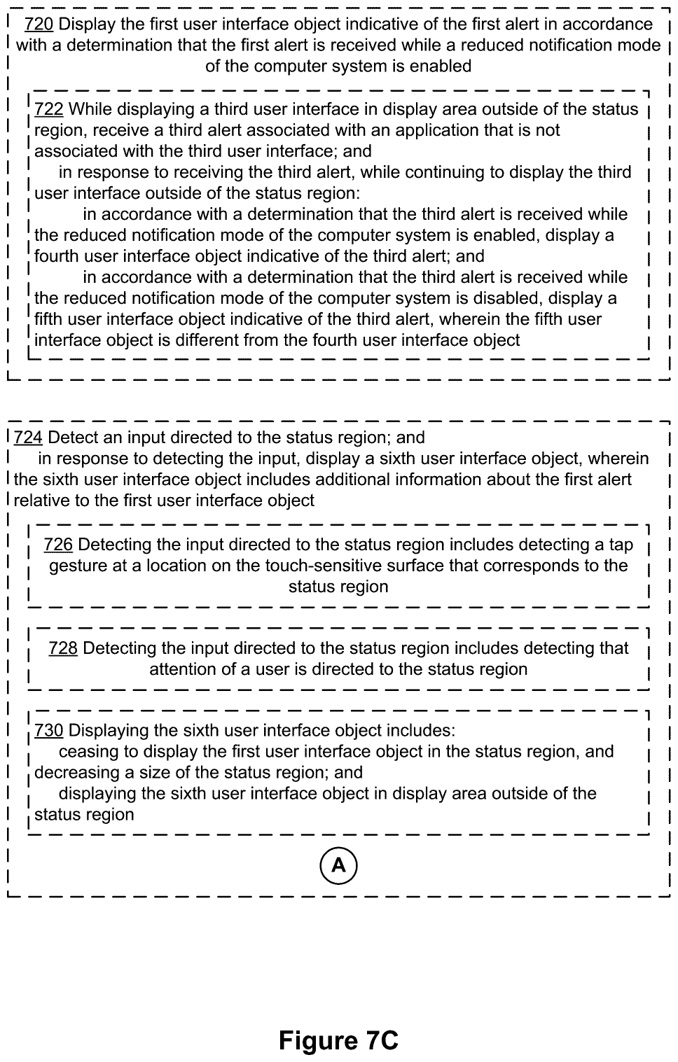

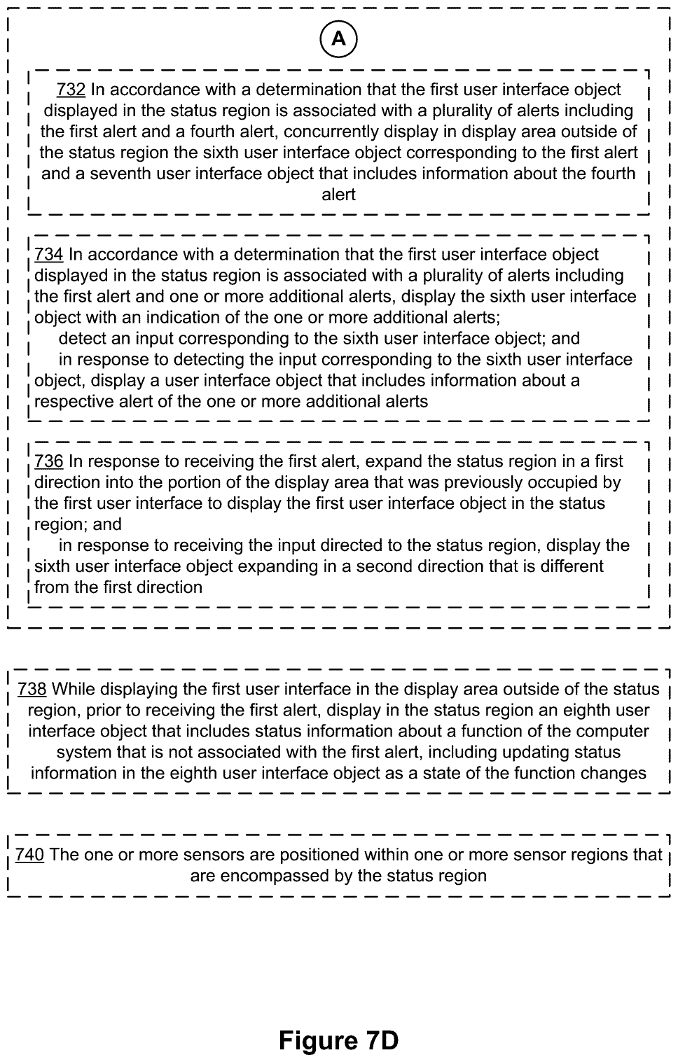

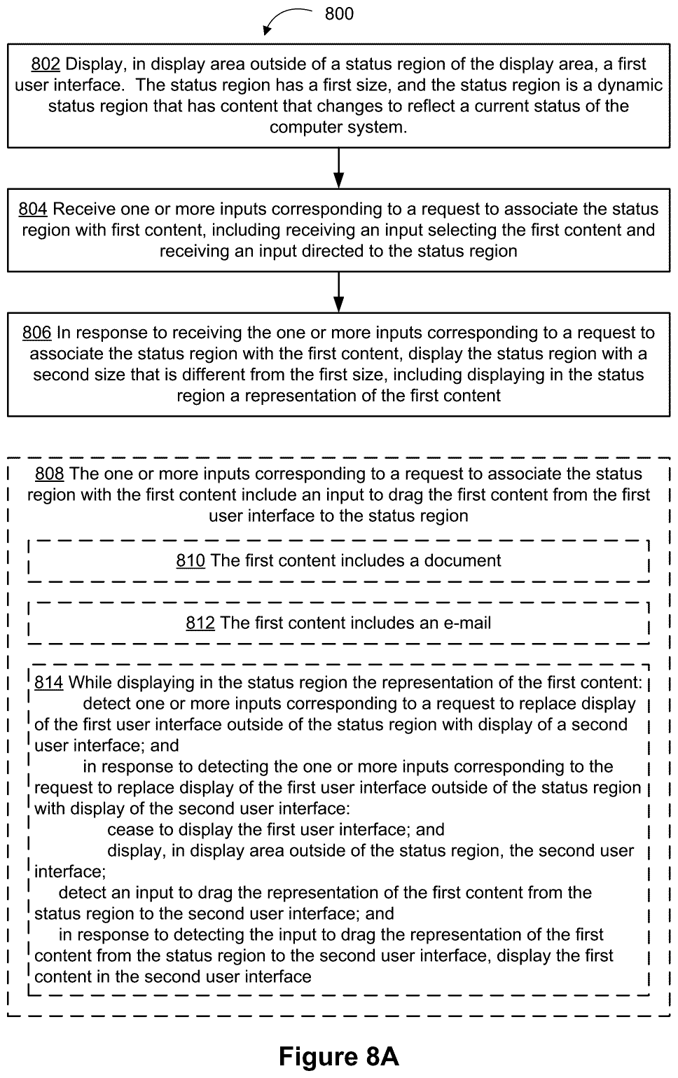

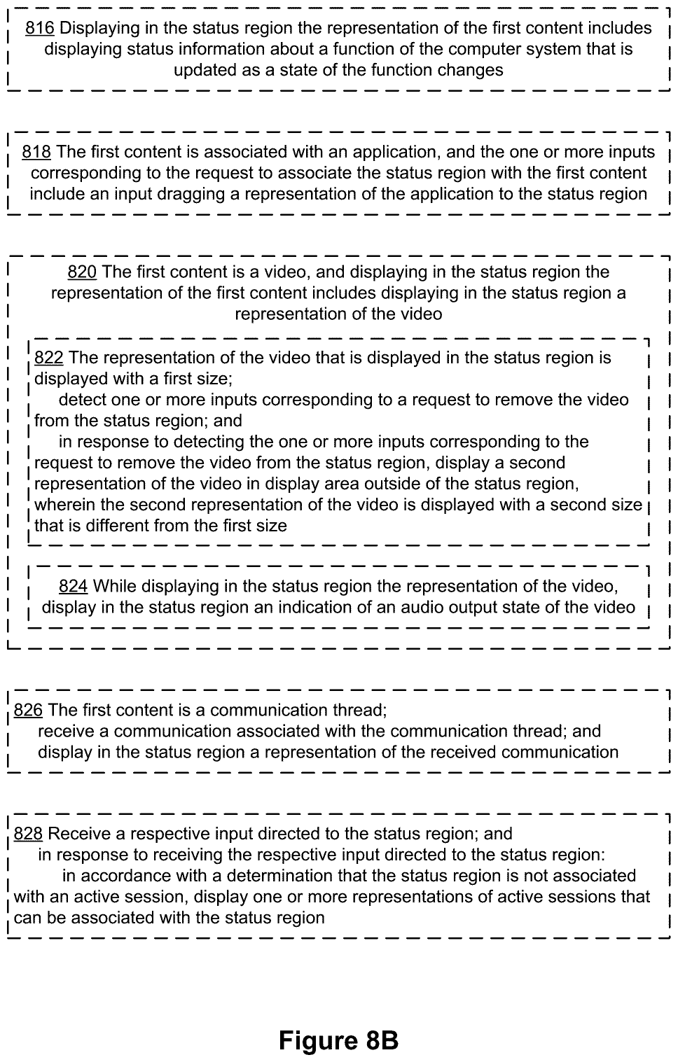

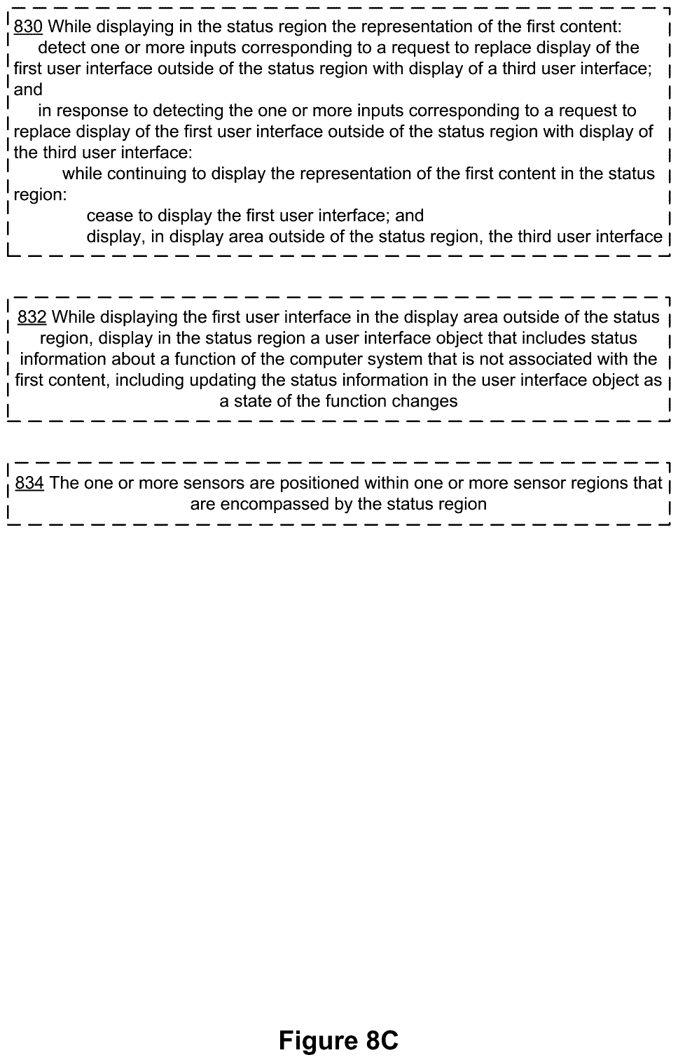

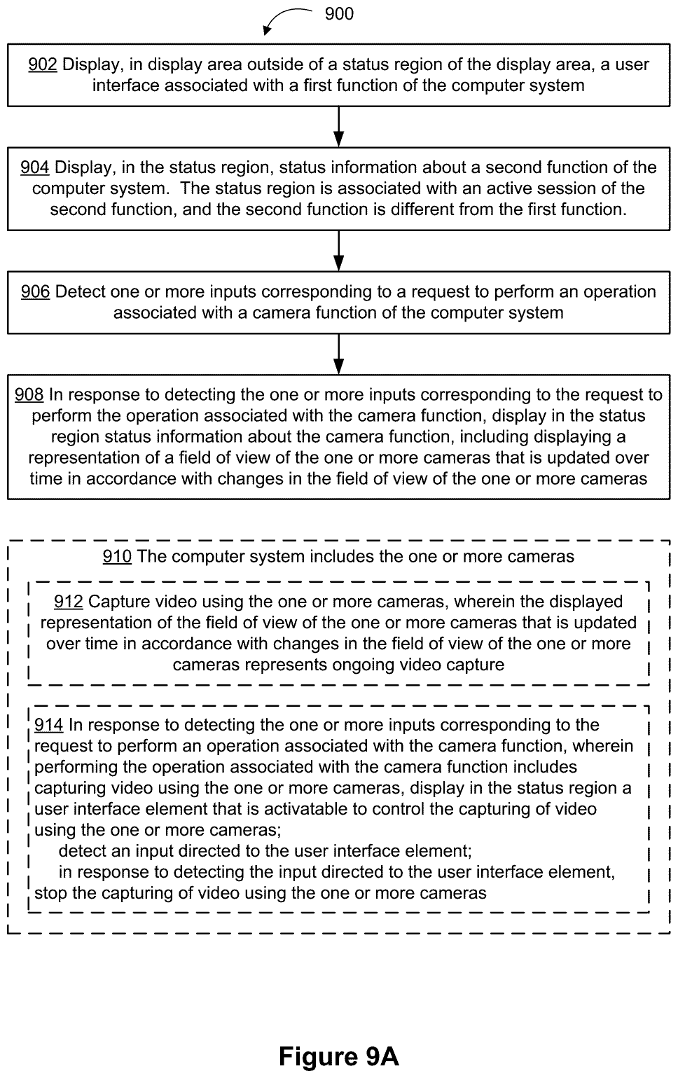

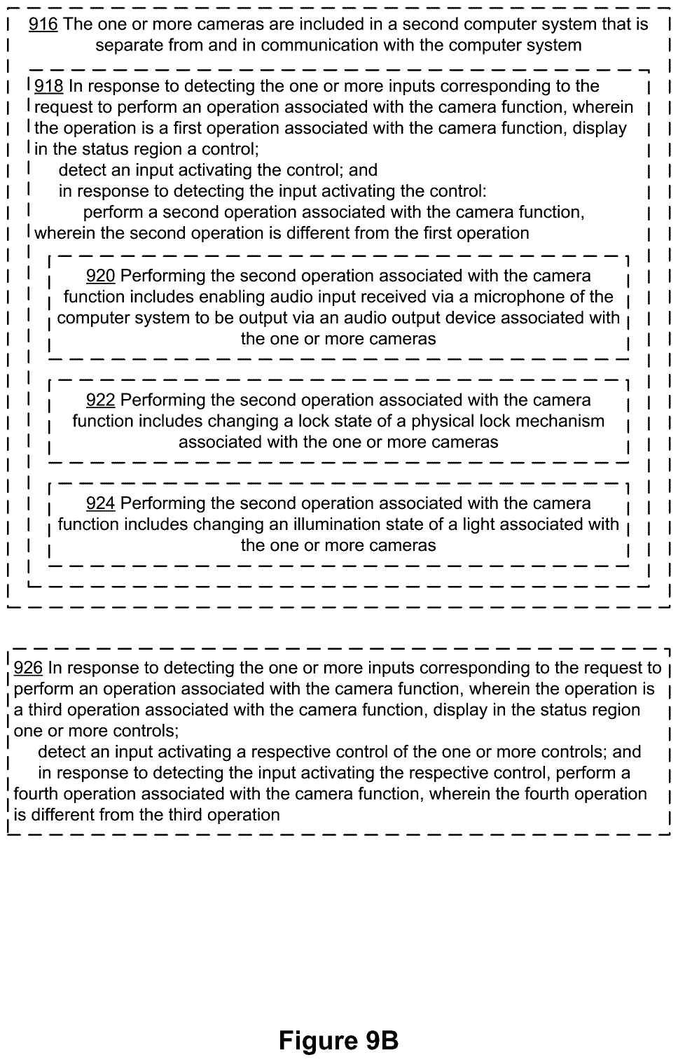

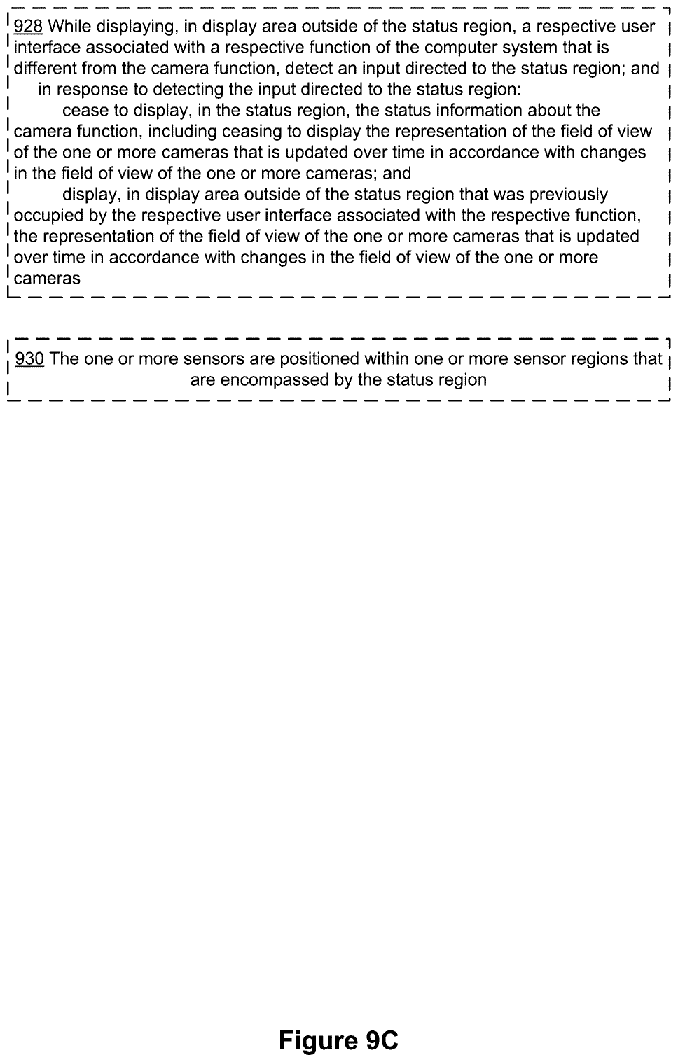

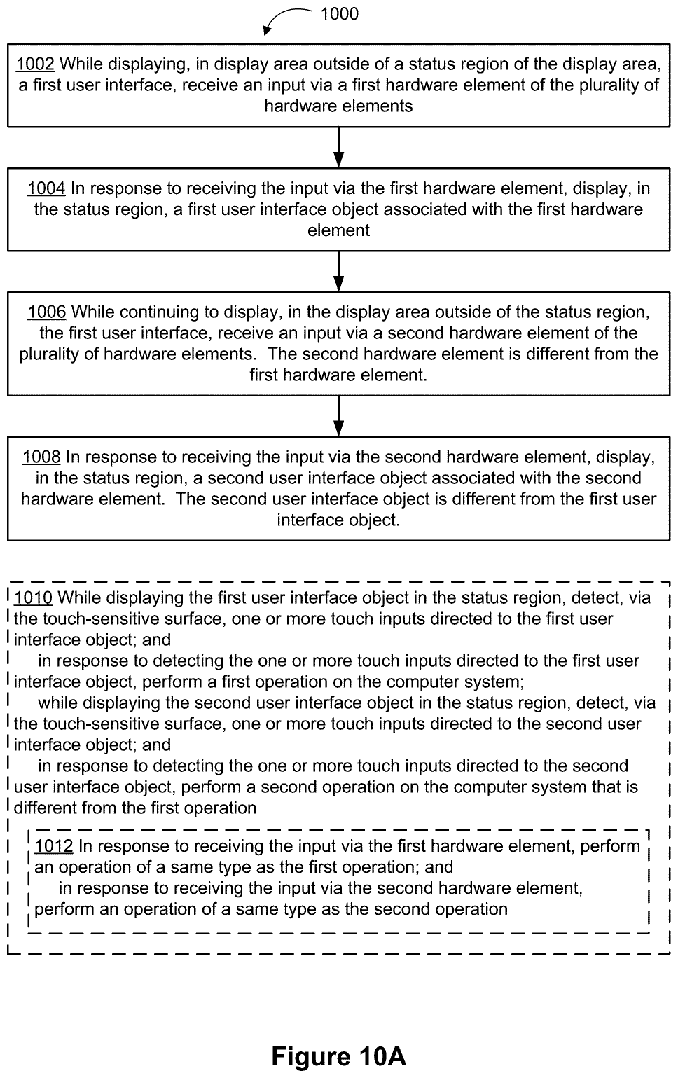

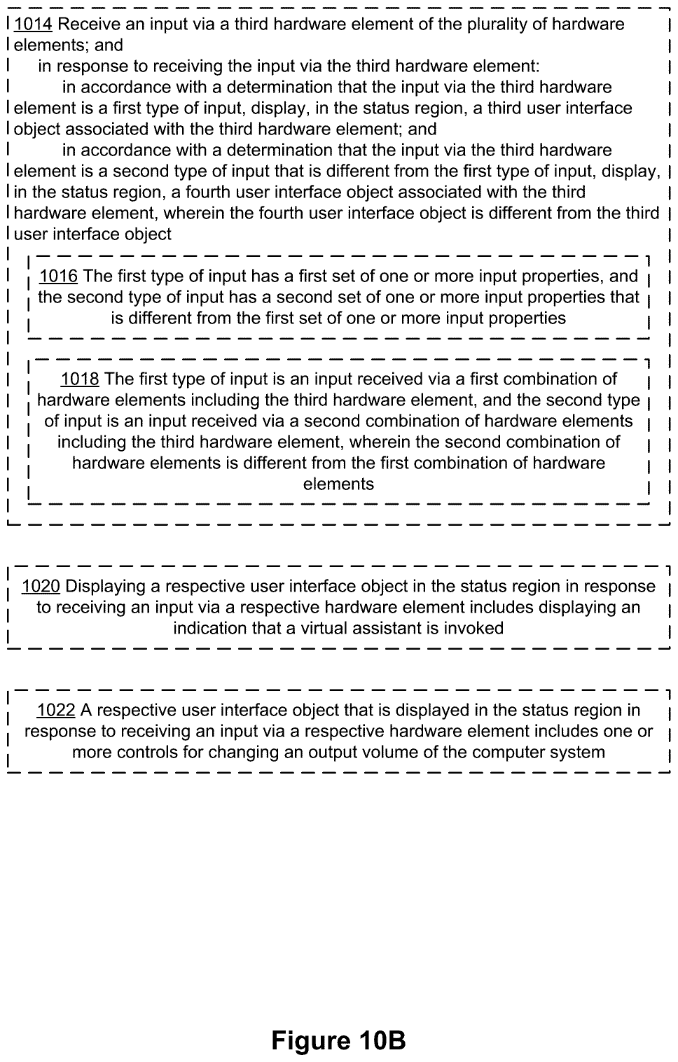

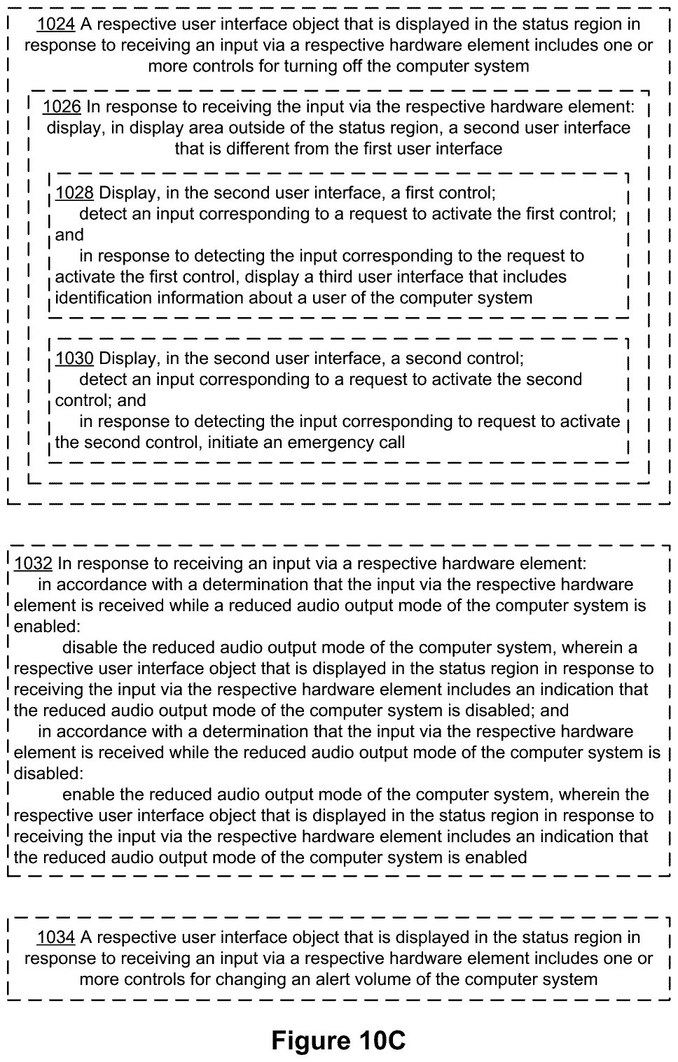

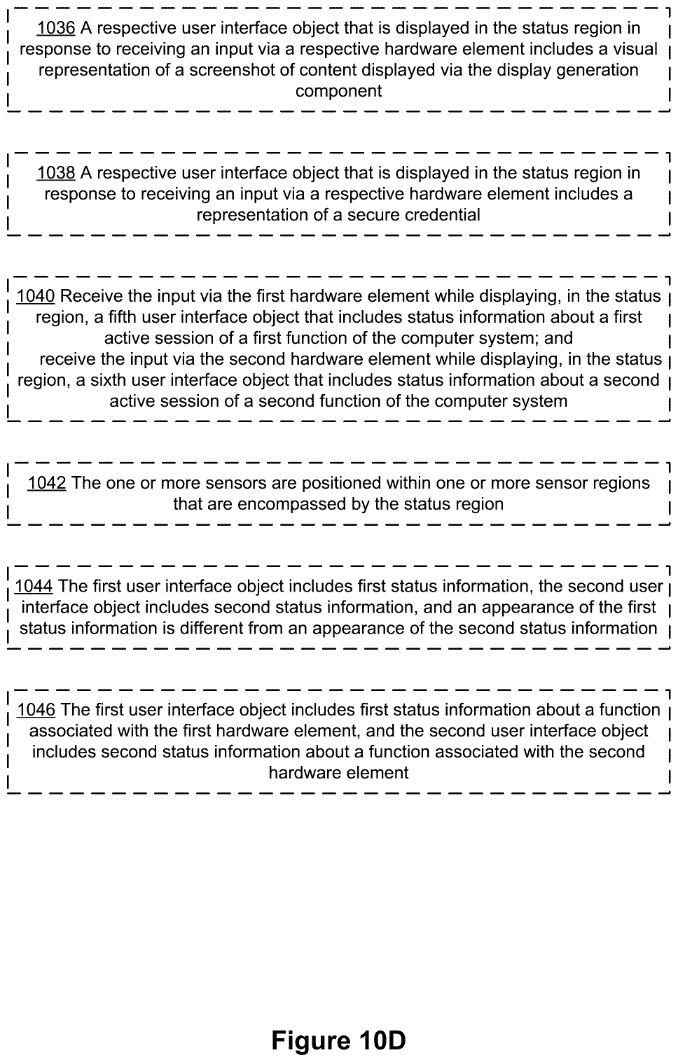

Below, FIGS. 1A-1B, 2, and 3 provide a description of example devices. FIGS. 4A-4B and 5A-5DD illustrate example user interfaces for updating content in a session region. FIGS. 6A-6B illustrate a flow diagram of a method of automatically displaying content in a session region based on a current context of a device. FIGS. 7A-7D illustrate a flow diagram of a method of displaying notification content generally and for using a session region to display notification content. FIGS. 8A-8C illustrate a flow diagram of a method of enabling a user to manually select content for display in a session region. FIGS. 9A-9C illustrate a flow diagram of a method of displaying camera information in a session region. FIGS. 10A-10D illustrate a flow diagram of a method of displaying user interfaces in a session region in response to inputs via corresponding hardware elements. The user interfaces in FIGS. 5A-5DD are used to illustrate the processes in FIGS. 6A-6B, 7A-7D, 8A-8C, 9A-9C, and 10A-10D.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

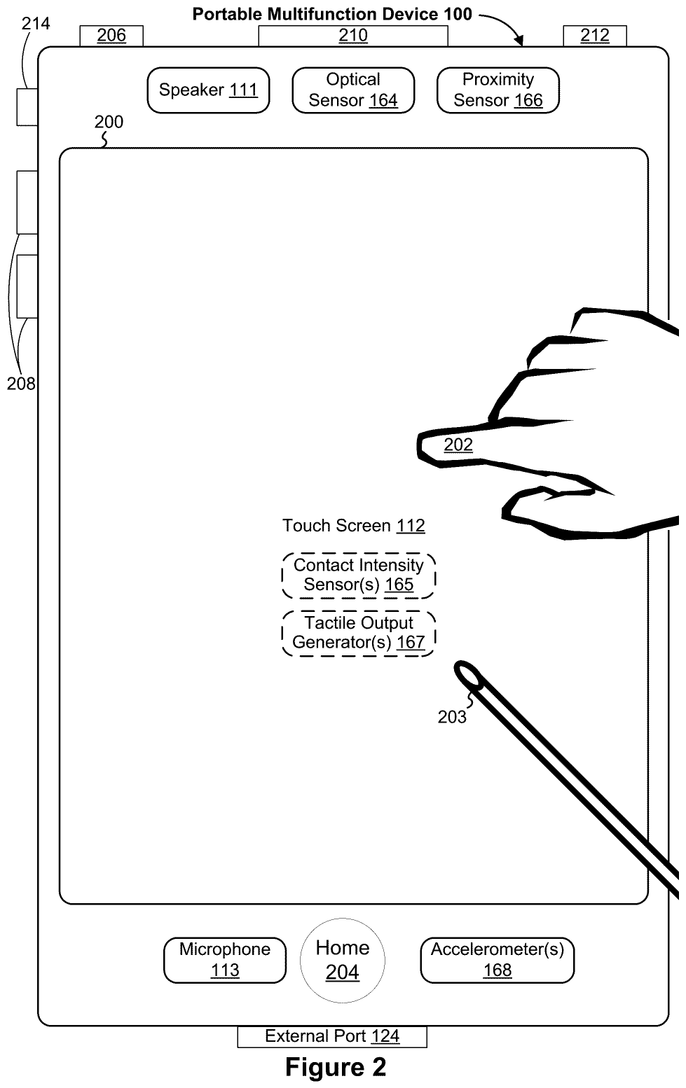

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include one or more physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2). The one or more buttons optionally include a switch or toggle button (e.g., 214, FIG. 2) for transitioning device 100 into or out of a respective associated state or mode.

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's car (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

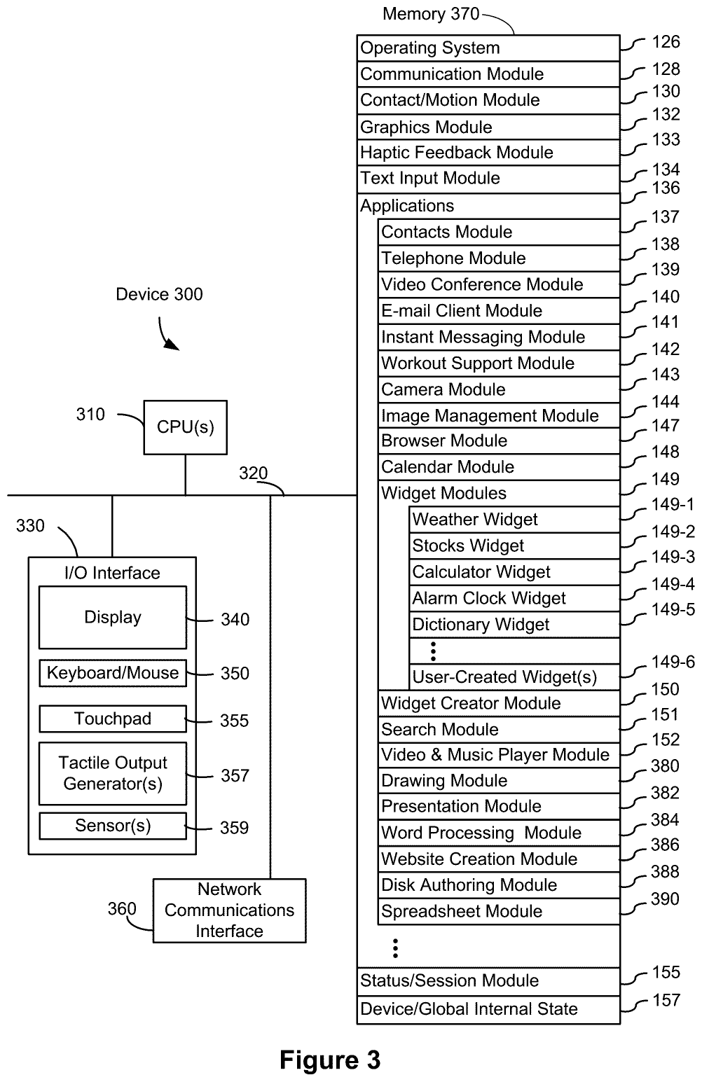

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. In some embodiments, memory 102 includes status/session module 155, as shown in FIGS. 1A and 3. Status/session module 155 optionally displays information indicating current status of one or more functions of device 100, such as applications or system software, with currently active sessions. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153; and/or
map module 154.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, optionally in conjunction with an online video module, include executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-154, and 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), side button 206 for powering the device on/off and locking the device, volume adjustment button(s) 208, Subscriber Identity Module (SIM) card slot 210, head set jack 212, switch 214 for transitioning the device between an audio output mode and a silent or vibrate (or other reduced audio output) mode, and/or docking/charging external port 124. Side button 206 is, optionally, used to turn the power on/off on the device by depressing the button (or otherwise applying a sufficient input intensity, such as for a solid-state button) and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, optionally labeled “Phone,” which optionally includes an indicator 414 of the number of missed calls or voicemail messages;
   Icon 418 for e-mail client module 140, optionally labeled “Mail,” which optionally includes an indicator 410 of the number of unread e-mails;
   Icon 420 for browser module 147, optionally labeled “Browser”; and
   Icon 422 for video and music player module 152, optionally labeled “Music”; and
Icons for other applications, such as:
   Icon 424 for IM module 141, optionally labeled “Messages”;
   Icon 426 for calendar module 148, optionally labeled “Calendar”;
   Icon 428 for image management module 144, optionally labeled “Photos”;
   Icon 430 for camera module 143, optionally labeled “Camera”;
   Icon 432 for an online video module, optionally labeled “Online Video”;
   Icon 434 for stocks widget 149-2, optionally labeled “Stocks”;
   Icon 436 for map module 154, optionally labeled “Maps”;
   Icon 438 for weather widget 149-1, optionally labeled “Weather”;
   Icon 440 for alarm clock widget 149-4, optionally labeled “Clock”;
   Icon 442 for workout support module 142, optionally labeled “Workout Support”;
   Icon 444 for notes module 153, optionally labeled “Notes”; and
   Icon 446 for a settings application or module, which provides access to settings for device 100 and its various applications 136; and
   Icon 448 for a home automation application or module, optionally of applications 136, which provides access to and control over physical home features such as lights, locks, cameras, and the like.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5DD illustrate example user interfaces for updating content in a session region (also called a status region) in accordance with some embodiments. The user interfaces in these figures are used to illustrate the processes described below, including the processes in FIGS. 6A-6B, 7A-7D, 8A-8C, 9A-9C, and 10A-10D. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector.

FIGS. 5A and 5B illustrate example session regions with and without sensors encompassed by the session region, respectively.

FIG. 5A illustrates an example user interface of a home screen (also called a home user interface) 500 of a portable multifunction device 100. In some embodiments, portable multifunction device 100 is a computer system, a handheld mobile device, tablet, or other client device. In some embodiments, the home screen user interface includes icons for navigating to a plurality of applications that are executed, or executable, by the device 100. In some embodiments, a user is enabled to interact with the device 100 using one or more gestures, including touch inputs. For example, a tap input on a respective application icon causes the respective application to launch, or otherwise open a user interface for the respective application, on the display area of device 100. In some embodiments, a plurality of views (also called pages) for the home screen user interface is available. For example, a user is enabled to swipe or otherwise navigate between the plurality of views, wherein different views, and in some embodiments each view, of the home screen user interface include different application icons for different applications. In some embodiments, the application icons are different sizes, such as in the case of an application widget that displays information for one or more corresponding applications, wherein the application widget is larger than the individual application icons.

In some embodiments, the device 100 includes a session region 502-1 that includes one or more sensors (e.g., speaker 111 and/or one or more optical sensors 164). In some embodiments, the one or more sensors are positioned within one or more cutouts (also called sensor regions) in a display of the device 100. In some embodiments, as shown in FIG. 5A, the session region 502-1 encompasses the one or more sensor cutouts for the one or more sensors. In some embodiments, additional sensors are located within the session region 502-1, wherein the cutouts illustrated in FIG. 5A include one or more sensors in the cutout (e.g., one or more additional sensors are positioned in the same cutout as speaker 111, and/or one or more additional sensors are positioned in the same cutout as optical sensor(s) 164, such as a structured light emitter or projector). It will be understood that in some embodiments, alternative shapes and/or numbers of cutouts (e.g., more than two or fewer than two), as well as numbers of sensors in a respective cutout, are implemented. In some embodiments, the cutouts are not visible from the surface of device 100. In some embodiments, the device displays an outline of the session region 502-1. For example, the device displays the black session region 502-1 that encompasses the cutouts for speaker 111 and optional sensors 164. In some embodiments, the device displays the session region 502-1 with a color that matches, or otherwise blends with, a color of the sensors that are positioned within the cutouts.

In some embodiments, a region that is between two of the sensor cutouts is maintained with a same color as the color of the sensors. For example, the region that is between two of the sensor cutouts comprises a display that displays a color selected to match the color of the hardware of the sensors. In some embodiments, at least one of the sensor cutouts includes a camera as the sensor in the sensor cutout. In some embodiments, the region that is between two of the sensor cutouts displays content (e.g., a privacy indicator and/or a lock indicator).

In some embodiments, session region 502-1 that is displayed without active sessions (e.g., without status information), and/or session regions described herein that are displayed with at least one active session (e.g., with status information), are displayed at a predefined position of the display as the user navigates between different user interfaces. For example, the session region is displayed within a same area of the display while the device 100 displays application user interfaces, a home screen user interface, and optionally a wake screen user interface (e.g., at the top of touch screen 112, as shown throughout the figures).

FIG. 5B illustrates the home screen user interface as described with reference to FIG. 5A. FIG. 5B further illustrates session region 502-2 that does not include one or more sensors within the session region 502-2. For example, in some embodiments, the one or more sensors are not positioned within cutouts of the display of device 100. In some embodiments, the session region 502-2 that does not include one or more sensors is enabled to perform all of the functions described herein (e.g., any of the same functions described herein as for session region 502-1). Although most examples describe herein illustrate one or more sensors within the session region, in some embodiments, the session region is displayed regardless of whether the one or more sensors are encompassed by the session region.

FIGS. 5C-5AF illustrate example user interfaces for automatically displaying content in a session region based on a current context of a device, in accordance with some embodiments.

FIG. 5C illustrates home screen 500 as described with reference to FIG. 5A. In FIG. 5C, session region 502-1 is not associated with any active sessions and is thus displayed at a minimized size (e.g., a minimum size). In some circumstances, a minimized session region without any active sessions is called an empty session region. FIG. 5C also illustrates user input 504, such as a tap input or other activation input, selecting an icon 422 for a music application. In response to detecting user input 504, device 100 displays user interface 506 for the music application, as illustrated in FIG. 5D.

FIG. 5D illustrates user input 508, such as a tap input or other activation input, requesting to initiate playback of a media content item (e.g., by selecting the “Listen Now” button). In response to detecting user input 508, user interface 506 of the music application is updated to user interface 510, to display information for the currently playing media content item, as illustrated in FIG. 5E.

In some embodiments, the currently playing media content item (e.g., song, audiobook, and/or video), or media content playback in general from the music application, corresponds to an active session, and thus, if the user navigates away from viewing the active media playback session in the music application user interface (e.g., navigates away from user interface 510), session information for the active session will move to the session region 502. In the example of FIG. 5E, user input 512 represents a request to navigate away from user interface 510 in the form of a request to redisplay home screen 500. User input 512 is optionally a swipe gesture (e.g., upward, downward, to the left, or to the right) from a respective portion (e.g., a bottom edge, a top edge, or a side edge) of the display.

FIG. 5F illustrates that home screen 500 is displayed in response to detecting user input 512 (FIG. 5E). FIG. 5F also illustrates that session region 502-3 is increased in size, relative to session region 502-1, to a condensed size and includes status information for the active media playback session of the music application. Session region 502-3 occupies at least some of the area previously occupied by home screen 500 and/or the status bar above home screen 500 and to the left and right of session region 502 (e.g., one or more status indicators in the status bar cease to be displayed; for example, cellular network indicator 514 of FIG. 5E has ceased to be displayed in FIG. 5F). In some embodiments, session region 502-3 for the media playback session includes a representation of the currently playing media content item (e.g., cover art for the media content item) and/or a sound waveform indicator that is optionally generated based on a current audio output of the currently playing media content item, such that the sound waveform is updated as the audio output changes over time. FIG. 5F also indicates that the current location of device 100 is “Home,” referring to the home of a user of device 100 (e.g., a location and context not associated with another particular session to be displayed in session region 502).

FIG. 5G indicates that the current location of device 100 has changed to “En route,” referring to the user of device 100, along with device 100, being on the way to a destination. The media playback session is maintained in session region 502-3 while device 100 is in the “En route” context (e.g., in accordance with the “En route” context not being a context in which another session is to be activated).

FIG. 5H indicates that the current location of device 100 has changed to “Transit station” and that the current time of day is “Morning commute,” referring to the user of device 100 having arrived at a bus stop, subway station, train station, or other location for boarding and disembarking public transportation on the user's way to work or other location as part of the user's routine morning journey. In accordance with device 100 being at the “Transit station” location and/or in accordance with this occurring during the “Morning commute” time of day, device 100 automatically (e.g., without detecting input from the user) invokes the user's transit card and displays session region 502-4 with a representation of the transit card (e.g., the transit card icon and the text label “Transit”), optionally replacing display of the music playback session of session region 502-3. In some embodiments, the session displayed in session region 502-4 is selected based on historical data regarding the user's activity patterns while previously at the current location and/or during previous instances of the current time of day, and/or other factors. Initially, session region 502-4 is displayed with the representation of the transit card as a condensed session region.

FIG. 5I illustrates device 100 establishing communication with wireless terminal 516 at the “Transit station” location during the “Morning commute” (e.g., in contrast to FIG. 5H in which device 100 was at the “Transit station” location but not yet in communication with a wireless terminal). FIG. 5J illustrates that, in response to device 100 establishing communication with wireless terminal 516 (e.g., in accordance with device 100 being brought into proximity with wireless terminal 516), the user's transit card information is transmitted to wireless terminal 516 (e.g., to pay a fare and/or otherwise authorize the user of device 100 to board a vehicle), and session region 502-5 increases in size (e.g., from the condensed size to an expanded size) to display an expanded representation of the transit card, providing visual feedback that a transaction is being performed with the transit card. In some embodiments, after the transaction with the transit card is performed, and optionally while device 100 remains at the “Transit station” location, expanded session region 502-5 automatically ceases to be displayed and reverts to condensed session region 502-4.

FIG. 5K indicates that the current location of device 100 has changed to “En route,” referring to the user of device 100 being on the way to a destination (e.g., currently traveling on the vehicle that the user boarded at the “Transit station” location, such as to continue the morning journey). The media playback session is redisplayed in session region 502-3 while device 100 is in the “En route” context (e.g., in accordance with the “En route” context not being a context in which another session is to be activated).

FIG. 5L indicates that the current location of device 100 has changed to “Coffee shop,” referring to the user of device 100 having arrived at a retail location such as a coffee shop. In accordance with device 100 being at the “Coffee shop” location, device 100 automatically (e.g., without detecting input from the user) invokes the user's coffee card (e.g., a payment and/or loyalty card, optionally based on historical data regarding the user's activity patterns while previously at the current location and/or during previous instances of the current time of day, and/or other factors) and displays session region 502-6 with a representation of the coffee card (e.g., the coffee card icon and the text label “Coffee”), optionally replacing display of the music playback session of session region 502-3. Initially, session region 502-6 is displayed with the representation of the coffee card as a condensed session region.

FIG. 5M illustrates user input 518, such as a tap input or long press input or other activation input, directed to condensed session region 502-6 with the representation of the coffee card. FIG. 5N illustrates that, in response to detecting user input 518, device 100 displays expanded session region 502-7 with additional information and/or interaction options associated with the coffee card. For example, expanded session region 502-7 includes a shortcut button that is activatable to place an order to the coffee shop at the user's current location (e.g., for the user's most commonly or most recently order item(s), optionally based on historical data regarding the user's activity patterns while previously at the current location and/or during previous instances of the current time of day, or other suggested order). A user input, such as a tap input or other activation input, to the shortcut button in session region 502-7 would perform a transaction placing the corresponding order to the coffee shop and optionally charging the order to the user's coffee card.

FIG. 5O indicates that the current location of device 100 has changed to “En route,” referring to the user of device 100 being on the way to a destination (e.g., having left the coffee shop, such as to continue the morning journey). The media playback session is redisplayed in session region 502-3 while device 100 is in the “En route” context (e.g., in accordance with the “En route” context not being a context in which another session is to be activated).

FIG. 5P indicates that the current location of device 100 has changed to “Airport,” referring to the user of device 100 having arrived at an airport. In accordance with device 100 being at the “Airport” location, device 100 automatically (e.g., without detecting input from the user) invokes a boarding pass and displays session region 502-8 with a representation of the boarding pass (e.g., the boarding pass icon with an airplane graphic and the text label “Flight”), optionally replacing display of the music playback session of session region 502-3. Initially, session region 502-8 is displayed with the representation of the boarding pass as a condensed session region. In some embodiments, the particular boarding pass to be displayed in session region 502-8 is selected (e.g., from one or more boarding passes stored on or otherwise associated with device 100) based on other contextual information such as whether the current time is close to a boarding or departure time of the boarding pass, whether the current location of device 100 is the departure airport for the boarding pass, and/or other factors.

FIG. 5Q illustrates user input 520, such as a tap input or long press input or other activation input, directed to condensed session region 502-8 with the representation of the boarding pass. FIG. 5P illustrates that, in response to detecting user input 520, device 100 displays expanded session region 502-9 with additional information and/or interaction options associated with the boarding pass. For example, expanded session region 502-9 includes, in addition to the airplane graphic of the boarding pass icon, an associated flight number, a departure time, a departure gate, an indication that the flight is currently scheduled to depart on time, and a barcode (e.g., which uniquely identifies the boarding pass and may be scanned or presented to an attendant to authorize the user to enter a security screening arca or to authorize the user to board an aircraft).

FIG. 5S illustrates user input 522, such as a button press or other actuation, detected via side button 206. FIG. 5T illustrates that, in response to detecting user input 522, device 100 displays wake screen user interface 524 (e.g., replacing display of home screen 500). In some embodiments, the wake screen user interface is a user interface that is displayed after the display of device 100 has entered a low power state during which the display is at least partially off, and/or upon waking device 100 from the low power state and before the user access the home screen user interface and/or other application user interfaces. FIG. 5T illustrates that, while wake screen user interface 524 is displayed, the session information that was displayed in session region 502-9 while home screen 500 (or another application user interface) was displayed outside of the session region, as shown in FIG. 5S, is instead displayed in wake screen user interface 524, and in particular in widget 526 in wake screen user interface 524. In some embodiments, as shown in FIG. 5T, one or more other active sessions also transition from being displayed in the session region to being displayed in wake screen user interface 524, such as the media playback session previously displayed in session region 502-3 (FIG. 5O) now being displayed instead in a widget on wake screen user interface 524. Accordingly, widget 526 includes boarding pass information such as the airplane graphic, the associated flight number, the departure time, and a prompt that widget 526 may be interacted with (e.g., tapped) to access additional boarding pass information. In addition, session region 502 reverts to empty session region 502-1.

FIG. 5U illustrates that one or more software updates have become available for device 100 (e.g., a change in context of device 100 in that software, such as the operating system, of device 100 is no longer up to date, due to the availability of a newer version of the software). Accordingly, device 100 displays session region 502-10 concurrently with wake screen user interface 524 in FIG. 5U, which includes an indication of the one or more available software updates (e.g., the settings application icon and the text “1” indicating how many software updates are available). FIG. 5U also illustrates user input 528-1 on session region 502-10.

FIG. 5V illustrates that the indication of one or more available software updates in session region 502-10 is in some circumstances displayed concurrently with an application user interface, such as user interface 510 for the music application (e.g., as illustrated in FIG. 5E) or another user interface for another application. FIG. 5V also illustrates user input 528-2 on session region 502-10.

FIG. 5W illustrates that the indication of one or more available software updates in session region 502-10 is in some circumstances displayed concurrently with a home user interface, such as home screen 500. FIG. 5W also illustrates user input 528-3 on session region 502-10.

FIG. 5X illustrates that, in response to detecting user input 528 (e.g., user input 528-1 of FIG. 5U, user input 528-2 of FIG. 5V, or user input 528-3 of FIG. 5W, such as a tap input or long press input or other activation input), device 100 displays software update user interface 530 for updating software of device 100. Because software update user interface 530 is displayed outside of session region 502, session region 502 need no longer display the software update status information and, in the example of FIG. 5X, reverts to empty session region 502-1. In some embodiments session region 502 alternatively reverts to displaying another session that is still active, such as the ongoing media playback session, by redisplaying session region 502-3 instead of empty session region 502-1. Software update user interface 530 includes button 532 for carrying out the process of downloading and installing the new software version that is available. FIG. 5X also illustrates user input 534 directed to button 532 to initiate the download and installation.

FIG. 5Y illustrates that, in response to detecting user input 534, device 100 begins downloading and installing the new software version, as reflected in control 536 which is an updated appearance of button 532 of FIG. 5X, which includes a text indication that the download and installing are in progress as well as a progress indicator. FIG. 5Y also illustrates user input 538 requesting to dismiss software update user interface 530 and to display home screen 500, while the software update continues. In some embodiments, as in the example shown in FIG. 5Y, user input 538 is an upward swipe gesture that is initiated at a predefined area of the display near the bottom edge, such as the area indicated by system affordance 540.

FIG. 5Z illustrates that, in response to detecting user input 538, device 100 displays home screen 500. Because the download and installation of the software update are ongoing, status information for the software update, such as the settings application icon and a progress indicator, is displayed in session region 502-11, indicating that the software update download and installation has progressed since the scenario of FIG. 5Y. FIG. 5AA likewise illustrates further progress of the software update download and installation than in FIG. 5Z, as indicated via the progress indicator in session region 502-11 of FIG. 5AA.

In some embodiments, while status information continues to be displayed and updated in session region 502, the user is enabled to interact with other functions of device 100. Accordingly, FIG. 5AA shows user input 542, such as a tap input or other activation input, selecting icon 422 for the music application. In response to detecting user input 542, device 100 displays user interface 544 to display information for the currently playing media content item, as illustrated in FIG. 5AB. User interface 544 for the currently playing media content item for the music application is analogous to user interface 510 of FIG. 5E, except that user interface 544 illustrates embodiments in which an activatable control for downloading the current media content item is provided, by also including button 546.

FIG. 5AB illustrates that session region 502-11 continues to be displayed and updated while device 100 transitions from displaying home screen 500 to displaying user interface 544 for the currently playing media content item. Accordingly, session region 502-11 in FIG. 5AB indicates further progress of the software update download and installation than in FIG. 5AA.

FIG. 5AC illustrates that once the software update download and installation is complete, condensed session region 502-11 is changed to expanded session region 502-12 (e.g., including a larger version of the settings application icon and the text “Software Update Complete”), thus informing the user of the change in status of the software update using a more visually prominent alert. In some embodiments, session region 502 ceases to display the software update alert of session region 502-12 after session region 502-12 has been displayed for a threshold amount of time or in response to a user input requesting to dismiss session region 502-12 (e.g., an input such as an upward swipe on session region 502-12, an input such as a tap input or other activation input in user interface 544 outside of session region 502-12, or other input), and optionally reverts to empty session region 502-1 (e.g., if session region 502 is not associated with another active session), as illustrated in FIG. 5AD.

More generally, in some embodiments, an expanded session region 502 automatically (e.g., without user input) shrinks to condensed form (e.g., if a session continues to be active, or an alert presented in session region 502 remains unread, or other criteria) or empty (e.g., if the expansion of session region 502 corresponded to a session ending, or was responsive to an input via one or more hardware elements, or other criteria) after the expanded session region 502 has been displayed for a threshold amount of time (e.g., 0.05, 0.1, 0.25, 0.5, 1, 3, 5, 15, 30, 60, 90, or 120 seconds). In some embodiments, an expanded session region 502 automatically shrinks to condensed form or empty after the expanded session region 502 has been displayed for a threshold amount of time since the expanded session region 502 was first displayed, since an input that triggers expansion of session region 502 (e.g., an input via one or more hardware elements) was last detected (e.g., even if detected while session region 502 is already expanded), and/or since an input was directed to the expanded session region 502 (e.g., for a session region that includes interactive elements such as buttons, sliders, or other elements). In some embodiments, an expanded session region 502 shrinks to condensed form or empty in response to a user input requesting to dismiss the expanded session region 502 (e.g., an input such as an upward swipe on session region 502, an input such as a tap input or other activation input in a user interface displayed outside of session region 502, an input such as a system gesture corresponding to a request to switch between application user interfaces displayed outside of session region 502, or other input).

FIG. 5AC also illustrates user input 548, such as a tap input or other activation input, directed to button 546 (visible in FIG. 5AB, though obscured by user input 548 in FIG. 5AC). FIG. 5AD illustrates that, in response to detecting user input 548, device 100 begins downloading the current media content item (e.g., “Song A”). Button 546 is changed to progress indicator 550 to indicate the progress of the download. FIG. 5AD also illustrates user input 552 requesting to dismiss user interface 544 for the currently playing media content item and to display home screen 500 (e.g., user input 552 is a system gesture such as an upward edge swipe). In the example of FIG. 5AD, user input 552 is detected while the download of the current media content item is ongoing.

FIG. 5AE illustrates that, in response to detecting user input 552, device 100 dismisses user interface 544 and displays home screen 500. In addition, because the download of the current media content item is ongoing, status information for the media download is displayed in session region 502-13 (e.g., the music application icon and a progress indicator), indicating that the media download has progressed since the scenario of FIG. 5AD. In some embodiments, once the media download has completed, an expanded session region alert is displayed, analogously to the software update alert of session region 502-12 in FIG. 5AC for the software update download and installation. In some embodiments, after the media download has completed (and after an expanded media download alert is optionally displayed), if no other sessions are active, session region 502 reverts to empty session region 502-1. For example, following the scenario of FIG. 5AE, home screen 500 would be displayed with empty session region 502-1.

FIG. 5AF illustrates that the current time of day is “Afternoon break,” and accordingly that device 100 automatically displays a suggested activity (e.g., “Start a Run”) for the current time of day in session region 502-14. In the example of FIG. 5AF, “Afternoon break” refers to a time when the user of device 100 typically takes a break from one activity to participate in a different activity, such as taking a break from work to exercise. In some embodiments, the activity suggested in session region 502-14 is selected based on historical data regarding the user's activity patterns during previous instances of the current time of day, a request from the user for device 100 to provide a reminder to perform the suggested activity at the current time of day, and/or other factors. In some embodiments, device 100 displays a suggested activity in accordance with a determination that device 100 is in one or more other types of contexts, such as a suggested activity that is relevant for a recently connected type of output device (e.g., headphones, speaker, television, or other output device) or a recently established type of connection (e.g., Bluetooth, NFC, or other protocol). For example, the suggested activity (e.g., “Start a Run”) is optionally displayed in accordance with a determination that the user of device 100 has connected a set of headphones to device 100 and/or in accordance with the set of headphones being connected to device 100 via Bluetooth.

FIGS. 5AG-5AN illustrate example user interfaces for displaying notification content generally and for using a session region to display notification content, in accordance with some embodiments.

FIGS. 5AG-5AH illustrate displaying notification content in banners over another user interface outside of the session region. For example, FIG. 5AG shows message notification 554, alerting the user of device 100 to an incoming text message, displayed over home screen 500 outside of the currently empty session region 502-1. Similarly, FIG. 5AH shows e-mail notification 556, alerting the user of device 100 to an incoming e-mail, displayed over home screen 500 outside of the currently empty session region 502-1.

FIGS. 5AI-5AJ illustrate displaying notification content in the session region, in contrast to (and in some embodiments alternatively to) FIGS. 5AG-5AH. For example, FIG. 5AI shows session region 502-15 alerting the user of device 100 to an incoming text message (e.g., the incoming text message of message notification 554 in FIG. 5AG). Session region 502-15 is expanded relative to empty session region 502-1 (FIG. 5AG) to occupy at least some of the display area otherwise occupied by the user interface outside of empty session region 502-1 (e.g., home screen 500 and/or one or more portions of the status bar). Session region 502-15 includes an icon for the messaging application, indicating the application with which the notification is associated, and a count (e.g., “1”) indicating the number of currently pending or unread notifications received for the messaging application. Session region 502-15 in FIG. 5AI includes less information about the incoming message than message notification 554 in FIG. 5AG includes. For example, session region 502-15 includes the count of unread message notifications, whereas message notification 554 instead includes the name of the sender of the text message, the timestamp of the text message, the name of the messaging application (e.g., “Message”) in addition to the application icon, and at least some of the content of the text message.

Similarly, FIG. 5AJ shows session region 502-16 alerting the user of device 100 to an incoming e-mail (e.g., the incoming e-mail of e-mail notification 556 in FIG. 5AH). Session region 502-16 is expanded relative to empty session region 502-1 (FIG. 5AH) to occupy at least some of the display area otherwise occupied by the user interface outside of empty session region 502-1 (e.g., home screen 500 and/or one or more portions of the status bar). Session region 502-16 includes an icon for the e-mail application, indicating the application with which the notification is associated, and a count (e.g., “1”) indicating the number of currently pending or unread notifications received for the e-mail application. Session region 502-16 in FIG. 5AJ includes less information about the incoming e-mail than e-mail notification 556 in FIG. 5AH includes. For example, session region 502-16 includes the count of unread e-mail notifications, whereas e-mail notification 556 instead includes the name of the sender of the e-mail, the timestamp of the e-mail, the name of the e-mail application (e.g., “Mail”) in addition to the application icon, at least some of the subject of the e-mail, and at least some of the content of the e-mail (e.g., at least some of the e-mail body).

In some embodiments, the condensed notifications displayed in session region 502 of FIGS. 5AI-5AJ are displayed instead of the banner-style notifications 554 and 556 of FIGS. 5AG-5AH in accordance with a determination that device 100 is in a reduced notification mode, such as a quiet notification mode or “Do Not Disturb” mode in which device 100 at least partially blocks notifications, such as by displaying a subset of a notification's content and/or reducing or suppressing corresponding audio and/or haptic alerts.

FIG. 5AK illustrates that device 100 has received another text message (e.g., a transition from FIG. 5AI or FIG. 5AJ) and that, in response, device 100 displays session region 502-17 with notification content related to the received text message. Session region 502-17 includes the icon for the messaging application, indicating the application with which the notification is associated, and a count (e.g., “2”) indicating the number of currently pending or unread notifications received for the messaging application. The notification count (e.g., “2”) in session region 502-17 of FIG. 5AK is increased from the notification count (e.g., “1”) in session region 502-15 of FIG. 5AI because the earlier notification remains unread. FIG. 5AK also illustrates user input 558, such as a tap input or long press input or other activation input, on session region 502-17.

FIG. 5AL illustrates that, in response to detecting user input 558, device 100 displays an expanded set of unread notifications 560 in banner format outside of session region 502, which reverts to empty session region 502-1. Unread notifications 560 includes notification 560-1 and notification 560-2 corresponding to the two unread notifications for the messaging application as indicated in session region 502-17 of FIG. 5AK. In the example of FIG. 5AL, notifications 560-1 and 560-2 are displayed as a stack of notifications, with notification 560-1 displayed in full (e.g., with content of the message indicated by notification 560-1) and notification 560-2 partially displayed (e.g., without content of the message indicated by notification 560-2) so as to appear to be underneath notification 560-1. In some embodiments, notifications 560-1 and 560-2 are both displayed in full in a list (e.g., with notification 560-2 displayed in full below notification 560-1). In some embodiments, the topmost notification on a stack of notifications or in a list of notifications represents the most recent notification (e.g., the notifications are displayed in reverse chronological order). In some embodiments, the topmost notification on the stack of notifications or in the list of notifications represents the least recent notification (e.g., the notifications are displayed in chronological order).

In some embodiments, in response to detecting a user input directed to notification 560-1, device 100 displays a user interface for the corresponding messaging application, such as a user interface that includes the received message and optionally other portions of the conversation that includes the received message. In some embodiments, in response to detecting user input 558, device 100 displays the user interface for the corresponding messaging application (e.g., with the received message and optionally other portions of the conversation) without displaying the expanded set of notifications 560.

FIG. 5AL also illustrates user input 562, such as a tap input or other activation input, on home screen 500 (e.g., on any portion of home screen 500 or on a portion of home screen 500 that does not correspond to an activatable control such as an application icon). In response to detecting user input 562, device 100 dismisses the expanded set of unread notifications 560, as shown in FIG. 5AM. In addition, because the pending notifications 560 have been viewed as shown in FIG. 5AL, session region 502 in FIG. 5AM has reverted to the empty session region 502-1.

FIG. 5AN illustrates that device 100 has received another text message and that, in response, device 100 displays session region 502-18 with notification content related to the most recently received text message. Session region 502-18 includes the icon for the messaging application and a count (e.g., “1”) indicating the number of currently pending or unread notifications received for the messaging application. The notification count (e.g., “1”) in session region 502-18 of FIG. 5AN is reset (e.g., restarted from zero) rather than increased from the notification count (e.g., “2”) in session region 502-17 of FIG. 5AK, because the earlier notifications have already been viewed, as described with reference to FIGS. 5AK-5AM.

FIGS. 5AO-5BP illustrate example user interfaces for enabling a user to manually select content for display in a session region in accordance with some embodiments.

FIG. 5AO illustrates home screen 500 displayed with empty session region 502-1, and user input 564, such as a tap input or other activation input, on icon 420 for a browser application. In response to detecting user input 564, device 100 displays user interface 566 for the browser application, as illustrated in FIG. 5AP.

In FIG. 5AP, user interface 566 for the browser application includes a webpage with content, such as image 568 (e.g., labeled “Photo 1”). FIG. 5AP also illustrates user input 570, such as a drag input, requesting to transfer image 568 to session region 502-1. In the example shown in FIG. 5AP, image 568 is visually distinguished to indicate that image 568 is selected for transfer (e.g., dimmed, highlighted, increased or decreased in size, displayed with a selection outline, and/or otherwise differentiated).

FIG. 5AQ illustrates that, in response to detecting user input 570, device 100 displays thumbnail 572 of image 568 being moved across the display area in accordance with the movement of user input 570, over user interface 566 toward session region 502-1. In the example shown in FIG. 5AQ, while thumbnail 572 is being moved across the display area, thumbnail 572 is visually distinguished from original image 568 as displayed in the webpage in user interface 566 (e.g., thumbnail 572 is faded, decreased in size, and/or otherwise differentiated from image 568).

FIG. 5AR illustrates session region 502-19 after user input 570 has dragged and dropped thumbnail 572 into session region 502-1. In response to detecting the end of user input 570 while user input 570 is over session region 502-1, device 100 displays thumbnail 572 held in session region 502-19 and optionally changes one or more visual properties of thumbnail 572 (e.g., at least partially reversing some of the changes that visually distinguished thumbnail 572 from image 568). For example, thumbnail 572 in session region 502-19 in FIG. 5AR is brighter, more saturated, and/or otherwise differentiated from dragged thumbnail 572 in FIG. 5AQ.

While the example of FIGS. 5AO-5AR illustrate circumstances in which thumbnail 572 is dragged and dropped into empty session region 502-1, in some circumstances, thumbnail 572 is dragged and dropped into a session region that includes content, such as if session region 502-18 of FIG. 5AN continued to be displayed in FIGS. 5AO-5AQ. In such circumstances, thumbnail 572 would in some embodiments replace the content displayed in session region 502 (e.g., session region 502-18 would cease to be displayed, and session region 502-19 would be displayed instead).

FIG. 5AR also illustrates user input 574-1, optionally a swipe input in a respective direction, such as from left to right, and optionally corresponding to an edge of the display area, such as the bottom edge, requesting to display a user interface for another application (e.g., an edge swipe gesture or other application switching user input).

In response to detecting user input 574-1, device 100 switches from displaying user interface 566 for the browser application to displaying another application user interface, such as the user interface for a next application in a sequence of recently opened applications. As shown in FIG. 5AS, in response to user input 574-1, device 100 optionally displays an animated transition that includes sliding user interface 566 in a respective direction (optionally corresponding to a direction of user input 574-1, such as left to right) out of the display area, and concurrently sliding user interface 576 for an e-mail application into the display area. FIG. 5AS also illustrates embodiments in which, during the animated transition from user interface 566 for the browser application to user interface 576 for the e-mail application, session region 502 is optionally decreased in size to condensed session region 502-20 with an icon (e.g., “P1”) representing thumbnail 572 held in session region 502. In some embodiments, during the animated transition, session region 502 is optionally decreased in size to empty session region 502-1.

FIG. 5AT illustrates that device 100 has switched to displaying user interface 576 for the e-mail application and continues to display session region 502-20 in condensed form. While thumbnail 572 remains held in session region 502, as indicated by condensed session region 502-20, the user of device 100 is enabled to interact with user interface 576 in FIG. 5AT or any other user interface displayed outside of session region 502-20. For example, FIG. 5AT illustrates user input 578, such as swipe input or other interaction, directed to e-mail item 580 in a list of e-mails in user interface 576. In FIG. 5AT, e-mail item 580 represents an unread e-mail, as indicated by the dot in the upper left corner of e-mail item 580 in FIG. 5AT. FIG. 5AU illustrates that, in response to detecting user input 578, e-mail item 580 is marked as read, as indicated by the absence of the dot in the upper left corner of e-mail item 580 in FIG. 5AU. Other examples of available user interactions with user interface 576 while thumbnail 572 is held in session region 502 include providing a tap input or other activation input on e-mail item 580 in FIG. 5AT to view the corresponding e-mail, and/or providing an upward or downward swipe input or other scrolling input to scroll the list of e-mails in user interface 576.

FIG. 5AU also illustrates another application switching user input 574-2 requesting to switch from displaying user interface 576 for the e-mail application to displaying a user interface for another application. FIG. 5AV illustrates that, in response to detecting user input 574-2, device 100 transitions from displaying user interface 576 for the e-mail application to displaying user interface 582-1 for a messaging application, optionally via an animated transition that includes sliding user interface 576 in a respective direction (optionally corresponding to a direction of user input 574-2, such as left to right) out of the display area, and concurrently sliding user interface 582-1 for the messaging application into the display area. FIG. 5AV also illustrates that session region 502-20 is maintained in condensed form during the animated transition.

FIG. 5AW illustrates user interface 582-1 for the messaging application, showing a conversation between the user of device 100 and another participant (e.g., “Tina”). Session region 502-20 is displayed in condensed form with the icon “P1” representing thumbnail 572 held in session region 502. Like in FIG. 5AT, while thumbnail 572 is held in session region 502-20, the user of device 100 is enabled to interact with user interface 582-1 displayed outside of session region 502-20 in FIG. 5AW. For example, FIG. 5AW illustrates a message being composed (e.g., the text “We could try this place”) in message entry region 584, which is displayed with message send button 586; FIG. 5AX illustrates user input 588-1, such as a tap input or other activation input, directed to message send button 586 (visible in FIG. 5AW, though obscured by user input 588-1 in FIG. 5AX) and requesting to send the composed message; and FIG. 5AY illustrates the sent message displayed in the updated conversation in user interface 582-2.

FIG. 5AY also illustrates user input 590-1 directed to condensed session region 502-20. In response to detecting user input 590-1, device 100 displays expanded session region 502-19 with thumbnail 572, as shown in FIG. 5AZ. FIG. 5AZ also illustrates user input 590-2 directed to thumbnail 572 in expanded session region 502-19. In some embodiments, user input 590-2 is a separate input from user input 590-1 (e.g., the beginning of user input 590-2 is detected after detecting the end, such as liftoff, of user input 590-1). In some embodiments, user input 590-2 is a continuation of user input 590-1 (e.g., user input 590-1 is a first portion of an input such as an initial contact on an input device, and user input 590-2 is a second portion of the same input such as subsequent movement of the contact while the contact is maintained on the input device). In the example of FIG. 5AZ, user input 590-2 includes a drag input requesting to transfer thumbnail 572 from session region 502-19 to message entry region 584.

FIG. 5BA illustrates that thumbnail 572 has been dragged out of session region 502 and moved across the display area over user interface 582-2 in accordance with the movement of user input 590-2. Because thumbnail 572 has been removed from session region 502, empty session region 502-1 is displayed instead. In the example shown in FIG. 5BA, and like in FIG. 5AQ, while thumbnail 572 is being moved across the display area over other user interfaces or user interface regions, thumbnail 572 is visually distinguished from its appearance while in session region 502-20 (e.g., thumbnail 572 is faded, decreased in size, and/or otherwise differentiated from its appearance while in session region 502). FIG. 5BA shows that user input 590-2 has positioned thumbnail 572 over message entry region 584.

FIG. 5BB illustrates a transition from FIG. 5BA in response to device 100 detecting the end of user input 590-2 while thumbnail 572 is positioned over message entry region 584. Thumbnail 572 is thus displayed in message entry region 584 with message send button 586.

FIG. 5BC illustrates user input 588-2, such as a tap input or other activation input, directed to message send button 586 (visible in FIG. 5BB, though obscured by user input 588-2 in FIG. 5BC) and requesting to send thumbnail 572 (or a copy of image 568, which thumbnail 572 represents). FIG. 5BD illustrates that, in response to detecting user input 588-2, device 100 displays thumbnail 572 in the updated conversation in user interface 582-3.

FIG. 5BE illustrates user input 592, such as a tap input, long press input, or other activation input, directed to empty session region 502-1. FIG. 5BF illustrates that, in response to detecting user input 592, and optionally because session region 502-1 is an empty session region, device 100 displays expanded session region 502-21 with suggestions of sessions to add to session region 502. In the example of FIG. 5BF, expanded session region 502-21 includes session shortcut 594-1 for adding a wallet pass to session region 502, session shortcut 594-2 for associating session region 502 with a conversation to follow (also called herein “pinning” a conversation), and session shortcut 594-3 for adding a timer session to session region 502.

FIG. 5BG illustrates user input 596-1, such as a tap input or other activation input, directed to wallet pass session shortcut 594-1. FIG. 5BH illustrates that, in response to detecting user input 596-1, device 100 displays condensed session region 502-22 with a representation of a payment card (e.g., the payment card icon and the text label “Pay”). In some embodiments, the wallet pass represented in session region 502-22 is that which is set as the default card (e.g., in a digital wallet) for device 100. In some embodiments, the wallet pass represented in session region 502-22 is selected by the user of device 100. In some embodiments, in response to detecting user input 596-1, device 100 displays a plurality of representations of wallet passes and, in response to a user input selecting a respective wallet pass, subsequently displays the selected respective wallet pass in session region 502. As described with reference to the transit card of FIG. 5H, while displaying session region 502-22 with the representation of the payment card, and in response to establishing communication with a wireless terminal (e.g., in accordance with device 100 being brought into proximity with the wireless terminal), device 100 is configured to transmit the payment card information to the wireless terminal to carry out a transaction (e.g., make a payment); in such scenarios, session region 502 optionally expands to display an expanded representation of the payment card, for at least a respective amount of time, thus providing visual feedback that a transaction is being performed with the payment card.

FIG. 5BI illustrates user input 596-2, such as a tap input or other activation input, directed to conversation pinning session shortcut 594-2. FIG. 5BJ illustrates that, in response to detecting user input 596-2, device 100 displays condensed session region 502-23 with a representation of a conversation (e.g., the messaging application icon and the name “Kim,” referring to another participant in the pinned conversation). In some embodiments, the conversation pinned in session region 502-23 is selected based on one or more factors such as amount of activity, recency of activity, whether the conversation has been pinned to the session region before and/or pinned in the messaging application, and/or other factors. In some embodiments, the conversation represented in session region 502-23 is selected by the user of device 100 (e.g., in response to detecting user input 596-2, device 100 displays a plurality of representations of conversations and, in response to a user input selecting a respective conversation, subsequently pins the selected conversation to session region 502).

FIG. 5BK illustrates that, while the conversation with “Kim” is pinned to session region 502, in response to activity in the conversation such as a new message being received, session region 502-23 expands to session region 502-24 to provide an alert about the conversation activity. In the example of FIG. 5BK, expanded alert session region 502-24 includes information about the conversation activity such as at least a portion of the content of the received new message (e.g., in addition to the messaging application icon and the name “Kim,” one or more of which is increased in size relative to the corresponding element in condensed session region 502-23). FIG. 5BL illustrates that, after expanded alert session region 502-24 is displayed, session region 502-24 reverts to condensed session region 502-23 indicating that the conversation with “Kim” remains pinned yet without continuing to display information about the received message. In some embodiments, expanded session region 502-24 reverts to condensed session region 502-23 automatically after session region 502-24 has been displayed for a respective amount of time. In some embodiments, expanded session region 502-24 reverts to condensed session region 502-23 in response to detection of a user input requesting to dismiss expanded session region 502-24 (e.g., an upward swipe input on expanded session region 502-24, a tap input outside of expanded session region 502-24, or other input).

FIG. 5BM illustrates user input 596-3, such as a tap input or other activation input, directed to timer session shortcut 594-3. FIG. 5BN illustrates that, in response to detecting user input 596-3, device 100 displays expanded session region 502-25 with a user interface for customizing and/or starting a timer. In the example shown in FIG. 5BN, a slider element is provided for selecting the duration of the timer, and a button labeled “Start” is provided for starting the timer. FIG. 5BO illustrates user input 598, such as a tap input or other activation input, directed to the “Start” button while the slider element specifies a fifteen-minute duration for the timer. FIG. 5BP illustrates that, in response to detecting user input 598, device 100 starts the timer and displays the current status of the timer (e.g., the timer icon and the amount of time remaining for the timer) in a timer session in session region 502-26, including continuing to update session region 502-26 as the timer progresses (e.g., decrementing (or in some embodiments incrementing) the timer over time following the scenario illustrated in FIG. 5BP).

FIGS. 5BQ-5CF illustrate example user interfaces for displaying camera information in a session region in accordance with some embodiments.

FIG. 5BQ illustrates home screen 500 with empty session region 502-1, and user input 5100 (e.g., a tap input or other activation input) directed to icon 430 for a camera function of device 100. FIG. 5BR illustrates that, in response to detecting user input 5100, device 100 displays user interface 5102 for the camera function. User interface 5102 includes: a representation of a field of view of one or more cameras (e.g., integrated cameras) of device 100; capture button 5104-1 for performing, starting, or stopping media capture using the camera function (e.g., using one or more integrated cameras) of device 100; and capture length indicator 5106-1 indicating the amount or extent of media capture (e.g., video duration or image count). In the example of FIG. 5BR, the appearance of capture button 5104-1 (e.g., circular) and the zero value of capture length indicator 5106-1 indicate that media capture is not currently taking place. User interface 5102 also indicates that the camera function is currently in a video capture mode (e.g., as indicated by the mode label “VIDEO” displayed centered above capture button 5104-1). In FIG. 5BR, session region 502-1 is empty (e.g., the dashed line that delineates session region 502-1 in FIG. 5BR for ease of reference is optionally not displayed).

FIG. 5BS illustrates user input 5108 (e.g., a tap input or other activation input) directed to capture button 5104-1. FIG. 5BT illustrates that, in response to detecting user input 5108, device 100 initiates video capture of at least a portion of the field of view of the one or more cameras as represented in user interface 5102 (e.g., video capture of the person who is in view in user interface 5102). Accordingly, the appearance of capture button 5104-1 changes (e.g., from circular to rectangular), and capture length indicator 5106-1 is incremented over time. FIG. 5BT also illustrates user input 5110 (e.g., an upward swipe gesture from the bottom edge of the display area, or other system gesture) requesting to navigate away from user interface 5102 for the camera function and to redisplay home screen 500.

FIG. 5BU illustrates that, in response to detecting user input 5110, device 100 redisplays home screen 500. In addition, device 100 displays session region 502-27 that includes a preview of the ongoing video being captured (e.g., of the person who is in view of the one or more cameras), capture length indicator 5106-2 that continues to be incremented as the video capture continues (e.g., as shown in FIGS. 5BU-5BX), and capture button 5104-2 for stopping the ongoing video capture. In some embodiments, the ongoing video capture preview displayed in session region 502-27 is a live preview of the field of view of the one or more cameras of device 100 so as to appear to be updated in real-time.

The example of FIGS. 5BQ-5BU illustrates circumstances in which a live camera view is added to an empty session region such as session region 502-1. In some circumstances, a video preview is displayed in a session region that already includes content, such as if the timer session of session region 502-26 in FIG. 5BP continued to be displayed in FIGS. 5BQ-5BT. In some embodiments, the ongoing video capture preview would replace the content already displayed in session region 502 (e.g., during the transition from FIG. 5BT to FIG. 5BU, session region 502-26 would cease to be displayed, and session region 502-27 would be displayed instead).

While the preview of the ongoing video capture is displayed in session region 502-27, the user of device 100 is enabled to interact with other functions of device 100, as described herein with reference to FIGS. 5BU and 5BV. For example, FIG. 5BU also illustrates user input 5112 (e.g., a tap input or other activation input) directed to icon 448 for a home automation application. FIG. 5BV illustrates that, in response to detecting user input 5112, and while continuing to display and update session region 502-27 (e.g., including updating the preview of the ongoing video capture and incrementing the capture length indicator), device 100 displays user interface 5114 for the home automation application. User interface 5114 includes representations of a plurality of home automation functions that are in communication with device 100, including camera, door lock, and lighting functions. In particular, camera view 5116 includes a representation of the field of view of one or more cameras that are in communication with device 100, such as one or more home security cameras that are external to device 100. In some embodiments, camera view 5116 displays an intermittently captured frame of the field of view of the one or more external cameras that is updated over time (e.g., at periodic intervals and/or when activity occurs within the field of view) with a current frame of the field of view (e.g., as indicated by the amount of time, “3s” that has elapsed since the frame displayed in camera view 5116 was captured). Optionally, camera view 5116 in user interface 5114 displays a live preview of the field of view of the one or more external cameras.

FIG. 5BV illustrates user input 5118 (e.g., a tap input or other activation input) directed to camera feed 5116. FIG. 5BW illustrates that, in response to detecting user input 5118, and while continuing to display and update session region 502-27 (e.g., including updating the preview of the ongoing video capture and incrementing the capture length indicator), device 100 displays user interface 5120 with an expanded live camera feed 5122 and one or more interaction controls, such as speaker button 5124 for listening to sound ambient to the one or more external cameras and microphone button 5126 for communication with a person in view of the one or more external cameras. In the example of FIGS. 5BW-5BY, because session region 502-27 is displayed with a fill color that is the same or similar color as the background color of portions of user interface 5120 that border session region 502-27, and because session region 502-27 includes an active session (e.g., the preview of the ongoing video capture), session region 502-27 is delineated with a border. In contrast, in the examples of FIGS. 5BR-5BT, although session region 502-1 is displayed with a fill color that is the same or similar color as the background color of portions of user interface 5102 that border session region 502-1, because session region 502-1 is an empty session region, session region 502-1 is not delineated with a border.

In some embodiments, live camera feed 5122 in user interface 5120 of FIG. 5BW is updated over time (e.g., at a plurality of different points in time) to reflect the current field of view of the corresponding one or more external cameras, so as to appear to be updated in real-time. For example, FIG. 5BX illustrates, in a transition from FIG. 5BW, that live camera feed 5122 has been updated to show that the person who was in view of the one or more external cameras in FIG. 5BW has moved closer to the one or more external cameras and thus appears closer and larger in live camera feed 5122 in FIG. 5BX than in FIG. 5BW.

FIG. 5BX also illustrates user input 5128 (e.g., a tap input or other activation input) directed to capture button 5104-2 in session region 502-27. FIG. 5BY illustrates that, in response to detecting user input 5128, device 100 stops the ongoing video capture using the camera function (e.g., via the one or more integrated cameras of device 100), and accordingly changes the appearance of capture button 5104-2 (e.g., from rectangular back to circular) and ceases to display capture length indicator 5106-2.

FIG. 5BY also shows user input 5130 requesting to switch from displaying user interface 5120 to displaying a user interface for another application (e.g., an edge swipe gesture or other application switching user input). FIG. 5BZ illustrates that, in response to detecting user input 5130, device 100 transitions to displaying user interface 5132 for the music application. User interface 5132 for the music application is analogous to user interface 544 of FIG. 5AB. In addition, device 100 replaces session region 502-27 for the video capture preview, which was stopped in response to user input 5128 in FIG. 5BX, with session region 502-28 for the live external camera feed that was being viewed in user interface 5120 in FIGS. 5BW-5BY. Session region 502-28 includes status information for the one or more external cameras, such as a video camera icon and identifier for the one or more external cameras (e.g., the label “Front Door”), live feed 5134 of the field of view of the one or more external cameras, and one or more interactive controls, such as a control for audio input and/or output from the one or more external cameras and that optionally indicates whether audio input and/or output is muted or unmuted, a control for changing a state of an associated lock (e.g., physically locking or unlocking a door that the one or more external cameras are configured for monitoring) and that optionally indicates whether the lock is locked or unlocked, and/or a control for changing an illumination state of associated lighting (e.g., dimming or turning off, brightening or turning on, and/or changing a color of lighting for a physical area that the one or more external cameras are configured for monitoring) and that optionally indicates whether the lighting is on or off. FIG. 5BZ also illustrates user input 5136 (e.g., a tap input, drag input, or other interaction input) directed to live feed 5134 in session region 502-28.

FIG. 5CA illustrates that, in response to detecting user input 5136, device 100 ceases to display live feed 5134 in session region 502-28 and instead displays live feed 5134 in picture-in-picture (PiP) window 5138 over user interface 5132 outside of session region 502, as well as minimizing session region 502 to empty session region 502-1. In some embodiments, session region 502 is minimized to empty session region 502-1 because session region 502 is not associated with any other active sessions (e.g., other than the media playback session already represented in user interface 5132 outside of session region 502). In some embodiments, in circumstances in which session region 502 is associated with another session, the other session is redisplayed in session region 502 in conjunction with live feed 5134 being transitioned from session region 502 to PiP window 5138 outside of session region 502 (e.g., if timer session region 502-26 in FIG. 5BP had continued to be displayed in FIGS. 5BQ-5BT, as described above with reference to FIG. 5BU, and were still active, timer session region 502-26 would be redisplayed in FIGS. 5CA-5CD). Thus, the user of device 100 is enabled to transition between displaying live feed 5134 in session region 502, optionally with other associated status information and/or interactive controls, and displaying live feed 5134 in an inset picture-in-picture (PiP) window over another user interface, optionally without the other associated status information and/or interactive controls.

FIG. 5CA also illustrates user input 5140 requesting to dismiss PiP window 5138 (e.g., a swipe input, such as toward an edge of the display area, or other input). FIG. 5CB illustrates that, in response to detecting user input 5140, device 100 ceases to display PiP window 5138 and displays pull indicator 5142 at the edge of user interface 5132 in the upper left region where PiP window 5138 was previously displayed. Pull indicator 5142 indicates that PiP window 5138 has been hidden and optionally that interacting with pull indicator 5142 will result in PiP window 5138 being redisplayed. Indeed, FIG. 5CC illustrates user input 5144 directed to pull indicator 5142 (e.g., a tap input, swipe input, drag input, or other input), and FIG. 5CD illustrates that, in response to detecting user input 5144, device 100 redisplays PiP window 5138 (e.g., at the same location at which PiP window 5138 was displayed prior to being hidden).

FIG. 5CD also illustrates user input 5146 directed to PiP window 5138 and corresponding to a request to move live feed 5134 to session region 502-1 (e.g., a drag input that is initiated on PiP window 5138 and that includes movement to session region 502-1, or other repositioning input). FIG. 5CE illustrates that, in response to detecting user input 5146, device 100 displays (e.g., redisplays) session region 502-28 that includes live feed 5134. FIG. 5CE also illustrates user input 5148 directed to session region 502-28 and corresponding to a request to dismiss session region 502-28 (e.g., an input such as an upward swipe on session region 502-28, an input such as a tap input or other activation input in user interface 5132 outside of session region 502-28, or other input). FIG. 5CF illustrates that, in response to detecting user input 5148, device 100 ceases to display expanded session region 502-28 with live preview 5134 and instead displays condensed session region 502-29 with status information for the associated live preview session (e.g., a video camera icon and a thumbnail of live preview 5134).

FIGS. 5BZ-5CF thus illustrate that in some embodiments, interaction options available for positioning and/or minimizing live feed 5134 while displayed in session region 502 are different from interaction options available for positioning and/or minimizing live feed 5134 while displayed outside of session region 502 over another user interface such as user interface 5132. For example, while session region 502-28 is displayed in a particular predefined region of the display area (e.g., centered to and aligned near the top of the display area, as in the examples of FIGS. 5BZ and 5CE), PiP window 5138 can be displayed at different locations over user interface 5132 (e.g., a drag input that is initiated on PiP window 5138 in FIG. 5CA or 5CD and that includes movement toward the left and/or downward may be performed to reposition PiP window 5138 over user interface 5132 toward the left and/or bottom of the display area). In another example, FIGS. 5CA-5CB illustrate that PiP window 5138 is minimized by ceasing to display PiP window 5138 and instead displaying pull indicator 5142 near where PiP window 5138 was previously displayed. In contrast, FIGS. 5CE-5CF illustrate that session region 502-28 is minimized by condensing session region 502 into session region 502-29.

FIGS. 5CG-5DD illustrate example user interfaces displayed in a session region in response to inputs via corresponding hardware elements, in accordance with some embodiments.

FIG. 5CG illustrates user input 5150-1 directed to volume adjustment button(s) 208 (e.g., a press input, touch input, or other input), and particularly to volume up button 208-1 (e.g., a first portion, that rocks in a first direction, of a single button that rocks in multiple directions, or a respective button of multiple separate buttons). FIG. 5CH illustrates that, in response to detecting user input 5150-1, device 100 displays session region 502-30 that includes a volume adjustment user interface. In the example of FIGS. 5CG-5CH, user input 5150-1 is detected while another active session is represented in session region 502 (e.g., session region 502-29 described herein with reference to FIG. 5CF), and, in response, session region 502-30 replaces display of session region 502-29. In another example scenario, user input 5150-1 is detected while empty session region 502-1 is displayed, and, in response, session region 502-30 replaces display of session region 502-1. In response to detecting user input 5150-1, device 100 increases an output volume level of device 100 (e.g., via one or more output devices with which device 100 is in communication, such as one or more integrated speakers, one or more external speakers, and/or other output device(s)), such as for audio output and/or tactile output. The increase in output volume level is reflected in FIG. 5CH in that the current output volume level, indicated by volume slider 5152 in session region 502-30, is above the previous output volume level, which is indicated by dashed line 5154. The increase in output volume level is also reflected in user interface 5132 displayed outside of session region 502-30; in FIG. 5CH for example, the output volume level for audio content from the music application, as represented by slider thumb 5158 along volume slider 5156 in user interface 5132, indicates a higher output volume level than that represented by dashed circle 5160 along volume slider 5156, which indicates the previous position of slider thumb 5158 (e.g., the position of slider thumb 5158 in FIG. 5CG).

FIG. 5CI is similar to FIG. 5CG except that FIG. 5CI illustrates empty session region 502-1 displayed instead of session region 502-30 (e.g., FIG. 5CI is otherwise identical to FIG. 5CG). FIG. 5CI also illustrates user input 5150-2 directed to volume up button 208-1 (e.g., the same type of input as user input 5150-1 in FIG. 5CG except in the alternative scenario of FIG. 5CI). FIG. 5CJ illustrates that, in response to detecting user input 5051-2, device 100 displays session region 502-30 and user interface 5132 in the same state as in FIG. 5CH (e.g., FIG. 5CH and FIG. 5CJ are identical). FIGS. 5CG-5CH in comparison with FIGS. 5CI-5CJ thus illustrate that an input via a hardware element, such as input 5150 on volume up button 208-1, results in the same behavior of device 100 (e.g., an increase in output volume level, display of session region 502-30, and/or updating of user interface 5132) regardless of whether session region 502 displays an active session (e.g., as in FIG. 5CG) or is empty (e.g., as in FIG. 5CI).

FIG. 5CK illustrates user input 5162 including a rightward drag input directed to volume slider 5152 in session region 502-30. FIG. 5CL illustrates that, in response to detecting user input 5162, device 100 increases the output volume level. For example, session region 502-30 in FIG. 5CK is updated to session region 502-31 in FIG. 5CL; volume slider 5152 in session region 502-31 indicates a higher output volume level than in session region 502-30. The increase in output volume level is also reflected in user interface 5132 displayed outside of session region 502-31, in that slider thumb 5158 is further to the right along volume slider 5156 in FIG. 5CL than in FIG. 5CK, indicating an increase in the output volume level for audio content from the music application. One of ordinary skill in the art will recognize that, analogously, a leftward drag input (e.g., an input in the opposite direction as the input for increasing the output volume level) may be performed to decrease the output volume level.

FIGS. 5CH, 5CJ, and 5CL illustrate embodiments or circumstances in which volume button(s) 208 control the output volume level for application content (e.g., audio content from the music application), as reflected by the changes to slider thumb 5158 on volume slider 5156. In some embodiments or circumstances, volume button(s) 208 controls the output volume level for other types of outputs, such as alerts (e.g., ringtones for incoming calls, sounds and/or haptics for notifications, and other alerts) and/or other system outputs (e.g., sound and/or haptic effects to indicate selection, deselection, activation, dragging, dropping, and/or other interactions with displayed user interface elements).

FIG. 5CM illustrates user input 5164 directed to volume adjustment button(s) 208, and particularly to volume down button 208-2 (e.g., a second portion that rocks in a second direction, of the single button that also includes the first portion that rocks in the first direction for volume up button 208-1, or a different button of multiple separate buttons than volume up button 208-1). FIG. 5CN illustrates that, in response to detecting user input 5164, device 100 decreases the output volume level. For example, session region 502-31 in FIG. 5CM is updated to session region 502-32 in FIG. 5CN; volume slider 5152 in session region 502-32 indicates a current output volume level that is lower than the previous output volume level of session region 502-31, which is indicated in session region 502-32 by dashed line 5166. FIG. 5CN, however, illustrates embodiments or circumstances in which volume button(s) 208 control the output volume for outputs other than application content (e.g., unlike FIGS. 5CH, 5CJ, and 5CL), and thus the decrease in output volume level of device 100 is not reflected in user interface 5132 displayed outside of session region 502-32; accordingly, slider thumb 5158 is at the same position along volume slider 5156 in FIG. 5CN as in FIG. 5CM, indicating no increase in the output volume level for audio content from the music application.

FIG. 5CO illustrates user input 5168-1 directed to switch 214 (visible in FIG. 5CN, though obscured by user input 5168-1 in FIG. 5CO) (e.g., flipping a toggle switch, pressing a push button, or other switch interaction). FIG. 5CP illustrates that, in response to user input 5168-1, the connection state of switch 214 is changed (e.g., from a first connection state to a second connection state of two or more connection states available for switch 214, such as from open to closed or vice versa, or from being connected to a first contact to being connected to a second contact, or other change in switch configuration), as indicated by the change in appearance of switch 214 from a solid fill pattern in FIGS. 5CN-5CO to a hatched fill pattern in FIG. 5CP. In addition, in response to detecting user input 5168-1, device 100 replaces display of session region 502-32 for volume adjustment with display of session region 502-33 indicating that device 100 has been transitioned to a reduced audio output mode (e.g., in which at least some audio and/or tactile outputs are at least partially suppressed), labeled “Silent Mode.” Session region 502-33 includes icon 5170-1 with an appearance that represents the reduced audio output mode being enabled.

FIG. 5CQ illustrates user input 5172 (e.g., a tap input or other activation input) directed to icon 5170-1 (visible in FIG. 5CP, though obscured by user input 5172 in FIG. 5CQ) in session region 502-33. FIG. 5CR illustrates that, in response to detecting user input 5172, device 100 remains in the reduced audio output mode and maintains display of session region 502-33 with the same appearance. In other words, FIGS. 5CQ-5CR illustrate embodiments or circumstances in which the user interface displayed (e.g., in session region 502) in response to an input via a respective hardware element is not responsive to touch inputs to change a software state of device 100 that is associated with the respective hardware element. For example, if whether device 100 is in the reduced audio output mode or not is controlled by the physical state of switch 214 (e.g., whether switch 214 is in a first connection state or a second connection state of two or more connection states, such as open versus closed, or connected to a first contact versus connected to a second contact, or other switch configuration), the appearance of session region 502-33 likewise conforms to the physical state of switch 214, so as to maintain consistency between the physical state of switch 214 and the status information conveyed by displayed session region 502-33. In contrast to FIGS. 5CQ-5CR, FIGS. 5CK-5CL illustrate embodiments or circumstances in which the user interface displayed (e.g., in session region 502) in response to an input via a respective hardware element is in fact responsive to touch inputs to change a software state of device 100 that is associated with the respective hardware element. For example, as described herein with reference to FIGS. 5CK-5CL, session region 502-30 is responsive to user input 5162 (e.g., a touch input or other manipulation input), and device 100 changes the output volume level accordingly in response.

FIG. 5CR also illustrates user input 5174 (e.g., an upward swipe gesture from the bottom edge of the display area, or other system gesture) requesting to navigate away from user interface 5132 for the music application and to redisplay home screen 500. FIG. 5CS illustrates that, in response to detecting user input 5174, device 100 redisplays home screen 500. FIG. 5CS also illustrates that device 100 has ceased to display session region 502-33 and has redisplayed empty session region 502-1 (e.g., session region 502-33 is dismissed and transitions to empty session region 502-1 in conjunction with the transition from user interface 5132 for the music application to home screen 500 outside of session region 502).

FIG. 5CS also illustrates user input 5168-2 directed to switch 214 (visible in FIG. 5CR, though obscured by user input 5168-2 in FIG. 5CS) (e.g., the same type of input as user input 5168-1 in FIG. 5CO, such as pressing the push button again; or a different, optionally opposite, type of input as user input 5168-1, such as flipping the toggle switch in a different, optionally opposite, direction; or other switch interaction). FIG. 5CT illustrates that, in response to user input 5168-2, the connection state of switch 214 is changed again (e.g., from the second connection state back to the first connection state or to a third connection state of a plurality of connection states available for switch 214, such as from closed back to open or vice versa, or from being connected to the second contact back to being connected to the first contact or to being connected to a third contact, or other change in switch configuration), as indicated by the change in appearance of switch 214 from the hatched fill pattern in FIG. 5CS back to the solid fill pattern in FIG. 5CT. In addition, in response to detecting user input 5168-2, device 100 displays session region 502-34 indicating that device 100 has been transitioned out of the reduced audio output mode (e.g., both session region 502-33 and session region 502-34 display status information for the reduced audio output mode; the appearance of session region 502-33 is used for enabling the reduced audio output mode, whereas the different appearance of session region 502-34 is used for disabling the reduced audio output mode). In some embodiments, if user input 5168-2 had been detected while another session was displayed in session region 502, session region 502-34 would have replaced display of the other displayed session.

Icon 5170-2 in session region 502-34 has an appearance that represents the reduced audio output mode being disabled (e.g., device 100 has transitioned to a normal audio output mode in which audio and/or tactile outputs are not suppressed or another audio output mode in which audio and/or tactile outputs are suppressed less than in the reduced audio output mode). Like icon 5170-1 in session region 502-33 (FIG. 5CP), icon 5170-2 in session region 502-34 is not responsive to user inputs such as touch inputs so as to change whether device 100 is in the reduced audio output mode or not, as described herein with reference to FIGS. 5CQ-5CR (e.g., in response to a user input directed to icon 5170-2 in session region 502-34, the reduced audio output mode would remain disabled, and device 100 would maintain display of session region 502-34 with the same appearance, rather than transitioning to display of session region 502-33).

FIG. 5CU illustrates user input 5176 (e.g., a long button press or other actuation) detected via side button 206. User input 5176 represents a different type of input than is used to display a wake screen user interface (e.g., a different type than user input 522 of FIG. 5S, used to display wake screen user interface 524 of FIG. 5T). FIG. 5CV illustrates that, in response to detecting user input 5176, device 100 displays session region 502-35 indicating that a virtual assistant is invoked (e.g., by including in session region 502-35 a representation of an active virtual assistant, such as a dynamic visual element that animates over time). Invoking the virtual assistant of device 100 enables a user to provide voice, text (e.g., via an on-screen keyboard that is optionally displayed in conjunction with invoking the virtual assistant), and/or other inputs that include requests to perform tasks or operations, which the virtual assistant performs or helps the user to perform.

For example, FIG. 5CW illustrates a change in appearance (e.g., an animation) of session region 502-35 while detecting voice command 5178 asking the virtual assistant, “What's the weather?” FIG. 5CX illustrates that, in response to voice command 5178, device 100 updates session region 502-35 to include a response to the voice command 5178 (e.g., “It's mostly clear in SF”). In some embodiments, the virtual assistant provides the response to voice command 5178 via an audio output (e.g., in addition to or instead of the update to session region 502-35). In some embodiments, device 100 displays banner 5180, outside of and optionally separate from session region 502-35, that provides additional information and/or context responsive to voice command 5178 (e.g., in addition to or instead of the update to session region 502-35). For example, device 100 in FIG. 5CX displays information from a weather application in banner 5180 in addition to the response (e.g., “It's mostly clear in SF”) in session region 502-35.

FIG. 5CY illustrates user input 5182 (e.g., a double press or other activation input) detected via side button 206. User input 5182 represents a different type of input than is used to display a wake screen user interface (e.g., a different type than user input 522 of FIG. 5S, used to display wake screen user interface 524 of FIG. 5T) and/or a different type of input than is used to invoke a virtual assistant (e.g., a different type than user input 5176 of FIG. 5CU, used to invoke the virtual assistant represented in session region 502-35 of FIG. 5CV). FIG. 5CZ illustrates that, in response to detecting user input 5182, device 100 displays session region 502-36 with a representation of a payment card (e.g., user input 5182 invokes a wallet pass session). In some embodiments, the payment card represented in session region 502-36 is selected in an analogous manner to when a wallet pass session is added to session region 502 via a wallet pass session shortcut (e.g., as described in more detail herein with reference to FIGS. 5BG-5BH). For example, the payment card represented in session region 502-36 is that which is set as the default card for device 100. In some embodiments, session region 502-36, displayed in response to user input 5182 via side button 206, is displayed as an expanded session region, whereas session region 502-22 of FIG. 5BH, displayed in response to one or more user inputs including user input 596-1 of FIG. 5BG optionally in sequence with user input 592 of FIG. 5BE via touchscreen 112, is displayed in contrast as a condensed session region. In some embodiments, whether a session region for an added or invoked session is displayed as an expanded session region or a condensed session region is based on the type of input used to add or invoke the session (e.g., using side button 206 to invoke the payment card indicates greater and/or more immediate user intent to use the payment card, so session region 502-36 is displayed in expanded form; whereas using the sequence of user inputs via touchscreen 112 to invoke the payment card suggests lesser and/or less urgent user intent to use the payment card, so session region 502-22 is displayed in condensed form (e.g., until device 100 is brought into proximity with a wireless terminal to carry out a transaction).

FIG. 5DA illustrates user input 5184 including multiple inputs, such as multiple concurrent inputs (e.g., concurrent button presses or other concurrent actuations) or multiple sequential inputs, via volume button(s) 208 (e.g., particularly to volume down button 208-2 in the example of FIG. 5DA) and via side button 206. FIG. 5DB illustrates that, in response to detecting user input 5184, device 100 captures a screenshot of the currently displayed user interface (e.g., optionally excluding session region 502) and displays a representation of the captured screenshot in session region 502-37, which in some embodiments or circumstances replaces display of session region 502-36.

FIG. 5DC illustrates user input 5186 including multiple inputs, such as multiple concurrent inputs (e.g., concurrent long button presses or other concurrent actuations) or multiple sequential inputs, via volume button(s) 208 (e.g., particularly to volume down button 208-2 in the example of FIG. 5DC) and via side button 206. User input 5186 represents a different type of input than is used to capture a screenshot (e.g., a different type than user input 5184 of FIG. 5DA, used to capture the screenshot represented in session region 502-37). For example, user input 5186 represents concurrent long button presses that are maintained for at least a threshold amount of time, whereas user input 5184 represents concurrent button presses that are released before the threshold amount of time. FIG. 5DD illustrates that, in response to detecting user input 5186, device 100 displays session region 502-38 including power down slider 5188, and user interface 5190 outside of session region 502-38. User interface 5190 outside of session region 502-38 optionally includes one or more additional user interface elements such as medical information slider 5192 and emergency call slider 5194, as well as optionally cancel button 5196. In some embodiments, the user interface element that is displayed in session region 502 corresponds to a primary function associated with user input 5186 (e.g., with the input type and/or hardware element(s) used to detect the input), and the user interface element(s) displayed in user interface 5190 correspond to other functions associated with user input 5186 that are also made available in conjunction with the primary function presented in session region 502.

In some embodiments, power down slider 5188 is activatable, such as via user input 5198-1 (e.g., a drag input) to turn off device 100. In some embodiments, medical information slider 5192 is activatable, such as via user input 5198-2 (e.g., a drag input) to cause display of a user interface for viewing or otherwise accessing identification information, and particularly medically relevant information, about the user of device 100 that may help another person, such as a first responder, attend to the user in an emergency, such as if the user is injured and/or unresponsive. In some embodiments, emergency call slider 5194 is activatable, such as via user input 5198-3 (e.g., a drag input), to make a call to emergency services such as first responders. In some embodiments, cancel button 5196 is activatable (e.g., using a tap input or other activation input) to dismiss session region 502-38 and/or user interface 5190.

FIGS. 6A-6B are flow diagrams illustrating method 600 of automatically displaying content in a session region based on a current context of a device in accordance with some embodiments. Method 600 is performed at a computer system (e.g., portable multifunction device 100, FIG. 1A, or device 300, FIG. 3) that is in communication with a display generation component having a display area (e.g., touch screen 112, FIG. 1A, or display 340, FIG. 3). In some embodiments, one or more sensors of the computer system (e.g., speaker 111 and/or one or more optical sensors 164, FIG. 1A, or sensor(s) 359, FIG. 3) are positioned within one or more sensor regions that are encompassed by the status region, and the display generation component is not capable of displaying content within the one or more sensor regions. Some operations in method 600 are, optionally, combined and/or the order of some operations is, optionally, changed.

While displaying a user interface corresponding to a first function (e.g., a first application or first portion of a system user interface), the computer system automatically determines (602) that the computer system is in a respective context associated with a second function that is different from the first function (optionally, while the computer system is not displaying user interface elements associated with the second function). Determining that the computer system is in the respective context is performed without detecting an input to perform an operation associated with the second function (or without regard to whether an input to perform an operation associated with the second function is detected). Example of respective contexts recognized by a computer system are described herein with reference to FIGS. 5F-5AF (e.g., location context(s), time of day context(s), and connection status context(s)).

In response to automatically determining that the computer system is in the respective context, the computer system displays (604), in a status region of the display area, a user interface object that includes status information about the second function, while displaying the user interface corresponding to the first function outside of the status region. Example status regions with context-based status information about a different function than that of the user interface displayed outside of the status region are described herein with reference to session region 502-4 (FIG. 5H), session region 502-5 (FIG. 5J), session region 502-6 (FIG. 5L), session region 502-8 (FIG. 5P), session region 502-10 (FIG. 5U), session region 502-11 (FIG. 5Z), session region 502-13 (FIG. 5AE), and session region 502-14 (FIG. 5AF).

While displaying the user interface object that includes status information about the second function in the status region, the computer system detects (606) an input corresponding to a request to display a user interface corresponding to a third function (e.g., a second application or a system user interface) outside of the status region. The user interface corresponding to the third function is different from the user interface corresponding to the first function.

In response to detecting the input corresponding to a request to display the user interface corresponding to the third function outside of the status region, the computer system displays (608) the user interface corresponding to the third function outside of the status region while continuing to display the user interface object that includes status information about the second function. For example, status region 502-11 continues to be displayed while device 100 transitions from displaying home screen 500 in FIG. 5AA to displaying user interface 544 for the music application in FIG. 5AB.

In some embodiments, the computer system detects one or more inputs corresponding to a request to associate the status region with an active session of a fourth function, and, in response to detecting the one or more inputs, displays in the status region a user interface object that includes status information about the fourth function, while displaying the user interface corresponding to the first function outside of the status region (or, in some circumstances, while displaying outside of the status region a user interface corresponding to a fifth function that is different from the first function). In some embodiments, in response to automatically determining that the computer system is in the respective context, displaying the user interface object that includes status information about the second function in the status region replaces display of the user interface object that includes status information about the fourth function in the status region.

Automatically displaying status information about a function of the computer system based on a current context of the computer system causes the computer system to automatically provide a user with quick access to information and/or interaction options that the user is likely to use, and displaying such status information in a status region that continues to be displayed as different user interfaces for other functions of the computer system are displayed outside of the status region makes more efficient use of the display area, thereby reducing the number of inputs and amount of time needed to perform a particular operation on the computer system.

In some embodiments, displaying the user interface object that includes the status information about the second function includes (610) displaying a representation of a secure credential (e.g., session region 502-4 (FIG. 5H) and session region 502-5 (FIG. 5J) corresponding to a transit card, session region 502-6 corresponding to a coffee card (FIG. 5L), and session region 502-8 corresponding to a boarding pass (FIG. 5P)). In some embodiments, the secure credential is a payment method (e.g., a credit card, debit card, or other transactional financial account), an identification card (e.g., a passport, driver license, health record card, or other form of identification), or a wireless entry key (e.g., for a vehicle, building, or other access-controlled location). In some embodiments, the secure credential is stored on the computer system. In some embodiments, in response to the computer system being brought into proximity with a wireless terminal and optionally conditional on biometric authentication or other user authentication performed by the computer system, the secure credential is transmitted to the wireless terminal for use by the wireless terminal to authenticate the user of the computer system (e.g., to verify the user's identity, to make a payment or other transaction, to unlock a door, or to perform another authentication-based operation). In some embodiments, the computer system displays different representations of different credentials (e.g., a representation of a first payment card has a different appearance from a representation of a second payment card; a payment card, an identification card, and an entry key have different appearances from each other) so as to enable a user to readily determine which secure credential is being used or made available for use. Automatically displaying, in the status region, a secure credential based on a current context, such as a current location, of the computer system causes the computer system to automatically provide a user with quick access to a function that the user is likely to use, thereby reducing the number of inputs and amount of time needed to perform a particular operation on the computer system while making more efficient use of the display area.

In some embodiments, the respective context includes (612) a location (e.g., a home of a user of the computer system, a retail location, a transit location, a work location, an event venue, a meeting location, or other location) (e.g., “Home” (FIG. 5F), “En route” (FIG. 5G), “Transit station” (FIG. 5H), “Coffee shop” (FIG. 5L), and “Airport” (FIG. 5P)). Automatically displaying, in the status region, status information relevant to a particular location (e.g., a current location of the computer system) causes the computer system to automatically provide a user with quick access to information and/or interaction options that the user is likely to use, thereby reducing the number of inputs and amount of time needed to perform a particular operation on the computer system while making more efficient use of the display area.

In some embodiments, the respective context includes (614) a time of day (e.g., morning, afternoon, evening, night time, commute time, a time associated with an event stored on the computer system such as a meeting or trip, a time at which the computer system has been frequently used to perform the second function, or other time of day) (e.g., “Morning commute” (FIG. 5H) and “Afternoon break” (FIG. 5AF)). Automatically displaying, in the status region, status information relevant to a particular time of day (e.g., a current time of day of the computer system) causes the computer system to automatically provide a user with quick access to information and/or interaction options that the user is likely to use, thereby reducing the number of inputs and amount of time needed to perform a particular operation on the computer system while making more efficient use of the display arca.

In some embodiments, displaying the user interface object that includes the status information about the second function includes (616) displaying an indication that an updated version of software (e.g., an operating system, an application, or other software) installed on the computer system is available (e.g., as described herein with reference to session region 502-10 in FIGS. 5U-5W). Automatically displaying, in the status region, an indication that a software update is available causes the computer system to automatically provide a user with quick access to information that is likely to be of interest to the user, thereby reducing the number of inputs and amount of time needed to perform a particular operation on the computer system while making more efficient use of the display area.

In some embodiments, displaying the user interface object that includes the status information about the second function includes (618) displaying a status of updating software on the computer system (e.g., update download status, update installation status, and/or other status) (e.g., as described herein with reference to session region 502-11 in FIGS. 5Z-5AB and session region 502-12 in FIG. 5AC). Automatically displaying, in the status region, an indication of a current status of a software update being performed on the computer system, regardless of which user interface is displayed outside of the status region, causes the computer system to automatically provide a user with quick access to information that is likely to be of interest to the user, thereby reducing the number of inputs and amount of time needed to perform a particular operation on the computer system while making more efficient use of the display area.

In some embodiments, displaying the user interface object that includes the status information about the second function includes (620) displaying an activity status of a function performed concurrently on the computer system with displaying the user interface corresponding to the third function (e.g., as described herein with reference to session region 502-13 in FIG. 5AE). In some embodiments, the activity status indicates a status of downloading software or content, uploading the software or content, syncing the software or content between the computer system and another computer system, or other process executing in the background while a user is enabled to interact with the third function. Automatically displaying, in the status region, an indication of background activity on the computer system causes the computer system to automatically provide a user with quick access to information that is likely to be of interest to the user, thereby reducing the number of inputs and amount of time needed to perform a particular operation on the computer system while making more efficient use of the display area.

In some embodiments, the computer system detects (622) an input (e.g., one or more presses of a button such as a power button, an input gesture such as a proximity gesture or a touch gesture detected via a touch-sensitive surface, or other input) corresponding to a request to display a wake screen user interface. In some embodiments, a wake screen user interface is a user interface that is displayed while the computer system is in a low-power state in which the display generation component is at least partially off (e.g., in response to an input to power down the display generation component). In some embodiments, the wake screen user interface is displayed in response to an input prompting the computer system to come out of the low-power state. In some embodiments, the wake screen user interface is displayed regardless of whether the computer system is in a locked state or has already been unlocked (e.g., the wake screen user interface is displayed upon waking the computer system before a user accesses a home screen user interface from which applications can be launched and/or accesses other application user interfaces.

In some embodiments, in response to detecting the input corresponding to the request to display the wake screen user interface, the computer system: displays the wake screen user interface outside of the status region (e.g., ceasing to display the user interface corresponding to the third function outside of the status region); and continues to display the status information about the second function (e.g., in the user interface object in the status region, or in the wake screen user interface outside of the status region). For example, as described herein with reference to FIGS. 5S-5T, in response to detecting user input 522 (FIG. 5S) corresponding to a request to display a wake screen user interface, session information for the boarding pass is transitioned out of session region 502-9 (FIG. 5S) and displayed in widget 526 in wake screen user interface 524 (FIG. 5T). Displaying status information about a function of the computer system on a wake screen based on a current context of the computer system causes the computer system to automatically provide a user with quick access to information and/or interaction options that the user is likely to use, thereby reducing the number of inputs and amount of time needed to perform a particular operation on the computer system.

It should be understood that the particular order in which the operations in FIGS. 6A-6B have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 900, and 1000) are also applicable in an analogous manner to method 600 described above with respect to FIGS. 6A-6B. For example, the session regions, status information, user interface objects, user interfaces, user inputs, gestures, alerts, device/system contexts, and/or device/system functions described above with reference to method 600 optionally have one or more of the characteristics of the session regions, status information, user interface objects, user interfaces, user inputs, gestures, alerts, device/system contexts, and/or device/system functions described herein with reference to other methods described herein (e.g., methods 700, 800, 900, and 1000). For brevity, these details are not repeated here.

FIGS. 7A-7D are flow diagrams illustrating method 700 of displaying notification content generally and using a session region to display notification content in accordance with some embodiments. Method 700 is performed at a computer system (e.g., portable multifunction device 100, FIG. 1A, or device 300, FIG. 3) that is in communication with a display generation component having a display area (e.g., touch screen 112, FIG. 1A, or display 340, FIG. 3), optionally a touch-sensitive surface (e.g., touch screen 112, FIG. 1A, or touchpad 355, FIG. 3), and optionally one or more sensors (e.g., speaker 111 and/or one or more optical sensors 164, FIG. 1A, or sensor(s) 359, FIG. 3). In some embodiments, one or more sensors of the computer system are positioned within one or more sensor regions that are encompassed by the status region, and the display generation component is not capable of displaying content within the one or more sensor regions. Some operations in method 700 are, optionally, combined and/or the order of some operations is, optionally, changed.

While displaying a first user interface (e.g., a user interface for an application or a system user interface) in display area outside of a status region of the display area, wherein the status region is surrounded on at least two sides by the first user interface, the computer system receives (702) a first alert associated with an application that is not associated with the first user interface (e.g., an alert associated with a respective application, such as an incoming text message or e-mail, as described herein with reference to FIGS. 5AI-5AJ).

In response to receiving the first alert, while continuing to display the first user interface outside of the status region, the computer system expands (704) the status region into a portion of the display area that was previously occupied by the first user interface and displays, in the status region, a first user interface object indicative of the first alert, including: in accordance with a determination that the first alert is associated with a first application (e.g., the second software is the first application) (706), displaying, in the first user interface object, a representation of the first application associated with the first alert; and in accordance with a determination that the first alert is associated with a second application that is different from the first application (e.g., the second software is the second application) (708), displaying, in the first user interface object, a representation of the second application associated with the first alert. For example, as described herein with reference to FIGS. 5AI-5AJ, session region 502 is expanded from empty session region 502-1 (e.g., as shown in FIG. 5AM) into a portion of the display area of touchscreen 112 that was previously occupied by home screen 500, resulting in display of session region 502-15 including a messaging application icon, in response to receiving an alert associated with the messaging application (e.g., an incoming text message), or display of session region 502-16 including an e-mail application icon, in response to receiving an alert associated with the e-mail application (e.g., an incoming e-mail).

Using a status region to display information about alerts such as incoming notifications, including an indication of which application is associated with a current alert, causes the computer system to automatically provide a user with a quick view of time-sensitive information while making more efficient use of the display area by concurrently displaying other user interfaces for other functions of the computer system outside of the status region, thereby reducing the number of inputs and amount of time needed to perform a particular operation on the computer system.

In some embodiments, the computer system displays (710), in the first user interface object displayed in the status region, an indication of how many unread alerts associated with the application corresponding to the first alert have been received within a respective time period (e.g., how many alerts have been received since a most recent prior instance that a user interacted with the respective application and/or with alerts from the respective application). Examples of session regions that include a count of unread alerts are described herein with reference to session region 502-15 (indicating that one alert is unread in the scenario of FIG. 5AI), session region 502-17 (indicating that a second alert is also unread in the scenario of FIG. 5AK, following from the scenario of FIG. 5AI), and session region 502-18 (indicating that a new unread alert has been received in the scenario of FIG. 5AN, after the two alerts of FIG. 5AK were read as described with reference to FIG. 5AL). In some embodiments, in accordance with a determination that a first number of unread alerts associated with the application have been received within the respective time period, the computer system displays, in the first user interface object, the first number; and, in accordance with a determination that a second number of unread alerts associated with the application have been received within the respective time period, wherein the second number is different from the first number, the computer system displays, in the first user interface object, the second number. Using a status region to display information about alerts, including an indication of how many alerts remain unread for a particular application, causes the computer system to automatically provide a user with a quick view of time-sensitive information, thereby reducing the number of inputs and amount of time needed to perform a particular operation on the computer system.

In some embodiments, while displaying a second user interface in display area outside of the status region (e.g., the second user interface is the same as or different from the first user interface), the computer system receives (712) a second alert associated with an application that is not associated with the second user interface. In some embodiments, in response to receiving the second alert, while continuing to display the second user interface outside of the status region: in accordance with a determination that respective criteria (e.g., condensed alert display criteria) are met (e.g., a reduced notification mode of the computer system is enabled, a condensed alert display setting of the computer system is set, the second user interface is a particular type of user interface such as a full screen application user interface, or other criteria for condensing alerts), the computer system displays (e.g., in the status region) a second user interface object indicative of the second alert; and, in accordance with a determination that the respective criteria (e.g., condensed alert display criteria) are not met, the computer system displays (e.g., in display area outside of the status region) a third user interface object indicative of the second alert, wherein the third user interface object includes more information about the second alert than the second user interface object includes about the second alert. For example, as described herein with reference to FIGS. 5AG-5AJ, banner-style message notification 554 (FIG. 5AG) is displayed if device 100 is not in the reduced notification mode, whereas condensed session region 502-15 (FIG. 5AI) is displayed with less information than message notification 554 if device 100 is in the reduced notification mode; similarly, banner-style e-mail notification 556 (FIG. 5AH) is displayed if device 100 is not in the reduced notification mode, whereas condensed session region 502-16 (FIG. 5AJ) is displayed with less information than e-mail notification 556 if device 100 is in the reduced notification mode. Displaying a condensed alert in a status region, with less information than a conventional alert outside of the status region, causes the computer system to automatically provide a user with a summary of time-sensitive information that can be viewed quickly, while making more efficient use of the display area by using less display area for the status region, thereby reducing the number of inputs and amount of time needed to perform a particular operation on the computer system.

In some embodiments, the second user interface object includes (714) a name associated with the second alert (e.g., a sender of an email or text message, a meeting organizer, or other name) without including content of the second alert (e.g., message content of the email or text message, details of a meeting, or other content), and the third user interface object includes the name associated with the second alert and content of the second alert. For example, condensed session region 502-15 in FIG. 5AI optionally includes the name of the message sender without content of the message (e.g., as illustrated in related FIG. 5BJ, in which session region 502-23 includes a sender's name (e.g., for someone named “Kim”)), whereas banner-style message notification 554 in FIG. 5AG includes the sender's name (e.g., “Ursula”) and content of the message (e.g., the text “I will meet you there”). In another example, condensed session region 502-16 in FIG. 5AJ optionally includes the name of the e-mail sender without content of the message, whereas banner-style e-mail notification 556 in FIG. 5AH includes the sender's name (e.g., “ConnectedTo”) and content of the message (e.g., part of the e-mail subject, the text “Godfrey's invitation is waiting . . . ”, and part of the e-mail body, the text “Harold Godfrey invited you to join . . . ”). Displaying a condensed alert in a status region, with a name (e.g., of a sender or initiator of the alert) but not content of the alert, which may otherwise have been displayed if the alert were displayed outside of the status region, causes the computer system to automatically provide a user with a summary of time-sensitive information that can be viewed quickly, while making more efficient use of the display area by using less display area for the status region, thereby reducing the number of inputs and amount of time needed to perform a particular operation on the computer system.

In some embodiments, the second user interface object includes (716) a name of the application associated with the second alert (e.g., as a text label, in addition to a graphical representation of the application such as an application icon) without including content of the second alert (e.g., without including the content that was included in the third user interface object or without including any content from the second alert), and the third user interface object includes the name of the application associated with the second alert and content of the second alert. For example, condensed session region 502-15 in FIG. 5AI optionally includes the name of the messaging application (e.g., in addition to or instead of the messaging application icon) without content of the message, whereas banner-style message notification 554 in FIG. 5AG includes the name of the messaging application (e.g., “Message”) and content of the message (e.g., the text “I will meet you there”). In another example, condensed session region 502-16 in FIG. 5AJ optionally includes the name of the e-mail application (e.g., in addition to or instead of the e-mail application icon) without content of the message, whereas banner-style e-mail notification 556 in FIG. 5AH includes the name of the e-mail application (e.g., “Mail”) and content of the message (e.g., part of the e-mail subject, the text “Godfrey's invitation is waiting . . . ”, and part of the e-mail body, the text “Harold Godfrey invited you to join . . . ”). Displaying a condensed alert in a status region, with a name of the application associated with the alert but not content of the alert, which may otherwise have been displayed if the alert were displayed outside of the status region, causes the computer system to automatically provide a user with a summary of time-sensitive information that can be viewed quickly, while making more efficient use of the display area by using less display area for the status region, thereby reducing the number of inputs and amount of time needed to perform a particular operation on the computer system.

In some embodiments, the second user interface object includes (718) an indication of how many unread alerts associated with the application corresponding to the second alert have been received within a respective time period without including content of the unread alerts, and the third user interface object includes content of one or more of the unread alerts. For example, condensed session region 502-15 in FIG. 5AI includes the number of unread alerts for the messaging application (e.g., “1”) without content of the message, and condensed session region 502-17 in FIG. 5AK includes an increased number of unread alerts for the messaging application (e.g., “2”) without content of the message, whereas banner-style message notification 554 in FIG. 5AG includes content of the message (e.g., the text “I will meet you there”). In another example, condensed session region 502-16 in FIG. 5AJ includes the number of unread alerts for the e-mail application (e.g., “1”) without content of the message, whereas banner-style e-mail notification 556 in FIG. 5AH includes content of the message (e.g., part of the e-mail subject, the text “Godfrey's invitation is waiting . . . ”, and part of the e-mail body, the text “Harold Godfrey invited you to join . . . ”). In some embodiments, the third user interface object includes content of a plurality of, or each of, the unread alerts. Displaying a condensed alert in a status region, with an indication of how many alerts remain unread for a particular application but not content of the alert(s), which may otherwise have been displayed if the alert(s) were displayed outside of the status region, causes the computer system to automatically provide a user with a summary of time-sensitive information that can be viewed quickly, while making more efficient use of the display area by using less display area for the status region, thereby reducing the number of inputs and amount of time needed to perform a particular operation on the computer system.

In some embodiments, the computer system displays (720) the first user interface object indicative of the first alert in accordance with a determination that the first alert is received while a reduced notification mode of the computer system is enabled (e.g., a mode in which notifications are suppressed or presented in a visually deemphasized manner relative to when the reduced notification mode of the computer system is disabled) (e.g., as described herein with reference to the condensed notifications displayed in session region 502 of FIGS. 5AI-5AJ in contrast to the banner-style notifications 554 and 556 of FIGS. 5AG-5AH). In some embodiments, in the reduced notification mode (e.g., a “do-not-disturb” mode), the computer system at least partially blocks notifications, such as by displaying a subset of the notification's content and reducing or suppressing corresponding audio and/or haptic alerts, optionally in accordance with one or more adjustable settings for suppressing one or more notification types. In some embodiments, notifications that are not on a permissions list (e.g., a list of allowed senders or applications) are at least partially blocked, whereas notifications that are on the permissions list are not blocked or are blocked to a lesser degree. Displaying an alert in a status region if the computer system is in a reduced notification mode causes the computer system to automatically provide a user with a summary of time-sensitive information while visually deemphasizing the alert consistent with the reduced notification mode and making more efficient use of the display area by concurrently displaying other user interfaces for other functions of the computer system outside of the status region.

In some embodiments, while displaying a third user interface (e.g., a user interface for an application or a system user interface, optionally the same as or different from the first user interface) in display area outside of the status region (722), the computer system receives a third alert associated with an application that is not associated with the third user interface. In some embodiments, in response to receiving the third alert, while continuing to display the third user interface outside of the status region, in accordance with a determination that the third alert is received while the reduced notification mode of the computer system is enabled, the computer system displays a fourth user interface object indicative of the third alert. In some embodiments, the fourth user interface object is displayed in the status region, and optionally the status region is expanded into a portion of the display area that was previously occupied by the third user interface. In some embodiments, the fourth user interface object includes a representation of the application associated with the third alert.

In some embodiments, in response to receiving the third alert, while continuing to display the third user interface outside of the status region, in accordance with a determination that the third alert is received while the reduced notification mode of the computer system is disabled, the computer system displays a fifth user interface object indicative of the third alert, wherein the fifth user interface object is different from the fourth user interface object (e.g., different in appearance, size, shape, visual prominence, amount of information, type(s) of information, placement relative to the status region, and/or other manner of differentiating from alerts in the reduced notification mode). In some embodiments, the fifth user interface object is displayed in display area outside of the status region, optionally overlaid on a portion of the third user interface or in a portion of the display area that was previously occupied by the third user interface. In some embodiments, the fifth user interface object includes more information about the third alert than is included in the fourth user interface object.

For example, in response to receiving an alert associated with a messaging application (e.g., which is not associated with home screen 500), the notification in condensed session region 502-15 of FIG. 5AI is displayed if device 100 is in a reduced notification mode, whereas the banner-style notification 554 of FIG. 5AG is displayed if device 100 is not in the reduced notification mode. In another example, in response to receiving an alert associated with an e-mail application (e.g., which is not associated with home screen 500), the notification in condensed session region 502-16 of FIG. 5AJ is displayed if device 100 is in the reduced notification mode, whereas the banner-style notification 556 of FIG. 5AH is displayed if device 100 is not in the reduced notification mode. Displaying one version of an alert (e.g., a condensed alert in a status region) if the computer system is in a reduced (e.g., quiet) notification mode versus a different version of the alert (e.g., an expanded alert outside of the status region) if the computer system is not in the reduced notification mode causes the computer system to automatically provide a user with time-sensitive information in a manner that is appropriate for a current mode of the computer system.

In some embodiments, the computer system detects (724) an input (e.g., a tap input, a gaze input, a proximity input, a cursor input, a press input, or other input) directed to the status region (e.g., while displaying the first user interface object in the status region) and, in response to detecting the input, displays a sixth user interface object, wherein the sixth user interface object includes additional information about the first alert relative to the first user interface object (e.g., the sixth user interface object includes a greater amount of information and/or different information about the first alert than was included in the first user interface object). In some embodiments, the sixth user interface object is an expanded version of the first user interface object. In some embodiments, the sixth user interface object is different from the first user interface object. In some embodiments, the sixth user interface object is displayed in the status region. In some embodiments, the status region is expanded into an additional portion of the display area that was previously occupied by the first user interface to display the sixth user interface object in the status region. In some embodiments, the sixth user interface object is displayed in display area outside of the status region. For example, as described herein with reference to FIGS. 5AK-5AL, device 100 displays an expanded set (e.g., stack, list, or other type of expansion) of notifications 560 in response to detecting user input 558 directed to condensed session region 502-17. In another example, in response to detecting a user input (e.g., a tap input or other activation input) directed to condensed session region 502-15 in FIG. 5AI, device 100 would display banner-style notification 554 as illustrated in FIG. 5AG. Similarly, in response to detecting a user input (e.g., a tap input or other activation input) directed to condensed session region 502-16 in FIG. 5AJ, device 100 would display banner-style notification 556 as illustrated in FIG. 5AH. In response to an input directed to a status region in which a condensed version of an alert is or was displayed, displaying an expanded version of the alert with more alert information reduces the number of inputs needed to view additional detail about the alert.

In some embodiments, detecting the input directed to the status region includes (726) detecting a tap gesture at a location on the touch-sensitive surface that corresponds to the status region (e.g., a tap or press on the status region displayed via a touchscreen, a tap or press on a touch-sensitive surface while a cursor or other focus indicator corresponds to the status region, or the like) (e.g., as described herein with reference to user input 558 in FIG. 5AK). Displaying an expanded version of an alert in response to a tap input directed to a status region in which a condensed version of the alert is or was displayed simplifies and reduces the number of inputs needed to view additional detail about the alert.

In some embodiments, detecting the input directed to the status region includes (728) detecting that attention (e.g., gaze, cursor location, touch location, or other focus indicator) of a user is directed to the status region (e.g., the user is looking at or otherwise focusing on the status region, optionally for at least a threshold amount of time) (e.g., detecting user input 558 in FIG. 5AK optionally includes detecting that a user's attention is directed to status region 502-17, such as by detecting that the user is gazing at session region 502-17 and/or resting a cursor, touch, or other focus indicator on session region 502-17). Displaying an expanded version of an alert in response to a user directing their attention to a status region in which a condensed version of the alert is or was displayed simplifies and reduces the number of inputs needed to view additional detail about the alert.

In some embodiments, displaying the sixth user interface object includes (730): ceasing to display the first user interface object in the status region, and decreasing a size of the status region; and displaying the sixth user interface object in display area outside of the status region (e.g., over a portion of the user interface of the first software, displayed outside of the display area). For example, as described herein with reference to FIGS. 5AK-5AL, the expanded set (e.g., stack, list, or other type of expansion) of notifications 560 is displayed outside of session region 502, which reverts to empty session region 502-1. In response to an input directed to a status region in which a condensed version of an alert is or was displayed, displaying an expanded version of the alert with more alert information outside of the status region, and shrinking the status region accordingly, causes the computer system to automatically make more efficient use of the display area by using less display area for the alert.

In some embodiments, in accordance with a determination that the first user interface object displayed in the status region is associated with a plurality of alerts (e.g., a plurality of alerts has been received within a respective time period and are optionally indicated by the first user interface object) including the first alert and a fourth alert (732), the computer system concurrently displays in display area outside of the status region the sixth user interface object corresponding to the first alert and a seventh user interface object that includes information about the fourth alert (e.g., notification 560-1 and notification 560-2 of FIG. 5AL). In response to an input directed to a status region in which a condensed alert indication is or was displayed, expanding and displaying multiple alerts outside of the status region causes the computer system to automatically make more efficient use of the display area by using less display area to indicate the alerts until an interaction with the alerts is detected.

In some embodiments, in accordance with a determination that the first user interface object displayed in the status region is associated with a plurality of alerts (e.g., a plurality of alerts has been received within a respective time period and are optionally indicated by the first user interface object) including the first alert and one or more additional alerts (734), the computer system displays the sixth user interface object with an indication of the one or more additional alerts (e.g., a visual effect of the sixth user interface object being part of a stack of user interface objects, pagination indicators, arrows, or other indication of additional alerts). In some embodiments, the indication of the one or more additional alerts includes less information about the one or more additional alerts than the sixth user interface object includes about the first alert. For example, the sixth user interface object includes content of the first alert, whereas the indication of the one or more additional alerts does not include content of the one or more additional alerts (e.g., as described herein with reference to the expanded set of notifications 560 in FIG. 5AL, notification 560-1 includes content of the alert corresponding to notification 560-1, whereas notification 560-2 visually indicates without including content of the alert corresponding to notification 560-2).

In some embodiments, the computer system detects an input corresponding to the sixth user interface object (e.g., directed to the sixth user interface object and/or to the indication of the one or more additional alerts) and, in response to detecting the input corresponding to the sixth user interface object, displays a user interface object that includes information about (e.g., content of) a respective alert of the one or more additional alerts (optionally concurrently with continuing to display the sixth user interface object). In some embodiments, one or more additional user interface objects are also displayed with information about other respective alerts of the one or more additional alerts. In some embodiments, the sixth user interface object is initially displayed as the topmost object in a stack of user interface objects, and, in response to interaction with the stack of user interface objects, one or more user interface objects corresponding to the one or more additional alerts appear to fan out from the stack. In response to an input directed to a status region in which a condensed alert indication is or was displayed, displaying a stack of multiple alerts outside of the status region causes the computer system to automatically make more efficient use of the display area by using less display area to indicate the alerts until an interaction with the alerts is detected, and by requiring additional interaction to fully expand the stack of multiple alerts.

In some embodiments, in response to receiving the first alert, the computer system expands (736) the status region in a first direction (e.g., to the left, to the right, upward, downward, horizontally, or vertically) into the portion of the display area that was previously occupied by the first user interface (optionally without the status region expanding in a second direction that is different from the first direction) to display the first user interface object in the status region. In some embodiments, in response to receiving the input directed to the status region (e.g., while displaying the first user interface object in the status region), the computer system displays the sixth user interface object expanding in a second direction that is different from (e.g., perpendicular to) the first direction. For example, the status region expands horizontally to display the first user interface object, and vertically to display the sixth user interface object (e.g., if the sixth user interface object is displayed in the status region). In another example, the status region expands horizontally to display the first user interface object, and the sixth user interface object expands vertically over the first user interface (e.g., if the sixth user interface object is displayed outside of the status region).

For example, session region 502-15 of FIG. 5AI, session region 502-16 of FIG. 5AJ, and session region 502-17 of FIG. 5AK are expanded horizontally over display area previously occupied by home screen 500, relative to empty session region 502-1 as illustrated in FIG. 5AM. Notification 554 of FIG. 5AG, optionally displayed in response to a user input directed to session region 502-15 of FIG. 5AI, expands vertically (e.g., downward) from session region 502 (e.g., whether notification 554 is displayed outside of session region 502, or whether session region 502-15 is expanded vertically to include notification 554 or additional content thereof). Similarly, notification 556 of FIG. 5AH, optionally displayed in response to a user input directed to session region 502-16 of FIG. 5AJ, expands vertically (e.g., downward) from session region 502. Moreover, as described herein with reference to FIGS. 5AK-5AL, expanded set of notifications 560 of FIG. 5AL expands vertically (e.g., downward) from session region 502 in response to user input 558 directed to condensed session region 502-17 of FIG. 5AK. Displaying a condensed alert indication in a status region that extends in one direction across the display area, such as horizontally, while displaying one or more expanded alerts that extend in a different direction across the display area, such as vertically, causes the computer system to automatically make more efficient use of the display area by using less intrusive display area to indicate alerts and making expanded alerts more visually prominent.

In some embodiments, while displaying the first user interface in the display area outside of the status region, prior to receiving the first alert, the computer system displays (738) in the status region an eighth user interface object that includes status information about a function of the computer system that is not associated with the first alert (e.g., the function is different from the first application and from the second application), including updating status information in the eighth user interface object as a state of the function changes (e.g., updating one or more visual elements of the status information repeatedly over time based on changes in the function, such as incrementing or decrementing a timer over time, displaying a current instruction for ongoing navigation using a map application and updating the displayed instruction as the computer system moves, displaying information about media currently playing using a music application and updating the displayed information as different media is played, or other function of the computer system). For example, session region 502 of FIGS. 5AG-5AN is configured to be displayed as any other session region described herein. In some embodiments, the first user interface object indicative of the first alert replaces display of the eighth user interface object in the status region (e.g., session region 502-15 of FIG. 5AI or session region 502-16 of FIG. 5AJ optionally replaces display of session region 502-13, in a transition from FIG. 5AE, or session region 502-14, in a transition from FIG. 5AF, or any other session region described herein in response to an alert being received while the other session region is displayed). In some embodiments, the first user interface object indicative of the first alert is displayed concurrently with the eighth user interface object in the status region (e.g., in different portions of the status region). Displaying alert indications in a status region that is also used to display status information about other functions of the computer system allows different types of status information for the computer system, as appropriate for the current context, to be presented in a consistent region of the display area, thereby reducing the number of inputs and amount of time needed for viewing feedback about a state of the computer system.

In some embodiments, the one or more sensors are (740) positioned within one or more sensor regions that are encompassed by the status region (e.g., surrounded by display area) (e.g., as described herein with reference to FIG. 5A). In some embodiments, the display generation component is not capable of displaying content within the one or more sensor regions (e.g., one or more non-display regions that form cutouts from the display area). Although many examples are described herein with respect to a status region of the display area that includes one or more sensors (e.g., positioned within one or more interior boundaries of the display area that are encompassed by the boundary of the status region), the examples described herein are also applicable to a status region of the display area that does not have any sensors within it (e.g., as described herein with reference to FIG. 5B). Displaying alert indications in a status region that encompasses one or more display cutouts for one or more sensors causes the computer system to automatically reduce the visual intrusiveness of the display cutouts and make more efficient use of the display area.

It should be understood that the particular order in which the operations in FIGS. 7A-7D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 800, 900, and 1000) are also applicable in an analogous manner to method 700 described above with respect to FIGS. 7A-7D. For example, the session regions, status information, user interface objects, user interfaces, user inputs, device/system functions, alerts, notifications, applications, and/or modes described above with reference to method 700 optionally have one or more of the characteristics of the session regions, status information, user interface objects, user interfaces, user inputs, device/system functions, alerts, notifications, applications, and/or modes described herein with reference to other methods described herein (e.g., methods 700, 800, 900, and 1000). For brevity, these details are not repeated here.

FIGS. 8A-8C are flow diagrams illustrating method 800 of enabling a user to manually select content for display in a session region in accordance with some embodiments. Method 800 is performed at a computer system (e.g., portable multifunction device 100, FIG. 1A, or device 300, FIG. 3) that is in communication with a display generation component having a display area (e.g., touch screen 112, FIG. 1A, or display 340, FIG. 3), and optionally one or more sensors (e.g., speaker 111 and/or one or more optical sensors 164, FIG. 1A, or sensor(s) 359, FIG. 3). In some embodiments, one or more sensors of the computer system are positioned within one or more sensor regions that are encompassed by the status region, and the display generation component is not capable of displaying content within the one or more sensor regions. Some operations in method 800 are, optionally, combined and/or the order of some operations is, optionally, changed.

The computer system displays (802), in display area outside of a status region of the display area, a first user interface (e.g., of a first function of the computer system, such as a first application executing on the computer system or first system software of an operating system of the computer system). The status region has a first size, and the status region is a dynamic status region that has content that changes to reflect a current status of the computer system.

The computer system receives (804) one or more inputs corresponding to a request to associate the status region with first content, including receiving an input selecting the first content and receiving an input directed to the status region (optionally as discrete inputs or as respective portions of a same continuous input).

In response to receiving the one or more inputs corresponding to a request to associate the status region with the first content, the computer system displays (806) the status region with a second size that is different from (e.g., larger than, or smaller than) the first size, including displaying in the status region a representation of the first content.

For example, as described herein with reference to FIGS. 5AO-5AR, device 100 displays session region 502-1 with a first size while empty (FIG. 5AO), receives one or more inputs (e.g., user input 570 (FIG. 5AP-5AQ), optionally in combination (e.g., sequence) with user input 564 (FIG. 5AO)) corresponding to a request to associate session region 502 with image 568 (or more specifically with thumbnail 572 of image 568), and, in response, displays session region 502-19 with a different (e.g., larger) size while displaying thumbnail 572 in session region 502-19.

In another example, as described herein with reference to FIGS. 5BE-5BP, device 100 displays session region 502-1 with a first size while empty (FIG. 5BE), receives one or more inputs (e.g., user input 592 (FIG. 5BE) in combination with user input 594-1 (FIG. 5BG), in combination with user input 594-2 (FIG. 5BI), or in combination with user input 594-3 (FIG. 5BM) and optionally user input 598 (FIG. 5BO)) corresponding to a request to associate session region 502 with a respective session (e.g., selected from a plurality of suggested sessions), and, in response, displays session region 502 with a different (e.g., larger) size (e.g., as session region 502-22 (FIG. 5BH), session region 502-23 (FIG. 5BJ), or session region 502-26 (FIG. 5BP), respectively) while displaying the respective session in session region 502.

In some embodiments, the status region is configured to display content that includes visual elements that change (e.g., automatically) over time based on a current status of an ongoing function of the computer system (e.g., incrementing or decrementing a timer over time, displaying a current instruction for ongoing navigation using a map application and updating the displayed instruction as the computer system moves, displaying information about media currently playing using a music application and updating the displayed information as different media is played, or other function of the computer system). In some embodiments, in accordance with a determination that the status region includes a representation of second content that is different from the first content, the computer system ceases to display in the status region at least a portion of the representation of the second content (e.g., displaying a subset of, or ceasing to display, the representation of the second content) in conjunction with displaying the representation of the first content in the status region in response to receiving the one or more inputs corresponding to the request to associate the status region with the first content. In some embodiments, the representation of the first content displayed in the status region is updated as a state of the first content changes. In some embodiments, the one or more inputs corresponding to the request to associate the status region with the first content are received while the status region is displayed without content. In some embodiments, the one or more inputs corresponding to the request to associate the status region with the first content are received while the status region includes a representation of content that is different from the first content, and in response, the representation of the first content replaces a representation of the existing content in the status region or is displayed in the status region in addition to the representation (or a modified representation) of the existing content.

Enabling a user to select content to be added to a status region provides the user with quick access to desired content for later use, particularly if the status region continues to be displayed as other interactable user interfaces for other functions of the computer system are displayed outside of the status region, thereby reducing the number of inputs and amount of time needed to perform a particular operation on the computer system.

In some embodiments, the one or more inputs corresponding to a request to associate the status region with the first content include (808) an input to drag the first content from the first user interface to the status region (optionally as a discrete input or as a continuation of the input selecting the first content). In some embodiments, receiving the one or more inputs includes receiving an input (e.g., a continuous input) that selects the first content, drags the first content to the status region, and drops the first content in the status region. For example, as described herein with reference to FIGS. 5AO-5AR, thumbnail 572 of image 568 is added to session region 502 in response to user input 570 dragging image 568 to session region 502. Enabling a user to drag selected content to the status region reduces the number of inputs needed to add the content to the status region.

In some embodiments, the first content includes (810) (e.g., is) a document (e.g., thumbnail 572 optionally represents a document that is added to session region 502, such as from a file folder, e-mail, text message, or other document source location). For example, a user that is drafting a document is enabled to place the document in the status region for easy access later (e.g., after navigating one or more other user interfaces, such as to refer to other content to help with drafting the document). Enabling a user to add a document to the status region provides the user with quick access to the document for later use, such as for moving the document between different user interfaces or applications or for referencing other user interfaces to assist in composing the document, thereby reducing the number of inputs and amount of time needed to perform a particular operation on the computer system.

In some embodiments, the first content includes (812) (e.g., is) an e-mail (e.g., thumbnail 572 optionally represents an e-mail that is added to session region 502, such as from an e-mail inbox, outbox, drafts folder, or other e-mail source location). For example, a user that is composing an e-mail message is enabled to place the e-mail in the status region for easy access later (e.g., after navigating one or more other user interfaces, such as to refer to other content to help with composing the e-mail). Enabling a user to add an e-mail to the status region provides the user with quick access to the e-mail for later use, such as for moving the e-mail between different user interfaces or applications or for referencing other user interfaces to assist in composing the e-mail, thereby reducing the number of inputs and amount of time needed to perform a particular operation on the computer system.

In some embodiments, while displaying in the status region the representation of the first content: the computer system detects (814) one or more inputs corresponding to a request to replace display of the first user interface outside of the status region with display of a second user interface; and, in response to detecting the one or more inputs corresponding to the request to replace display of the first user interface outside of the status region with display of the second user interface, the computer system: ceases to display the first user interface; and displays, in display area outside of the status region, the second user interface. In some embodiments, the computer system detects an input to drag the representation of the first content from the status region to the second user interface; and, in response to detecting the input to drag the representation of the first content from the status region to the second user interface, the computer system displays the first content (or a second representation of the first content, such as a copy of the first content) in the second user interface (and optionally ceasing to display in the status region the representation of the first content).

For example, as described herein with reference to FIGS. 5AO-5BB, thumbnail 572 of image 568 is displayed, and continues to be displayed, in session region 502 during interaction with device 100 outside of session region 502 (e.g., via application switching from browser user interface 566 to e-mail user interface 576 in response to user input 574-1 (FIGS. 5AR-5AT) or from e-mail user interface 576 to messaging user interface 582 in response to user input 574-2 (FIGS. 5AU-5AW)), until thumbnail 572 is dragged out of session region 502 into messaging user interface 582 in response to user input(s) 590 (FIGS. 5AY-5BB). Enabling a user to select content to be placed in the status region provides the user with quick access to the content for later use, such as for moving the content between different user interfaces or applications, thereby reducing the number of inputs and amount of time needed to perform a particular operation on the computer system.

In some embodiments, displaying in the status region the representation of the first content includes (816) displaying status information about a function of the computer system that is updated as a state of the function changes (e.g., the status region is associated with an active session of the function in response to receiving the one or more inputs corresponding to the request to associate the status region with the first content). In some embodiments, the one or more inputs corresponding to the request to associate the status region with the first content (e.g., the selected active session) are received while the status region is not associated with the active session. For example, as described herein with reference to FIGS. 5BE-5BP, while session region 502 is associated with an active session of a function (e.g., the wallet pass session of session region 502-22 (FIGS. 5BG-5BH), the pinned conversation of session region 502-23 (FIGS. 5BI-5BL), or the timer session of session region 502-25 (FIGS. 5BM-5BP)), session region 502 is updated as a state of the function changes (e.g., device 100 is brought into proximity with a wireless terminal to initiate a payment (described herein with reference to FIG. 5BH), activity occurs in the pinned conversation (FIG. 5BK), or the timer counts down (described herein with reference to FIG. 5BP), respectively). Enabling a user to select an active session for a function of the computer system to be added to the status region, such that status information about the ongoing function is displayed and updated over time, provides the user with quick access to desired content, and displaying such status information in a status region that continues to be displayed as different user interfaces for other functions of the computer system are displayed outside of the status region makes more efficient use of the display area, thereby reducing the number of inputs and amount of time needed to perform a particular operation on the computer system.

In some embodiments, the first content is (818) associated with an application, and the one or more inputs corresponding to the request to associate the status region with the first content include an input dragging a representation of the application to the status region (e.g., the representation of the first content, displayed in the status region, includes the representation of the application, content of the application, and/or status information about the application that is optionally updated as a state of the application changes). For example, starting a timer session is in some embodiments performed by dragging icon 440 for a clock application to session region 502 (e.g., in the scenario of FIG. 5AO). In some embodiments, the input dragging the representation of the application to the status region includes a first portion that selects the application or representation thereof and a second portion that is directed to the status region once the representation of the application is dragged to the status region. Enabling a user to select an application to be added to the status region, whether to add an active session of the application to the status region or to move the application between user interfaces, provides the user with quick access to desired content, thereby reducing the number of inputs and amount of time needed to perform a particular operation on the computer system.

In some embodiments, the first content is (820) a video, and displaying in the status region the representation of the first content includes displaying in the status region a representation of the video (e.g., session region 502-28 (FIG. 5BZ) displays live feed 5134 of the field of view of one or more external cameras, which can be transitioned out of session region 502 (FIGS. 5BZ-5CA) as well as placed back into session region 502 (FIGS. 5CD-5CE)). Enabling a user to add a video or video feed to the status region provides the user with quick access to desired content while making more efficient use of the display area by enabling user interfaces for other functions of the computer system to be displayed and interacted with outside of the status region, thereby reducing the number of inputs and amount of time needed to perform a particular operation on the computer system.

In some embodiments, the representation of the video that is displayed in the status region is (822) displayed with a first size. In some embodiments, the computer system detects one or more inputs corresponding to a request to remove the video from the status region; and, in response to detecting the one or more inputs corresponding to the request to remove the video from the status region, the computer system displays a second representation of the video in display area outside of the status region, wherein the second representation of the video is displayed with a second size that is different from (e.g., larger than or smaller than) the first size. For example, live feed 5134 in session region 502-28 (FIG. 5BZ) is smaller than live camera feed 5122 in user interface 5120 (FIG. 5BY) and smaller than live feed 5134 in PiP window 5138 (FIG. 5CA). Displaying a smaller version of a video or video feed in the status region relative to when the video or video feed is displayed outside of the status region causes the computer system to automatically reduce the visual intrusiveness of the status region and make more efficient use of the display area by using less display area when using the status region to provide quick access to content.

In some embodiments, while displaying in the status region the representation of the video, the computer system displays (824) in the status region an indication of an audio output state of the video (e.g., an indication of whether audio associated with the video is being output or is muted). For example, as described herein with reference to FIG. 5BZ, session region 502-28 includes one or more controls for muting or unmuting audio input and/or output. Displaying a video or video feed in the status region with an indication of the status of corresponding audio provides feedback about a state of the computer system.

In some embodiments, the first content is (826) a communication thread (e.g., a series of messages that are part of a same conversation). In some embodiments, the computer system receives a communication associated with the communication thread and displays in the status region a representation of the received communication (e.g., an indication that a new communication has been received in the thread, an indication of the sender of the communication, at least some of the content of the communication, and/or other representation). For example, as described herein with reference to FIGS. 5BI-5BL, while a messaging conversation is pinned to session region 502, session region 502 expands to provide alerts (e.g., in session region 502-24 of FIG. 5BK) about conversation activity such as new messages received in the pinned conversation. In some embodiments, as one or more new communications that are part of the thread are received, the status region is updated with one or more additional representations of the one or more new communications. Enabling the status region to display status updates associated with a selected communication thread, including alerts of new communications, causes the computer system to automatically provide a user with time-sensitive information that the user has indicated is of interest, thereby reducing the number of inputs and amount of time needed to perform a particular operation on the computer system.

In some embodiments, the computer system receives (828) a respective input directed to the status region. In some embodiments, in response to receiving the respective input directed to the status region, in accordance with a determination that the status region is not associated with an active session (e.g., involving performing a respective function concurrently on the computer system with another function whose user interface is displayed outside of the status region, where the respective function optionally continues to change state, and where the status region is used to indicate, in a persistent and consistently located display region, a current state of the respective function during the active session), the computer system displays one or more representations of active sessions that can be associated with the status region (e.g., suggestions for active sessions to add to the status region). For example, as described herein with reference to FIGS. 5BE-5BF, in response to detecting user input 592 directed to session region 502 and in accordance with a determination that session region 502 is an empty session region, device 100 displays session region 502-21 with suggestions of sessions to add to session region 502. In some embodiments, in response to receiving the respective input directed to the status region, in accordance with a determination that the status region is associated with (e.g., includes content of) an active session, the computer system performs an operation associated with the active session (e.g., displaying additional content of the active session or displaying a user interface of an application that the active session represents). In some embodiments, in response to receiving one or more inputs corresponding to a first representation of the one or more representations, wherein the first representation corresponds to a first active session, the computer system displays content of the first active session in the status region, and optionally maintains display of, or alternatively ceases to display, one or more representations of other active sessions that can be added to the status region. In response to user interaction with an “empty” status region that is not currently displaying content, displaying one or more selectable options for content and/or active sessions that can be added to the status region reduces the number of inputs needed to make use of the status region to gain quick access to desired content.

In some embodiments, while displaying in the status region the representation of the first content (e.g., and displaying the status region with the second size): the computer system detects (830) one or more inputs corresponding to a request to replace display of the first user interface outside of the status region with display of a third user interface; and, in response to detecting the one or more inputs corresponding to a request to replace display of the first user interface outside of the status region with display of the third user interface, while continuing to display the representation of the first content in the status region, the computer system ceases to display the first user interface and displays, in display area outside of the status region, the third user interface. For example, as described herein with reference to FIGS. 5AS-5AY, thumbnail 572 is maintained in session region 502 (e.g., as represented by the icon “P1”) during navigation between and interaction with other user interfaces outside of session region 502 (e.g., during navigation from browser user interface 566 to e-mail user interface 576 to messaging user interface 582 and during interaction with those user interfaces). Continuing to display user-selected content in the status region while enabling the user to navigate between other user interfaces outside of the status region causes the computer system to automatically provide the user with quick access to desired information while making more efficient use of the display area, thereby reducing the number of inputs and amount of time needed to perform a particular operation on the computer system.

In some embodiments, while displaying the first user interface in the display area outside of the status region, the computer system displays (832) in the status region a user interface object that includes status information about a function of the computer system that is not associated with the first content, including updating the status information in the user interface object as a state of the function changes. In some embodiments, the user interface object that includes the status information is displayed prior to receiving the one or more inputs corresponding to a request to associate the status region with the first content, and in response, the first content is displayed in the status region instead of or in addition to the user interface object that includes the status information. In some embodiments, while or after displaying the representation of the first content in the status region, the computer system receives one or more inputs corresponding to a request to associate the status region with an active session of the function, and the user interface object that includes the status information is displayed in the status region in response. For example, session region 502 of FIGS. 5AO-5BP is configured to be displayed as any other session region described herein that includes content of applications and/or elements of functions of device 100. Enabling the status region to display content for different applications allows different types of status information for the computer system to be presented in a consistent region of the display area, thereby reducing the number of inputs and amount of time needed to perform a particular operation on the computer system.

In some embodiments, the one or more sensors are (834) positioned within one or more sensor regions that are encompassed by the status region (e.g., surrounded by display area) (e.g., as described herein with reference to FIG. 5A). Displaying content in a status region that encompasses one or more display cutouts for one or more sensors causes the computer system to automatically reduce the visual intrusiveness of the display cutouts and make more efficient use of the display area.

It should be understood that the particular order in which the operations in FIGS. 8A-8C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 700, 900, and 1000) are also applicable in an analogous manner to method 800 described above with respect to FIGS. 8A-8C. For example, the session regions, status information, user interface objects, user interfaces, user inputs, gestures, device/system functions, alerts, applications and/or modes described above with reference to method 800 optionally have one or more of the characteristics of the session regions, status information, user interface objects, user interfaces, user inputs, device/system functions, alerts, applications and/or modes described herein with reference to other methods described herein (e.g., methods 600, 700, 900, and 1000). For brevity, these details are not repeated here.

FIGS. 9A-9C are flow diagrams illustrating method 900 of displaying camera information in a session region in accordance with some embodiments. Method 900 is performed at a computer system (e.g., portable multifunction device 100, FIG. 1A, or device 300, FIG. 3) that is in communication with one or more cameras (e.g., optical sensors 164, FIG. 1A, sensor(s) 359, FIG. 3, or one or more cameras in communication via RF circuitry 108, FIG. 1A or via network communications interface 360, FIG. 3) and with a display generation component having a display area (e.g., touch screen 112, FIG. 1A, or display 340, FIG. 3), and optionally one or more sensors (e.g., speaker 111 and/or one or more optical sensors 164, FIG. 1A, or sensor(s) 359, FIG. 3). In some embodiments, one or more sensors of the computer system are positioned within one or more sensor regions that are encompassed by the status region, and the display generation component is not capable of displaying content within the one or more sensor regions. Some operations in method 900 are, optionally, combined and/or the order of some operations is, optionally, changed.

The computer system displays (902), in display area outside of a status region of the display area, a user interface associated with a first function of the computer system (e.g., a first application executing on the computer system or first system software of an operating system of the computer system).

The computer system displays (904), in the status region, status information about (e.g., provided by) a second function of the computer system (e.g., a second application executing on the computer system or second system software of the operating system of the computer system). The status region is associated with an active session of the second function (e.g., the status information about the second function is updated over time as a state of the second function changes), and the second function is different from the first function. For example, as described herein with reference to FIG. 5BQ, home screen 500 is displayed in display area outside of session region 502, which optionally includes a timer session as shown in FIG. 5BP. In another example, as described herein with reference to FIG. 5BU, home screen 500 is displayed in display area outside of session region 502-27, which includes a preview of ongoing video capture.

The computer system detects (906) one or more inputs corresponding to a request to perform an operation associated with a camera function of the computer system (e.g., the first application or a third application executing on the computer system, or the first system software or third system software of the operating system of the computer system). For example, as described herein with reference to FIGS. 5BQ-5BU, user input 5100 (FIG. 5BQ), user input 5108 (FIG. 5BS), and user input 5110 (FIG. 5BT) prompt device 100 to display camera user interface 5102, initiate video capture, and navigate from camera user interface 5102 to home screen 500, respectively. In another example, as described herein with reference to FIGS. 5BU-5BZ, user input 5112 (FIG. 5BU), user input 5118 (FIG. 5BV), and user input 5130 (FIG. 5BY) prompt device 100 to display home automation user interface 5114, display user interface 5120 with an expanded live camera feed 5122, and navigate from user interface 5120 to music user interface 5132, respectively.

In response to detecting the one or more inputs corresponding to the request to perform the operation associated with the camera function, the computer system displays (908) in the status region status information about the camera function, including displaying a representation of a field of view of the one or more cameras that is updated over time in accordance with changes in the field of view of the one or more cameras (e.g., a live camera feed or previously captured video, associated with the camera function, that is updated in accordance with objects moving within the field of view and/or movement of the field of view). For example, as described herein with reference to FIGS. 5BQ-5BU, in response to the one or more inputs including user input 5110 (FIG. 5BT) (optionally in sequence with user input 5100 (FIG. 5BQ) and user input 5108 (FIG. 5BS)), device 100 displays session region 502-27 including a preview of ongoing video capture (FIG. 5BU). In another example, as described herein with reference to FIGS. 5BU-5BZ, in response to the one or more inputs including user input 5130 (FIG. 5BY) (optionally in sequence with user input 5112 (FIG. 5BU) and user input 5118 (FIG. 5BV)), device 100 displays session region 502-28 including live feed 5134 of the field of view of one or more cameras.

In some embodiments, displaying status information about the camera function in the status region associates the status region with an active session of the camera function (e.g., the camera function remains active, and the status information displayed about the camera function in the status region is updated to reflect a current state of the camera function). In some embodiments, the status information about the camera function, including the representation of the field of view of the one or more cameras, is displayed in the status region while displaying, in display area outside of the status region, a user interface associated with a function of the computer system that is different from the camera function (e.g., the user interface associated with the first function, a user interface associated with the second function, or other user interface associated with yet another function of the computer system).

Displaying a camera feed in a status region for providing status information about one or more functions of the computer system provides a user with quick access to desired content while making more efficient use of the display area by concurrently enabling user interfaces for other functions of the computer system to be displayed and interacted with outside of the status region, thereby reducing the number of inputs and amount of time needed to perform a particular operation on the computer system.

In some embodiments, the computer system includes (910) the one or more cameras (e.g., the one or more cameras are integrated cameras of the computer system) (e.g., as described herein with reference to FIG. 5BQ, the one or more cameras whose feed is displayed in session region 502-27 in FIG. 5BU are optionally integrated cameras of device 100). In some embodiments, the one or more cameras optionally include two or more cameras pointing in one direction and/or two or more cameras pointing in different (e.g., opposite directions). In some embodiments, a user is enabled to select which of the two or more cameras is represented in the status region. For example, if a representation of a field of view of a first camera is displayed in the status region, a user is enabled to provide one or more inputs to switch to displaying a representation of a field of view of a different, second camera in the status region, in addition to or instead of the representation of the field of view of the first camera. In some embodiments, the computer system automatically switches which camera is represented in the status region (e.g., cycling through multiple camera feeds periodically on a respective time interval and/or displaying a representation of a field of view of a camera in response to detecting a change, such as movement, within that camera's field of view). Displaying a camera feed for one or more cameras of the computer system, such as one or more integrated cameras, in the status region provides a user with quick access to the camera(s) while making more efficient use of the display area by enabling user interfaces for other functions of the computer system to be displayed and interacted with outside of the status region concurrently with displaying the camera feed in the status region, thereby reducing the number of inputs and amount of time needed to perform a particular operation on the computer system.

In some embodiments, the computer system captures (912) video using the one or more cameras, wherein the displayed representation of the field of view of the one or more cameras that is updated over time in accordance with changes in the field of view of the one or more cameras represents ongoing video capture (e.g., as described herein with reference to session region 502-27 of FIGS. 5BU-5BX). Displaying, in the status region, a feed of ongoing video capture enables a user to continue monitoring the video capture using the status region while enabling the user to interact with other functions of the computer system using user interfaces displayed outside of the status region, thereby reducing the number of inputs and amount of time needed to perform a particular operation on the computer system.

In some embodiments, in response to detecting the one or more inputs corresponding to the request to perform an operation associated with the camera function, wherein performing the operation associated with the camera function includes capturing video using the one or more cameras, the computer system displays (914) in the status region a user interface element that is activatable to control the capturing of video using the one or more cameras (e.g., as described herein with reference to capture button 5104-2 in session region 502-27 of FIG. 5BU-5BX). In some embodiments, the computer system detects an input directed to the user interface element and, in response to detecting the input directed to the user interface element, stops the capturing of video using the one or more cameras. For example, as described herein with reference to FIGS. 5BX-5BY, device 100 stops the ongoing video capture in response to detecting user input 5128 directed to capture button 5104-2 in session region 502-27. In some embodiments, in accordance with a determination that the input directed to the user interface element is detected while capturing video using the one or more cameras, the capturing of video using the one or more cameras is stopped in response to detecting the input directed to the user interface element. In some embodiments, in accordance with a determination that the input directed to the user interface element is detected while not capturing video using the one or more cameras, capturing video using the one or more cameras is performed (e.g., initiated) in response to detecting the input directed to the user interface element. Displaying, in the status region, an activatable control to stop (or start) video capture enables a user to control video capture using the status region while also being able to interact with other functions of the computer system using user interfaces displayed outside of the status region, thereby reducing the number of inputs and amount of time needed to perform a particular operation on the computer system.

In some embodiments, the one or more cameras are (916) included in a second computer system that is separate from and in communication with the computer system (e.g., the one or more cameras are remote cameras) (e.g., as described herein with reference to FIG. 5BV, the one or more cameras whose feed is displayed in session region 502-28 in FIG. 5BZ are optionally cameras that are external to and in communication with device 100). For example, the computer system is a personal electronic device such as a phone, watch, tablet, computer, or other device, that is used to remotely access a feed from a camera of the second computer system, such as a security camera for a user's home, workplace, or other location, that is physically separate from the personal electronic device. Displaying, in the status region, a camera feed for one or more cameras that are separate from the computer system, such as one or more remote cameras, provides a user with quick access to the camera(s) while making more efficient use of the display area by enabling user interfaces for other functions of the computer system to be displayed and interacted with outside of the status region concurrently with displaying the camera feed in the status region, as well as provides improved security/privacy by enabling a user to monitor activity at the location of the remote system.

In some embodiments, in response to detecting the one or more inputs corresponding to the request to perform an operation associated with the camera function, wherein the operation is a first operation associated with the camera function, the computer system displays (918) in the status region a control. In some embodiments, the computer system detects an input activating the control and, in response to detecting the input activating the control, performs a second operation associated with the camera function (e.g., the second operation is performed at the second computer system, remotely, via an input to the first computer system), wherein the second operation is different from the first operation. In some embodiments, a plurality of controls is displayed in the status region, each control being activatable to perform a different operation associated with the camera function. For example, as described herein with reference to FIG. 5BZ, session region 502-28 for the live external camera feed includes a control that is activatable to enable or disable audio input and/or output via the one or more external cameras, a control that is activatable to control a physical lock mechanism, and/or a control that is activatable to control associated lighting. Displaying, in the status region, an activatable control to perform an operation associated with a camera function of a remote system enables a user to interact with the remote system using the status region while also being able to interact with other functions of the computer system using user interfaces displayed outside of the status region, thereby reducing the number of inputs and amount of time needed to perform a particular operation on either the computer system or the remote system.

In some embodiments, performing the second operation associated with the camera function includes (920) enabling audio input received via a microphone of the computer system to be output via an audio output device (e.g., a speaker or other audio output device) associated with the one or more cameras (e.g., an audio output device of the second computer system). For example, as described herein with reference to FIG. 5BZ, session region 502-28 for the live external camera feed includes a control that is activatable to enable or disable audio input and/or output via the one or more external cameras. Displaying, in the status region, an activatable control for talking through a speaker of a remote system (and/or listening through a microphone of the remote system) enables a user to interact with the remote system using the status region while also being able to interact with other functions of the computer system using user interfaces displayed outside of the status region, as well as provides improved security/privacy by enabling a user to appear present at the location of the remote system.

In some embodiments, performing the second operation associated with the camera function includes (922) changing a lock state of a physical lock mechanism associated with the one or more cameras (e.g., from a locked state to an unlocked state or from an unlocked state to a locked state). For example, as described herein with reference to FIG. 5BZ, session region 502-28 for the live external camera feed includes a control that is activatable to control a physical lock mechanism. In some embodiments, in accordance with a determination that the input activating the control is detected while the physical lock mechanism associated with the one or more cameras (e.g., a lock that is separate from the computer system and optionally associated with or part of the second computer system, such as a deadbolt or other physical door lock) is in a first state (e.g., a locked state), the computer system transitions the lock to a second state (e.g., a state other than the locked state, such as an unlocked state). In some embodiments, in accordance with a determination that the input activating the control is detected while the lock is in the second state, the computer system transitions the lock to the first state (e.g., the control is activatable to toggle whether the lock is locked or unlocked). Displaying, in the status region, an activatable control for controlling a physical lock mechanism of a remote system enables a user to interact with the remote system using the status region while also being able to interact with other functions of the computer system using user interfaces displayed outside of the status region, as well as provides improved security/privacy by enabling a user to remotely control physical security at the location of the remote system.

In some embodiments, performing the second operation associated with the camera function includes (924) changing an illumination state of a light associated with the one or more cameras (e.g., from an on state to an off state, from an off state to an on state, from a first brightness state to a second brightness state that is different from the first brightness state, and/or from a first color to a second color that is different from the first color). For example, as described herein with reference to FIG. 5BZ, session region 502-28 for the live external camera feed includes a control that is activatable to control associated lighting. In some embodiments, in accordance with a determination that the input activating the control is detected while a light associated with the one or more cameras (e.g., a light that is separate from the computer system and optionally associated with or part of the second computer system) is in a first state (e.g., an off state, a first brightness state, and/or a first color), the computer system transitions the light to a second state (e.g., an on state, a second brightness state that is different from the first brightness state, and/or a second color that is different from the first color). In some embodiments, in accordance with a determination that the input activating the control is detected while the light is in the second state, the computer system transitions the light to the first state (e.g., the control is activatable to toggle whether the light is on or off). Displaying, in the status region, an activatable control for controlling a light of a remote system enables a user to interact with the remote system using the status region while also being able to interact with other functions of the computer system using user interfaces displayed outside of the status region, as well as provides improved security/privacy by enabling a user to remotely control the amount of light at the location of the remote system.

In some embodiments, in response to detecting the one or more inputs corresponding to the request to perform an operation associated with the camera function, wherein the operation is a third operation associated with the camera function (optionally, the third operation is the same as the first operation), the computer system displays (926) in the status region one or more controls. In some embodiments, the computer system detects an input activating a respective control of the one or more controls and, in response to detecting the input activating the respective control, performs a fourth operation associated with the camera function, wherein the fourth operation is different from the third operation (e.g., the fourth operation includes any of the operations described herein with reference to the camera function of the computer system, such as starting or stopping media capture via the one or more cameras, enabling, disabling, or changing a volume of audio captured by or output via an audio output device associated with the one or more cameras, changing a state of a physical lock mechanism or light associated with the one or more cameras, or other operation). In some embodiments, each control of the one or more controls is activatable to perform a different operation associated with the camera function. For example, as described herein with reference to FIG. 5BU, capture button 5104-2 in session region 502-27 is activatable to stop or start video capture via the one or more cameras of device 100. In another example, as described herein with reference to FIG. 5BZ, session region 502-28 for the live external camera feed includes a control that is activatable to enable or disable audio input and/or output via the one or more external cameras. Displaying, in the status region, one or more activatable controls to perform a camera operation enables a user to control the camera function using the status region while also being able to interact with other functions of the computer system using user interfaces displayed outside of the status region, thereby reducing the number of inputs and amount of time needed to perform a particular operation on the computer system.

In some embodiments, while displaying, in display area outside of the status region, a respective user interface associated with a respective function (e.g., the first function, the second function, or other function) of the computer system that is different from the camera function (928), the computer system detects an input directed to the status region (e.g., to a portion of the status region, such as a background, where an activatable control is not displayed). In some embodiments, in response to detecting the input directed to the status region (e.g., in accordance with a determination that the input is a particular type of input and/or the input is directed to a particular portion of the status region where an activatable control is not displayed): the computer system ceases to display, in the status region, the status information about the camera function (and in some embodiments ceasing to display one or more activatable controls for performing operation(s) associated with the camera function), including ceasing to display the representation of the field of view of the one or more cameras that is updated over time in accordance with changes in the field of view of the one or more cameras; and the computer system displays, in display area outside of the status region that was previously occupied by the respective user interface associated with the respective function, the representation of the field of view of the one or more cameras that is updated over time in accordance with changes in the field of view of the one or more cameras. For example, as described herein with reference to FIGS. 5BZ-5CA, device 100 ceases to display live feed 5134 in session region 502-28 and instead displays live feed 5134 in PiP window 5138 over music user interface 5132 outside of session region 502. In some embodiments, other aspects of the status information and/or one or more activatable controls are displayed in display area outside of the status region that was previously occupied by the respective user interface associated with the respective function, in addition to or instead of the representation of the field of view of the one or more cameras. Enabling a user to transition a camera feed displayed in the status region to being displayed outside of the status region reduces the number of inputs needed to reposition the camera feed outside of the status region (optionally to one or more user-selected locations).

In some embodiments, the one or more sensors are (930) positioned within one or more sensor regions that are encompassed by the status region (e.g., surrounded by display area) (e.g., as described herein with reference to FIG. 5A). Displaying camera information and/or controls in a status region that encompasses one or more display cutouts for one or more sensors causes the computer system to automatically reduce the visual intrusiveness of the display cutouts and make more efficient use of the display area.

It should be understood that the particular order in which the operations in FIGS. 9A-9C have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 700, 800, and 1000) are also applicable in an analogous manner to method 900 described above with respect to FIGS. 9A-9C. For example, the session regions, status information, user interface objects, user interfaces, user inputs, gestures, device/system functions, and applications described above with reference to method 900 optionally have one or more of the characteristics of the session regions, status information, user interface objects, user interfaces, user inputs, gestures, device/system functions, and applications described herein with reference to other methods described herein (e.g., methods 600, 700, 800, and 1000). For brevity, these details are not repeated here.

FIGS. 10A-10D are flow diagrams illustrating method 1000 of displaying user interfaces in a session region in response to inputs via corresponding hardware elements in accordance with some embodiments. Method 1000 is performed at a computer system (e.g., portable multifunction device 100, FIG. 1A, or device 300, FIG. 3) that is in communication with a plurality of hardware elements (e.g., buttons, toggle switches, solid-state touch- and/or intensity-sensitive elements (optionally other than a primary touch screen and/or touchpad for providing touch inputs), or the like) (e.g., other input or control devices 116, FIG. 1A, sensor(s) 359, FIG. 3), with a display generation component (e.g., distinct from the plurality of hardware elements) having a display area (e.g., touch screen 112, FIG. 1A, or display 340, FIG. 3), optionally with a touch-sensitive surface (e.g., touch screen 112, FIG. 1A, or touchpad 355, FIG. 3), and optionally with one or more sensors (e.g., speaker 111 and/or one or more optical sensors 164, FIG. 1A, or sensor(s) 359, FIG. 3). In some embodiments, one or more sensors of the computer system are positioned within one or more sensor regions that are encompassed by the status region, and the display generation component is not capable of displaying content within the one or more sensor regions. Some operations in method 1000 are, optionally, combined and/or the order of some operations is, optionally, changed.

While displaying, in display area outside of a status region of the display area, a first user interface (e.g., a user interface of an application executing on the computer system or of an operating system of the computer system), the computer system receives (1002) an input via a first hardware element of the plurality of hardware elements.

In response to receiving the input via the first hardware element, the computer system displays (1004), in the status region, a first user interface object associated with the first hardware element (e.g., while continuing to display the first user interface outside of the status region).

While continuing to display, in the display area outside of the status region, the first user interface, the computer system receives (1006) an input via a second hardware element of the plurality of hardware elements. The second hardware element is different from the first hardware element.

In response to receiving the input via the second hardware element, the computer system displays (1008), in the status region, a second user interface object associated with the second hardware element (e.g., while continuing to display the first user interface outside of the status region). The second user interface object is different from the first user interface object.

For example, as described herein with reference to FIGS. 5CG-5DD, while displaying music user interface 5132 or home screen 500 outside of session region 502, device 100 displays volume level session region 502-30 (FIGS. 5CH and 5CJ) in response to a respective user input 5150 directed to volume button 208 (FIGS. 5CG and 5CI), volume level session region 502-32 (FIG. 5CN) in response to user input 5164 directed to volume button 208 (FIG. 5CM), audio output mode session region 502-33 (FIG. 5CP) or 502-34 (FIG. 5CT) in response to a respective user input 5168 directed to switch 214 (FIGS. 5CO and 5CS), virtual assistant session region 502-35 (FIG. 5CV) in response to user input 5176 directed to side button 206 (FIG. 5CU), wallet pass session region 502-36 (FIG. 5CZ) in response to user input 5182 directed to side button 206 (FIG. 5CY), screenshot session region 502-37 (FIG. 5DB) in response to user input 5184 directed to side button 206 and volume button 208 (FIG. 5DA), or power down session region 502-38 (along with system user interface 5190 outside of session region 502-38, FIG. 5DD) in response to user input 5186 directed to side button 206 and volume button 208 (FIG. 5DC).

In some embodiments, in displaying a respective user interface object in the status region, the status region is expanded to accommodate the respective user interface object (e.g., covering a corresponding portion of the first user interface displayed outside of the status region). In some embodiments, if the input via the second hardware element is detected while the first user interface object associated with the first hardware element is displayed in the status region, the second user interface object associated with the second hardware element is displayed instead of, or alternatively in addition to, the first user interface object. In some embodiments, while displaying the first user interface in display area outside of the status region, the computer system receives an input; in response to receiving the input: in accordance with a determination that the input is received via the first hardware element, the computer system displays, in the status region, the first user interface object associated with the first hardware element; and, in accordance with a determination that the input is received via the second hardware element, the computer system displays, in the status region, the second user interface object associated with the second hardware element.

In response to detecting an input via a hardware element, displaying different user interface objects in a status region based on which hardware element was used to provide the input enables a user to invoke different functions of the computer system without displaying additional controls, and makes more efficient use of the display area by allowing user interfaces for other functions of the computer system to be displayed outside of the status region.

In some embodiments, while displaying the first user interface object in the status region, the computer system detects (1010), via the touch-sensitive surface, one or more touch inputs directed to the first user interface object. In some embodiments, in response to detecting the one or more touch inputs directed to the first user interface object, the computer system performs a first operation on the computer system (e.g., issuing a command to a virtual assistant, selecting or authorizing use of a stored secure credential, changing a ringer volume or system volume, toggling a silent mode on or off, or other operation). In some embodiments, while displaying the second user interface object in the status region, the computer system detects, via the touch-sensitive surface, one or more touch inputs directed to the second user interface object. In some embodiments, in response to detecting the one or more touch inputs directed to the second user interface object, the computer system performs a second operation on the computer system that is different from the first operation (e.g., issuing a command to a virtual assistant, selecting or authorizing use of a stored secure credential, changing a ringer volume or system volume, toggling a silent mode on or off, or other operation). For example, as described herein with reference to FIGS. 5CK-5CL, where user input 5162 is a touch input via touchscreen 112, volume session region 502-30 is responsive to the touch input to change the output volume level in a similar manner to providing a respective user input 5150 or user input 5164, such as a press input, via volume button 208. In another example, as described herein with reference to FIGS. 5CU-5CV, an on-screen keyboard is optionally displayed in conjunction with invoking the virtual assistant in response to user input 5176, enabling a user to provide touch inputs via touchscreen 112 to type commands to the virtual assistant. In yet another example, as described herein with reference to FIG. 5DD, power down slider 5188 in session region 502-38 is responsive to a touch input, such as a drag input, via touchscreen 112 to turn off device 100. In some embodiments, the computer system detects, via the touch-sensitive surface, one or more touch inputs directed to the status region; in response to detecting the one or more touch inputs: in accordance with a determination that the one or more touch inputs are detected while displaying the first user interface object in the status region, the computer system performs the first operation; and, in accordance with a determination that the one or more touch inputs are detected while displaying the second user interface object in the status region, the computer system performs the second operation. Performing an operation in conjunction with displaying a user interface object in the status region in response to detecting an input via a hardware element, and configuring the displayed user interface object to be responsive to touch inputs to perform additional operations, reduces the number of inputs and amount of time needed to perform operations on the computer system.

In some embodiments, in response to receiving the input via the first hardware element, the computer system performs (1012) an operation of a same type as the first operation; and, in response to receiving the input via the second hardware element, the computer system performs an operation of a same type as the second operation. In some embodiments, in response to receiving an input via a respective hardware element, the computer system displays in the status region a user interface object associated with the respective hardware element and performs a respective operation; then, in response to receiving one or more touch inputs directed to the displayed user interface object, the computer system performs another operation of a same type as the respective operation.

For example, the hardware element is a button that changes an output volume (e.g., of audio and/or tactile outputs) of the computer system (e.g., a single button with two actuatable portions, or two separate buttons, or other type of hardware element for increasing/decreasing output volume), and the user interface object displayed in response to pressing the button optionally indicates the current output volume of the computer system (e.g., in response to pressing the button) and includes one or more user interface elements that are activatable to further change (e.g., increase or decrease) the current output volume of the computer system (e.g., a volume slider control, volume up and/or volume down affordances, or the like). For example, as described herein with reference to FIGS. 5CG-5CL, user input 5162 via touchscreen 112 performs the same type of operation, increasing output volume level, as user input 5150 via volume up button 208-1 (e.g., and the same type of operation as would be performed in response to additional user input via volume up button 208-1).

In another example, the hardware element is a switch that toggles whether the computer system is in a silent mode in which audio and/or tactile outputs are reduced or silenced, and the user interface object displayed in response to toggling the switch optionally indicates the current mode (e.g., whether the toggling of the switch has turned silent mode on or off) and includes one or more user interface elements that are activatable to toggle whether the computer system is in the silent mode (e.g., if the toggling of the switch has turned silent mode on, a user interface element is displayed that is activatable to turn silent mode back off (and optionally then again activatable to turn silent mode back on again, and so forth), and if the toggling of the switch has turned silent mode off, the user interface element is activatable to turn silent mode back on (and optionally then activatable to turn silent mode back off again, and so forth)). In some embodiments, as described herein with reference to FIGS. 5CQ-5CR, the user interface object displayed in response to toggling the switch associated with the silent mode is not itself activatable to transition the computer system into or out of the silent mode (e.g., the user interface state is not independent of the physical state of the switch hardware element).

For a user interface object that is displayed in the status region in response to detecting an input via a hardware element and in conjunction with performing an associated type of operation, configuring the user interface object to be responsive to touch inputs to perform additional operations of the same type reduces the number of inputs and amount of time needed to perform operations on the computer system.

In some embodiments, while displaying a user interface object in a session region in response to an input via a respective hardware element, the operation performed in response to a touch input directed to the user interface object displayed in the session region is a different type of operation than would be performed in response to receiving additional or continued input via the respective hardware element. For example, with respect to FIG. 5DD, in response to detecting user input 5198-1 as a touch input directed to the power down slider 5188 in session region 502-38, device 100 would power down, whereas, in response to continued detection of user input 5186 via volume button(s) 208 and side button 206, device 100 would initiate an emergency call (e.g., as would be performed in response to user input 5198-3 directed to emergency call slider 5194).

In some embodiments, the computer system receives (1014) an input via a third hardware element of the plurality of hardware elements. In some embodiments, the third hardware element is the same as the first hardware element or the second hardware element, or the third hardware element is different from the first hardware element and from the second hardware element. In some embodiments, in response to receiving the input via the third hardware element: in accordance with a determination that the input via the third hardware element is a first type of input, the computer system displays, in the status region, a third user interface object associated with the third hardware element; and, in accordance with a determination that the input via the third hardware element is a second type of input that is different from the first type of input, the computer system displays, in the status region, a fourth user interface object associated with the third hardware element, wherein the fourth user interface object is different from the third user interface object.

For example, a long press of a button results in display of a user interface for shutting down the computer system, whereas a double press of the same button results in display of a digital wallet user interface. In some embodiments, the third user interface object includes status information about a first function associated with the third hardware element, and the fourth user interface object includes status information about a second function associated with the third hardware element.

For example, a long press via side button 206, as with user input 5176 (FIG. 5CU) results in invocation of a virtual assistant and display of virtual assistant session region 502-35 (FIG. 5CV), whereas a double press via the same side button 206, as with user input 5182 (FIG. 5CY) results in display of wallet pass session region 502-36 (FIG. 5CZ). In another example, a press (e.g., a brief press that is shorter than a threshold amount of time required for a long press) via volume button(s) 208 and side button 206 concurrently, as with user input 5184 (FIG. 5DA) results in capturing of a screenshot and display of screenshot session region 502-37 (FIG. 5DB), whereas a long press via the same volume(s) button 208 and side button 206 concurrently, as with user input 5186 (FIG. 5DC) results in display of power down session region 502-38 (along with system user interface 5190 outside of session region 502-38, FIG. 5DD). In response to detecting an input via a hardware element, displaying different user interface objects in the status region based on which type of input was provided via the hardware element enables a user to invoke different functions of the computer system without displaying additional controls.

In some embodiments, the first type of input has (1016) a first set of one or more input properties (e.g., duration, input pattern, repetition, intensity, and/or other property), and the second type of input has a second set of one or more input properties (e.g., duration, input pattern, repetition, intensity, and/or other property) that is different from the first set of one or more input properties (e.g., one or more properties of the second set differ from that of the first set). For example, user input 5176 (e.g., a long press via side button 206) (FIG. 5CU) differs from user input 5182 (e.g., a double press via the same side button 206) (FIG. 5CY) in number and duration (e.g., one long press versus two short presses, where a short press is shorter than a threshold amount of time required for the long press). In another example, user input 5184 (e.g., a short press via volume button(s) 208 and side button 206 concurrently) (FIG. 5DA) differs from user input 5186 (e.g., a long press via the same volume(s) button 208 and side button 206 concurrently) (FIG. 5DC) in duration.

Displaying different user interface objects in a status region based on whether a first type of input with certain input properties or a second type of input with different input properties was provided via the hardware element enables a user to invoke different functions of the computer system without displaying additional controls.

In some embodiments, the first type of input is (1018) an input received via a first combination of hardware elements including the third hardware element, and the second type of input is an input received via a second combination of hardware elements including the third hardware element, wherein the second combination of hardware elements is different from the first combination of hardware elements. For example, the first type of input is an input received via just the third hardware element (e.g., user input 5186 in FIG. 5CU being a long press via side button 206), and the second type of input is an input received via the third hardware element in combination with another hardware element (e.g., concurrently or sequentially) (e.g., user input 5186 in FIG. 5DC being a long press via the same side button 206 as well as volume(s) button 208 concurrently). In another example, the first type of input is an input received via the third hardware element in combination with another (e.g., fourth) hardware element (e.g., concurrently or sequentially), and the second type of input is an input received via the third hardware element in combination with yet another (e.g., fifth) hardware element (e.g., concurrently or sequentially). In response to detecting an input, displaying different user interface objects in the status region based on which combination of hardware elements was used to provide the input enables a user to invoke different functions of the computer system without displaying additional controls.

In some embodiments, displaying a respective user interface object in the status region in response to receiving an input via a respective hardware element (optionally in combination with one or more other hardware elements, and optionally in accordance with a determination that the input is a particular type of input) includes (1020) displaying an indication that a virtual assistant is invoked (e.g., actively listening for or otherwise waiting for a query) (e.g., as described herein with reference to virtual assistant session region 502-35 of FIG. 5CV). In some embodiments, in response to receiving the input via the respective hardware element, the computer system invokes the virtual assistant. In some embodiments, a virtual assistant is a software module or application, optionally executing on the computer system, that assists a user with performing tasks or operations on the computer system in response to voice, text, and/or other inputs recognized as requests to perform such tasks or operations. In some embodiments, while displaying the indication that the virtual assistant is invoked, the computer system detects a query or command directed to the virtual assistant and, in response, automatically performs one or more operations responsive to the query or command (e.g., providing a response to a question or performing a requested operation) (e.g., as described herein with reference FIGS. 5CW-5CX). Displaying, in the status region, a user interface object indicating that a virtual assistant is invoked and ready to accept a query in response to detecting the input via the hardware element provides feedback about a state of the device while making more efficient use of the display area by allowing user interfaces for other functions of the computer system to be displayed and interacted with outside of the status region.

In some embodiments, a respective user interface object that is displayed in the status region in response to receiving an input via a respective hardware element includes (1022) one or more controls for changing an output volume (e.g., of audio and/or tactile outputs) of the computer system (e.g., if the input is received via a volume up or volume down hardware button). In some embodiments, in response to receiving the input via the respective hardware element, the output volume of the computer system is changed; in some embodiments, the displayed respective user interface object reflects the changed output volume and/or is interactive to (e.g., further) change the output volume of the computer system. In some embodiments, the output volume of the computer system is changed for outputs of a particular first type, such as outputs associated with application content such as for music and/or video playback. In some embodiments, the output volume of the computer system is changed for outputs of the first type in accordance with a determination that the respective hardware element is configured to control outputs of the first type (e.g., via a setting of the computer system) rather than outputs of another type. For example, as described herein with reference to FIGS. 5CG-5CN, inputs via volume up/down buttons 208 change the output volume level of device 100, and in particular, as described herein with reference to FIGS. 5CG-5CL, inputs via volume up/down buttons 208 change the output volume level for some types of outputs such as for application content (e.g., and optionally not for other types of outputs such as ringtones). In response to detecting an input via a hardware element such as a volume button, displaying, in the status region, a user interface object with one or more volume controls provides feedback about a state of the device while in some embodiments reducing the number of inputs needed to adjust an output volume (e.g., for content) of the computer system and while making more efficient use of the display area by allowing user interfaces for other functions of the computer system to be displayed and interacted with outside of the status region.

In some embodiments, a respective user interface object that is displayed in the status region in response to receiving an input via a respective hardware element (optionally in combination with one or more other hardware elements, and optionally in accordance with a determination that the input is a particular type of input) (e.g., the first user interface object, displayed in the status region in response to receiving an input via the first hardware element, or the second user interface object, displayed in the status region in response to receiving an input via the second hardware element, or other user interface object, displayed in the status region in response to receiving an input via a combination of two or more hardware elements of the plurality of hardware elements) includes (1024) one or more controls for turning off the computer system (e.g., transitioning the computer system to a power off state). In some embodiments, the one or more controls include a button, toggle, slider, or other activatable control. For example, as described herein with reference to FIGS. 5DC-5DD, power down session region 502-38 is displayed in response to detecting user input 5186 via volume button 208 and side button 206 concurrently, and includes activatable power down slider 5188 for turning off device 100. Displaying, in the status region, a user interface object with one or more controls for turning off the computer system causes the device to automatically require user confirmation before performing a critical system operation.

In some embodiments, in response to receiving the input via the respective hardware element (optionally in combination with one or more other hardware elements), the computer system displays (1026), in display area outside of the status region, a second user interface that is different from the first user interface (e.g., while displaying, in the status region, the respective user interface object that includes the one or more controls for turning off the computer system). For example, as described herein with reference to FIG. 5DD, in response to detecting user input 5186, device 100 transitions from displaying home screen 500 outside of session region 502 to displaying system user interface 5190 outside of session region 502. While displaying the user interface object (e.g., with the one or more controls for turning off the computer system) in the status region, displaying different user interfaces outside of the status region makes more efficient use of the display area by allowing other functions of the computer system to be accessed outside of the status region.

In some embodiments, the computer system displays (1028), in the second user interface, a first control. In some embodiments, the computer system detects an input corresponding to a request to activate the first control (e.g., a tap, swipe, or other input on the first control, or a continuation of the input via the respective hardware element such as by continuing to press the respective hardware element, optionally in combination with one or more other hardware elements). In some embodiments, in response to detecting the input corresponding to the request to activate the first control, the computer system displays a third user interface that includes identification information about a user of the computer system (e.g., name, age, weight, height, blood type, medical conditions, allergies, medications, language(s) spoken, emergency contact information, and/or other information that may help another person, such as a first responder, attend to the user in an emergency, such as if the user is injured and/or unresponsive). For example, as described herein with reference to FIG. 5DD, system user interface 5190 outside of session region 502-38 includes medical information slider 5192, which is activatable (e.g., via user input 5198-2) to view identification information such as medical identification about the user of device 100. While displaying the user interface object (e.g., with the one or more controls for turning off the computer system) in the status region, displaying a user interface outside of the status region with a control for accessing user identification information makes more efficient use of the display area by allowing other functions of the computer system to be accessed outside of the status region and reduces the number of inputs and amount of time needed to perform a particular operation on the computer system.

In some embodiments, the computer system displays (1030), in the second user interface, a second control. In some embodiments, the computer system detects an input corresponding to a request to activate the second control (e.g., a tap, swipe, or other input on the second control, or a continuation of the input via the respective hardware element such as by continuing to press the respective hardware element, optionally in combination with one or more other hardware elements). In some embodiments, in response to detecting the input corresponding to request to activate the second control, the computer system initiates an emergency call (e.g., calling one or more emergency services or first responders such as police, fire, and/or ambulance). For example, as described herein with reference to FIG. 5DD, system user interface 5190 outside of session region 502-38 includes medical information slider 5194, which is activatable (e.g., via user input 5198-3) to make a call to emergency services using device 100. While displaying the user interface object (e.g., with the one or more controls for turning off the computer system) in the status region, displaying a user interface outside of the status region with a control for initiating an emergency call makes more efficient use of the display area by allowing other functions of the computer system to be accessed outside of the status region and reduces the number of inputs and amount of time needed to perform a particular operation on the computer system.

In some embodiments, in response to receiving an input via a respective hardware element (1032): in accordance with a determination that the input via the respective hardware element is received while a reduced audio output mode of the computer system (e.g., a silent mode or a mode in which standard audio alerts are reduced in volume or silenced) is enabled, the computer system disables the reduced audio output mode of the computer system, wherein a respective user interface object that is displayed in the status region in response to receiving the input via the respective hardware element includes an indication that the reduced audio output mode of the computer system is disabled; and, in accordance with a determination that the input via the respective hardware element is received while the reduced audio output mode of the computer system is disabled (e.g., a ringer mode of the computer system is enabled), the computer system enables the reduced audio output mode of the computer system, wherein the respective user interface object that is displayed in the status region in response to receiving the input via the respective hardware element includes an indication that the reduced audio output mode of the computer system is enabled. In some embodiments, while the reduced audio output mode is enabled, audio outputs and/or tactile outputs of the computer system are disabled, suppressed, or reduced relative to while the reduced audio output mode is disabled (e.g., the ringer mode is enabled). In some embodiments, an input to the respective hardware element toggles whether the reduced audio output mode is enabled or disabled. In some embodiments, the computer system is not configured to respond to a touch input directed to the respective user interface object (or more specifically directed to the indication whether the reduced audio output mode is enabled or disabled) by toggling whether the reduced audio output mode is enabled or disabled; accordingly, in some embodiments, which indication is displayed corresponds to the current state of the respective hardware element.

For example, as described herein with reference to FIGS. 5CO-5CT, a respective user input 5168 directed to switch 214 toggles whether the reduced audio output mode is enabled: user input 5168-1 enables the reduced audio output mode because user input 5168-1 is detected while the reduced audio output mode is disabled, as indicated by icon 5170-1 in session region 502-33; and user input 5168-2 disables the reduced audio output mode (e.g., and enables a normal audio output mode) because user input 5168-2 is detected while the reduced audio output mode is enabled, as indicated by icon 5170-2 in session region 502-34. In response to detecting an input via a hardware element such as an audio output mode switch, displaying, in the status region, a user interface object indicating a current status (e.g., enabled or disabled) of a reduced audio output mode provides feedback about a state of the device while making more efficient use of the display area by allowing user interfaces for other functions of the computer system to be displayed and interacted with outside of the status region.

In some embodiments, a respective user interface object that is displayed in the status region in response to receiving an input via a respective hardware element includes (1034) one or more controls for changing an alert volume (e.g., of audio and/or tactile outputs) of the computer system (e.g., for notifications, incoming voice and/or video calls, or other alerts, particularly time-sensitive alerts). In some embodiments, in response to receiving the input via the respective hardware element, the alert volume of the computer system is changed; in some embodiments, the displayed respective user interface object reflects the changed alert volume and/or is interactive to (e.g., further) change the alert volume of the computer system. In some embodiments, the alert volume of the computer system is changed for outputs of a particular second type, such as outputs associated with alerts, optionally in accordance with a determination that the respective hardware element is configured to control outputs of the second type (e.g., via a setting of the computer system) rather than outputs of another type. For example, as described herein with reference to FIGS. 5CG-5CN, inputs via volume up/down buttons 208 change the output volume level of device 100, and in particular, as described herein with reference to FIGS. 5 CM-5CN, inputs via volume up/down buttons 208 change the output volume level for some types of outputs other than for application content (e.g., for ringtones), and thus changes in the output volume level are reflected in session region 502 but not in user interface 5132 for the music application. In response to detecting an input via a hardware element such as a volume button, displaying, in the status region, a user interface object with one or more volume controls provides feedback about a state of the device while in some embodiments reducing the number of inputs needed to adjust an output volume (e.g., for alerts) of the computer system and while making more efficient use of the display area by allowing user interfaces for other functions of the computer system to be displayed and interacted with outside of the status region.

In some embodiments, a respective user interface object that is displayed in the status region in response to receiving an input via a respective hardware element (optionally in combination with one or more other hardware elements, and optionally in accordance with a determination that the input is a particular type of input) includes (1036) a visual representation of a screenshot of content displayed via the display generation component (e.g., content displayed in display area outside of the status region, including or excluding content displayed in the status region) (e.g., as described herein with reference to session region 502-37 of FIG. 5DB). In response to detecting an input via one or more hardware elements, capturing a screenshot and displaying, in the status region, a visual representation of the screenshot provides feedback about a state of the device while in some embodiments reducing the number of inputs needed to access the screenshot, such as by allowing a user to transfer the screenshot from the status region to a different user interface outside of the status region.

In some embodiments, a respective user interface object that is displayed in the status region in response to receiving an input via a respective hardware element (optionally in combination with one or more other hardware elements, and optionally in accordance with a determination that the input is a particular type of input) includes (1038) a representation of a secure credential (e.g., as described herein with reference to session region 502-36 of FIG. 5CZ). In some embodiments, the secure credential is a payment method (e.g., a credit card, debit card, or other transactional financial account), an identification card (e.g., a passport, driver license, health record card, or other form of identification), or a wireless entry key (e.g., for a vehicle, building, or other access-controlled location). In some embodiments, the secure credential is stored on the computer system. In some embodiments, in response to the computer system being brought into proximity with a wireless terminal and optionally conditional on biometric authentication or other user authentication performed by the computer system, the secure credential is transmitted to the wireless terminal for use by the wireless terminal to authenticate the user of the computer system (e.g., to verify the user's identity, to make a payment or other transaction, or to unlock a door). In response to detecting an input via one or more hardware elements, displaying, in the status region, a representation of a secure credential reduces the number of inputs needed to access the secure credential while making more efficient use of the display area by allowing user interfaces for other functions of the computer system to be displayed and interacted with outside of the status region.

In some embodiments, the computer system receives the input via the first hardware element while displaying (1040), in the status region, a fifth user interface object that includes status information about a first active session of a first function of the computer system (e.g., concurrently with displaying, in the display area outside of the status region, the first user interface). In some embodiments, the fifth user interface object ceases to be displayed in the status region in response to receiving the input via the first hardware element and is replaced by the first user interface object. In some embodiments, the computer system receives the input via the second hardware element while displaying, in the status region, a sixth user interface object that includes status information about a second active session of a second function of the computer system (e.g., concurrently with displaying, in the display area outside of the status region, the first user interface). In some embodiments, the sixth user interface object ceases to be displayed in the status region in response to receiving the input via the second hardware element and is replaced by the second user interface object. The first active session is optionally the same as or different from the second active session. The first function of the computer system is optionally the same as or different from the second function of the computer system. For example, session region 502 of FIGS. 5CG-5DD is configured to be displayed as any other session region described herein. Enabling the status region to display content for different applications and active sessions allows different types of status information for the computer system to be presented in a consistent region of the display area, thereby reducing the number of inputs and amount of time needed to perform a particular operation on the computer system.

In some embodiments, the one or more sensors are (1042) positioned within one or more sensor regions that are encompassed by the status region (e.g., surrounded by display area) (e.g., as described herein with reference to FIG. 5A). Displaying a user interface object responsive to a hardware input in a status region that encompasses one or more display cutouts for one or more sensors causes the computer system to automatically reduce the visual intrusiveness of the display cutouts and make more efficient use of the display area.

In some embodiments, the first user interface object (that is displayed in response to receiving the input via the first hardware element) includes (1044) first status information (e.g., any of a displayed volume control element, an indication of a current audio output mode, an indication of a current display orientation control mode, a representation of a virtual assistant, a representation of a secure credential, a representation of a screenshot, or other status information), the second user interface object (that is displayed in response to receiving the input via the second hardware element) includes second status information (e.g., a different one of a volume control, an indication of a current audio output mode, a representation of a virtual assistant, a representation of a secure credential, a representation of a screenshot, or other status information), and an appearance of the first status information is different from an appearance of the second status information. For example, as described herein with reference to the various examples in FIGS. 5CG-5DD, the user interface element(s) and/or status information displayed in session region 502 in response to a respective input via one or more hardware elements differ based on which hardware element(s) are used to provide the respective input. In response to detecting different inputs via one or more hardware elements, displaying, in the status region, different user interface objects with different appearances based on which type of input was provided and/or which hardware element(s) were used to provide the input enables a user to invoke different functions of the computer system without displaying additional controls.

In some embodiments, the first user interface object (that is displayed in response to receiving the input via the first hardware element) includes (1046) first status information about a function associated with the first hardware element (e.g., any of controlling output volume, selecting a current audio output mode, selecting a display orientation control mode, invoking a virtual assistant, displaying a representation of a secure credential, taking a screenshot, or other function), and the second user interface object (that is displayed in response to receiving the input via the second hardware element) includes second status information about a function associated with the second hardware element (e.g., a different one of controlling output volume, selecting a current audio output mode, selecting a display orientation control mode, invoking a virtual assistant, displaying a representation of a secure credential, taking a screenshot, or other function). For example, as described herein with reference to the various examples in FIGS. 5CG-5DD, the user interface element(s) and/or status information displayed in session region 502 in response to a respective input via one or more hardware elements represent a function associated with the one or more hardware element(s) (e.g., volume session regions 502-30, 502-31, and 502-32 displayed in response to inputs via volume button(s) 208 and including status information about output volume level associated with volume button(s) 208; audio output mode session region 502-33 displayed in response to inputs via switch 214 and including status information about audio output mode associated with switch 214; virtual assistant session region 502-35 displayed in response to inputs via side button 206 and including status information about a virtual assistant function associated with side button 206, wallet pass session region 502-36 displayed in response to inputs via side button 206 and including status information about a digital wallet function associated with side button 206, and other examples). In some embodiments, both the first hardware element and the second hardware element are associated with the same function or class of function (e.g., volume up and volume down, or other grouping of related functions). In some embodiments, the function associated with the first hardware element is different from and optionally unrelated to the function associated with the second hardware element. In response to detecting different inputs via one or more hardware elements, displaying, in the status region, different user interface objects with status information about different associated functions based on which type of input was provided and/or which hardware element(s) were used to provide the input enables a user to invoke different functions of the computer system without displaying additional controls.

It should be understood that the particular order in which the operations in FIGS. 10A-10D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 600, 700, 800, and 900) are also applicable in an analogous manner to method 1000 described above with respect to FIGS. 10A-10D. For example, the session regions, status information, user interface objects, user interfaces, user inputs, device/system functions, applications, and/or modes described above with reference to method 1000 optionally have one or more of the characteristics of the session regions, status information, user interface objects, user interfaces, user inputs, device/system functions, applications, and/or modes described herein with reference to other methods described herein (e.g., methods 600, 700, 800, and 900). For brevity, these details are not repeated here.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve display of content in a session region. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve the automatic selection of content for display in a session region based on users' activity patterns. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of automatic selection of content for display in a session region based on users' activity patterns, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content for display in a session region can be selected by inferring relevance or preferences based on non-personal information data or a bare minimum amount of personal information, such as the content being requested by the device associated with a user, other non-personal information available to the service, or publicly available information.

1-60. (canceled)

61. A method, comprising:
at a computer system that is in communication with a plurality of hardware elements and with a display generation component having a display area:
while displaying, in display area outside of a status region of the display area, a first user interface, receiving an input via a first hardware element of the plurality of hardware elements;
in response to receiving the input via the first hardware element, displaying, in the status region, a first user interface object associated with the first hardware element;
while continuing to display, in the display area outside of the status region, the first user interface, receiving an input via a second hardware element of the plurality of hardware elements, wherein the second hardware element is different from the first hardware element; and
in response to receiving the input via the second hardware element, displaying, in the status region, a second user interface object associated with the second hardware element, wherein the second user interface object is different from the first user interface object.

62. The method of claim 61, wherein the computer system is in communication with a touch-sensitive surface, and the method includes:
while displaying the first user interface object in the status region, detecting, via the touch-sensitive surface, one or more touch inputs directed to the first user interface object; and
in response to detecting the one or more touch inputs directed to the first user interface object, performing a first operation on the computer system;
while displaying the second user interface object in the status region, detecting, via the touch-sensitive surface, one or more touch inputs directed to the second user interface object; and
in response to detecting the one or more touch inputs directed to the second user interface object, performing a second operation on the computer system that is different from the first operation.

63. The method of claim 62, including:
in response to receiving the input via the first hardware element, performing an operation of a same type as the first operation; and
in response to receiving the input via the second hardware element, performing an operation of a same type as the second operation.

64. The method of claim 61, including:
receiving an input via a third hardware element of the plurality of hardware elements; and
in response to receiving the input via the third hardware element:
in accordance with a determination that the input via the third hardware element is a first type of input, displaying, in the status region, a third user interface object associated with the third hardware element; and
in accordance with a determination that the input via the third hardware element is a second type of input that is different from the first type of input, displaying, in the status region, a fourth user interface object associated with the third hardware element, wherein the fourth user interface object is different from the third user interface object.

65. The method of claim 64, wherein the first type of input has a first set of one or more input properties, and the second type of input has a second set of one or more input properties that is different from the first set of one or more input properties.

66. The method of claim 64, wherein the first type of input is an input received via a first combination of hardware elements including the third hardware element, and the second type of input is an input received via a second combination of hardware elements including the third hardware element, wherein the second combination of hardware elements is different from the first combination of hardware elements.

67. The method of claim 61, wherein displaying a respective user interface object in the status region in response to receiving an input via a respective hardware element includes displaying an indication that a virtual assistant is invoked.

68. The method of claim 61, wherein a respective user interface object that is displayed in the status region in response to receiving an input via a respective hardware element includes one or more controls for changing an output volume of the computer system.

69. The method of claim 61, wherein a respective user interface object that is displayed in the status region in response to receiving an input via a respective hardware element includes one or more controls for turning off the computer system.

70. The method of claim 69, including, in response to receiving the input via the respective hardware element:
displaying, in display area outside of the status region, a second user interface that is different from the first user interface.

71. The method of claim 70, including:
displaying, in the second user interface, a first control;
detecting an input corresponding to a request to activate the first control; and
in response to detecting the input corresponding to the request to activate the first control, displaying a third user interface that includes identification information about a user of the computer system.

72. The method of claim 70, including:
displaying, in the second user interface, a second control;
detecting an input corresponding to a request to activate the second control; and
in response to detecting the input corresponding to request to activate the second control, initiating an emergency call.

73. The method of claim 61, including:
in response to receiving an input via a respective hardware element:
in accordance with a determination that the input via the respective hardware element is received while a reduced audio output mode of the computer system is enabled:
disabling the reduced audio output mode of the computer system, wherein a respective user interface object that is displayed in the status region in response to receiving the input via the respective hardware element includes an indication that the reduced audio output mode of the computer system is disabled; and
in accordance with a determination that the input via the respective hardware element is received while the reduced audio output mode of the computer system is disabled:
enabling the reduced audio output mode of the computer system, wherein the respective user interface object that is displayed in the status region in response to receiving the input via the respective hardware element includes an indication that the reduced audio output mode of the computer system is enabled.

74. The method of claim 61, wherein a respective user interface object that is displayed in the status region in response to receiving an input via a respective hardware element includes one or more controls for changing an alert volume of the computer system.

75. The method of claim 61, wherein a respective user interface object that is displayed in the status region in response to receiving an input via a respective hardware element includes a visual representation of a screenshot of content displayed via the display generation component.

76. The method of claim 61, wherein a respective user interface object that is displayed in the status region in response to receiving an input via a respective hardware element includes a representation of a secure credential.

77. The method of claim 61, including:
receiving the input via the first hardware element while displaying, in the status region, a fifth user interface object that includes status information about a first active session of a first function of the computer system; and
receiving the input via the second hardware element while displaying, in the status region, a sixth user interface object that includes status information about a second active session of a second function of the computer system.

78. The method of claim 61, wherein the computer system is in communication with one or more sensors, and the one or more sensors are positioned within one or more sensor regions that are encompassed by the status region.

79. The method of claim 61, wherein the first user interface object includes first status information, the second user interface object includes second status information, and an appearance of the first status information is different from an appearance of the second status information.

80. The method of claim 61, wherein the first user interface object includes first status information about a function associated with the first hardware element, and the second user interface object includes second status information about a function associated with the second hardware element.

81. A computer system that is in communication with a plurality of hardware elements and with a display generation component having a display area, the computer system comprising:
one or more processors; and
memory storing one or more programs, wherein the one or more programs are configured to be executed by the one or more processors, the one or more programs including instructions for:
while displaying, in display area outside of a status region of the display area, a first user interface, receiving an input via a first hardware element of the plurality of hardware elements;
in response to receiving the input via the first hardware element, displaying, in the status region, a first user interface object associated with the first hardware element;
while continuing to display, in the display area outside of the status region, the first user interface, receiving an input via a second hardware element of the plurality of hardware elements, wherein the second hardware element is different from the first hardware element; and
in response to receiving the input via the second hardware element, displaying, in the status region, a second user interface object associated with the second hardware element, wherein the second user interface object is different from the first user interface object.

82. A computer readable storage medium storing one or more programs, the one or more programs comprising instructions that, when executed by a computer system that is in communication with a plurality of hardware elements and with a display generation component having a display area, cause the computer system to:
while displaying, in display area outside of a status region of the display area, a first user interface, receive an input via a first hardware element of the plurality of hardware elements;
in response to receiving the input via the first hardware element, display, in the status region, a first user interface object associated with the first hardware element;
while continuing to display, in the display area outside of the status region, the first user interface, receive an input via a second hardware element of the plurality of hardware elements, wherein the second hardware element is different from the first hardware element; and
in response to receiving the input via the second hardware element, display, in the status region, a second user interface object associated with the second hardware element, wherein the second user interface object is different from the first user interface object.
